(19) United States
(12) Patent Application Publication
(10) Pub. No.: US 2026/0260902 A1
(43) Pub. Date: Sep. 3, 2026

(54) BATTERIES AND METHODS OF MAKING THE SAME

(71) Applicant: BOARD OF REGENTS, THE UNIVERSITY OF TEXAS SYSTEM, Austin, TX (US)

(72) Inventors: David MITLIN, Hannawa Falls, NY (US); Yixian WANG, Austin, TX (US)

(21) Appl. No.: 18/717,061

(22) PCT Filed: Dec. 7, 2022
(86) PCT No.: PCT/US2022/052143

§ 371 Date: Jun. 6, 2024

Related U.S. Application Data
(60) Provisional application No. 63/287,855, filed on Dec. 9, 2021.
(60) Provisional application No. 63/292,601, filed on Dec. 22, 2021.
(60) Provisional application No. 63/357,860, filed on Jul. 1, 2022.

(51) Int. Cl. H01M 4/66; H01M 4/04; H01M 4/38; H01M 4/58; H01M 4/80; H01M 10/0525; H01M 10/054; H01M 10/0562; H01M 10/0569

(52) U.S. Cl. CPC H01M 4/667; H01M 4/0404; H01M 4/381; H01M 4/5825; H01M 4/661; H01M 4/808; H01M 10/0525; H01M 10/054; H01M 10/0562; H01M 10/0569; H01M 2300/0028; H01M 2300/008

(57) ABSTRACT

Disclosed is an electrochemical cell comprising a conductive host material configured to sustain a plurality of plating/stripping cycles such that an active anode metal material is repeatedly plated and then stripped during the electrochemical cell operation and wherein the host material comprises a) a substrate; and b) a coating disposed on the substrate, where the coating comprises at least one chalcogen. Also disclosed are electrochemical cells comprising such templates and methods of making and using the same.

### CROSS-REFERENCE TO RELATED APPLICATIONS

This application claims the benefit of U.S. Provisional Application No. 63/357,860, filed Jul. 1, 2022, U.S. Provisional Application No. 63/292,601, filed Dec. 22, 2021, and U.S. Provisional Application No. 63/287,855, filed Dec. 9, 2021, the contents of which are incorporated herein by reference in their entirety.

### STATEMENT ACKNOWLEDGING GOVERNMENT SUPPORT

This invention was made with government support under Grant Nos. DE-AC05-00OR22725 awarded by the Department of Energy and CBET1942226, DMR1938833, and CMM11911905 awarded by the National Science Foundation. The government has certain rights in the invention.

### TECHNICAL FIELD

This application relates generally to electrochemical cells having a conductive host material configured to sustain a plurality of plating/stripping cycles, where the host material is a host for an anode material and comprises a substrate and a chalcogen coating disposed on the substrate.

### BACKGROUND

The past three decades have witnessed the booming of lithium-ion battery (LIB) technology with extensive applications in portable electronics and electric vehicles. This, however, does not fully satisfy targeted EV range requirements, such as 500 km per charge. The application in large-scale grid storage, however, is greatly impeded by its cost due to the scarcity of Li on Earth's Crust (~20 ppm). Sodium-ion batteries (SIBs, NIBs) turn out to be one of the most promising alternatives due to their analogous working mechanism but great abundance (~28000 ppm on Earth's Crust). The cost-effectiveness of Na batteries is expected to overtake that of LIBs in terms of electromobile applications if their practical energy density can reach 200 Wh kg⁻¹, as the commercial LIBs that are based on transition-metal oxide cathodes and graphite anodes normally provide specific energy in the range of 250 Wh kg⁻¹. Numerous efforts have been devoted to developing suitable electrode materials for SIBs with larger capacity, higher output voltage, and greater energy density to achieve this goal.

With aspect to anode materials, compared with alloying and conversion types of materials, sodium metal holds considerable promise considering its high theoretical capacity of 1,166 mAh g⁻¹ and low redox potential of −2.71 V vs. standard hydrogen electrode (SHE). Unfortunately, the dendrite growth of Na during electroplating/electrostripping and unstable solid electrolyte interphase (SEI) prevail in a wide range of electrolytes and even to a worse extent compared with its counterpart (Li metal). This, in turn, can cause a series of major problems, including increased cell impedance, low Coulombic efficiency (CE), electrolyte depletion, and, finally, cell failure.

To address the above issues, altering the surface chemistry on the Na metal anode is one of the most commonly used strategies to regulate Na deposition and suppress dendrite growth. This is achieved either by in-situ formation of a passivation layer through adding electrolyte additives (e.g., KFSI, SnCl₂, Na₂S₆) or by ex-situ construction of an artificial SEI through the surface coating (e.g., Al₂O₃, NaBr, Na/Bi and Na/Sb alloy). However, the Mohs hardness of Na metal is only 0.5, and the intrinsic softness makes it difficult to be processible without a suitable substrate. In addition, the infinite volume change during plating/stripping associated with hostless Na is yet to be solved. Therefore, the construction of suitable Na hosts through rational designs to accommodate volume expansion and enable uniform Na plating/stripping is imperative to realize high-performance sodium metal batteries (SMBs).

The inventors have shown that rather than forming a conformal film, a heterogenous island structure is more favorable to form on bare metal foil, causing a series of deleterious results, including poor metal wetting, and dendrite growth, and SEI thickening. Creating sodiophilic surfaces to promote metal wetting during deposition and simultaneously reduce the nucleation/growth overpotentials has been proved to be highly effective. However, some ambiguities are yet to be cleared, including what causes the sodiophobicity/sodiophilicity, why some substrates are more sodiophilic than others, what is the difference between Na electroplating/electrostripping behavior on sodiophobic/sodiophilic surfaces. In addition, a more simplified and processible synthetic process is of great desire considering adaptive manufacturing to bring the technology to a greater scale.

Thus, innovative approaches to providing stable and efficient anodeless batteries are needed. These needs and other needs are at least partially satisfied by the present disclosure.

### SUMMARY

The present disclosure is directed to an electrochemical cell comprising a conductive host material configured to sustain a plurality of plating/stripping cycles such that an active anode metal material is repeatedly plated and then stripped during the electrochemical cell operation and wherein the host material comprises a) a substrate; and b) a coating disposed on the substrate, where the coating comprises at least one chalcogen.

In further aspects, at least one chalcogen comprises sulfur (S), tellurium (Te), selenium (Se), antimony (Sb), or a combination thereof.

While in still further aspects, the substrate comprises a rough surface.

In yet still further aspects, the substrate comprises copper, aluminum, alloys of copper, or alloys of aluminum.

In yet still further aspects, the disclosed electrochemical cell further comprises an electrolyte. Further disclosed herein are aspects where the electrolyte comprises a salt and a non-aqueous solvent.

In still further aspects, disclosed is an electrochemical cell comprising a conductive host material configured to sustain a plurality of plating/stripping cycles such that an active anode metal material is repeatedly plated and stripped during the electrochemical cell operation and wherein the host material further comprises a) a substrate and b) a coating comprising an in-situ formed intermetallic complex comprising at least one first element and at least one second element, wherein at least one second element comprises the active anode metal material. In such exemplary aspects, the in-situ formed intermetallic complex is irreversible.

Also disclosed herein is a method of making the disclosed electrochemical cell comprising: a) providing a host material comprising: i) a substrate; and a coating disposed on the substrate where the coating comprises at least one chalcogen; b) providing an electrolyte; and c) plating an active anode metal material to form an anode.

In yet further aspects, disclosed herein is a method of making the disclosed electrochemical cell comprising: a) providing a host material comprising: i) a substrate; and a coating disposed on the substrate where the coating comprises at least one first element; b) providing an electrolyte; and c) in-situ forming an intermetallic complex comprising the at least one first element and at least one second element, wherein at least one second element comprises an active anode metal material; and d) plating an active anode metal material to form an anode.

Additional advantages will be set forth in part in the description which follows, and in part will be obvious from the description or can be learned by practice of the aspects described below. The advantages described below will be realized and attained by means of the chemical compositions, methods, and combinations thereof, particularly pointed out in the appended claims. It is to be understood that both the foregoing general description and the following detailed description are exemplary and explanatory only and are not restrictive of the invention, as claimed.

### BRIEF DESCRIPTION OF DRAWINGS

FIG. 1 illustrates the structure of CF, Te@CF, and S@CF.

FIGS. 2A-2F depict SEM images at different magnifications: FIGS. 2A, 2D show CF, FIGS. 2B, 2E show Te@CF and FIGS. 2C, 2F show S@CF. FIG. 2G shows XRD profiles of Te@CF, S@CF, and CF. FIGS. 2H, 2I show high-resolution XPS spectra of Cu2p and Te3d of Te@CF, respectively. FIG. 2J-2L show high resolution XPS spectra of Cu2p, Te3d, and Na1s after activation.

FIGS. 3A-3F show an electrochemical performance of the half-cells and symmetrical cells based on the Te@CF, S@CF, and CF substrates. Galvanostatic profile of Na plating at 0.2 mA cm⁻² (FIG. 3A) and 0.5 mA cm⁻² (FIG. 3B) on various substrates. Insets of FIG. 3B are digital photos demonstrating the preference of Na nucleation on Te@CF before and after plating 1 mAh cm⁻² capacity at 0.5 mA cm⁻². Coulombic efficiencies of Na plating/stripping tested at 2 mA cm⁻² (FIG. 3C) to 1 mAh cm⁻² capacity and 4 mA cm⁻² to 2 mAh cm⁻² capacity (FIG. 3D). FIG. 3E shows a rate capability with a fixed capacity of 1 mAh cm⁻² at different current densities. Inset is a digital photo showing the three substrates with 5 mAh cm⁻² Na plated. FIG. 3F shows a cycling performance at 2 mA cm⁻² to 1 mAh cm⁻² capacity.

FIGS. 4A-4P show the microstructural analysis of Te@CF and of baseline CF with different Na plating capacities, tested at xyz Ah cm⁻² for a single deposition cycle. FIGS. 4A-4D show Te @CF with a Na plating capacity of 0.5 mAh cm-2 displaying top-down SEM images with digital photograph insets of entire foil, cryo-FIB cross section image, and associated EDX elemental map. FIGS. 4E-4H show the same analysis but for baseline CF to plating capacity of 0.5 mAh cm⁻². FIGS. 4I-4L show Te@CF to a plating capacity of 5 mAh cm⁻². FIGS. 4M-4P show the baseline CF to plating capacity of 5 mAh cm⁻².

FIGS. 5A-5H show microstructural analysis of Te@CF and of baseline CF in the stripped condition, tested at xyz Ah cm⁻² for a single deposition/stripping cycle. FIGS. 5A-5D show Te@CF with a Na plating/stripping capacity of 0.5 mAh cm⁻², displaying top-down SEM images with digital photograph insets of entire foil, cryo-FIB cross-section image, and associated EDX elemental map. FIGS. 5E-5H show the same analysis but for baseline CF to plating/stripping capacity of 0.5 mAh cm⁻².

FIGS. 6A-6H depict the electrochemical performance of the symmetric cells and full cells based on Te@CF-TNa, CF-TNa, and Na. FIG. 6A shows the rate capability of symmetric cells with a fixed capacity of 2 mAh cm⁻² at different current densities. FIG. 6B shows the cycling performance of symmetric cells at 2 mA cm⁻² current density to 1 mAh cm⁻² of capacity. FIG. 6C is digital photos showing the post-cycled CF-TNa and Te@CF-TNa electrodes. FIG. 6D Cycling performance of Te@CF-TNa symmetric cells at 1 mA cm⁻² current density to 2 mAh cm⁻² capacity. FIG. 6E shows the rate capability of full cells with Te@CF-TNa, CF-TNa and Na anodes and NVP cathode (1C=xyz mA g⁻¹). FIG. 6F depicts the cycling performance of Te@CF-TNa full cells. FIG. 6G shows the rate capability of Te@CF-TNaLTD (define LTD) full cells. FIG. 6H Cycling performance full cells of Te@CF-TNaLTD full cells.

FIGS. 7A-7B illustrate the enhancement effect on the plating and stripping behavior. FIG. 7A shows baseline CF with dendrite and irregular SEI from the onset and the formation of dead metal upon stripping. FIG. 7B shows the role of the sodiophilic layer on the surface of Te@CF, enabling uniform plating/stripping of Na metal.

FIGS. 8A-8C depict digital photographs showing the thickness of CF (FIG. 8A), the front (FIG. 8B), and the back (FIG. 8C) sides of CF, S@CF, and Te@CF.

FIGS. 8D-8G show SEM and EDX images and analysis of the backside morphology of Te@CF.

FIGS. 9A-E show the EDX maps (FIGS. 9A-9D) and associated spectrum (FIG. 9E) of Te@CF.

FIGS. 10A-10E show EDX maps (FIGS. 10A-10D) and the associated spectrum (FIG. 10E) of S@CF.

FIGS. 11A-11D show TEM analysis of exfoliated nanoparticle from Te@CF. (FIG. 11A) Bright-field image, (FIG. 11B), HRTEM image (FIG. 11C) and (FIG. 11D) SAED pattern.

FIG. 12 depicts the XRD profiles of Te@CF with different Te mass loadings.

FIGS. 13A-13D show SEM images of Te@CF-0.4 (FIGS. 13A, 13B) and Te@CF-0.1 (FIGS. 13C,13 D).

FIGS. 14A-14B show high-resolution XPS spectra of Cu 2p (FIG. 14A) and S 2p of S@CF (FIG. 14B).

FIGS. 15A-15D depict CV curves of Te@CF and S@CF at cycle 1, respectively (FIGS. 15A-15B), and galvanostatic profiles of Te@CF and S@CF during 1st discharge to 0 V (FIGS. 15C-15D).

FIG. 16 shows the XRD profile of Te@CF and S@CF after activation.

FIGS. 17A-17D show high-resolution XPS spectra of (FIG. 17A) Cu 2p and (FIG. 17B) Te 3d of Te@CF; (FIG. 17C) Cu 2p and (FIG. 17D) S 2p of S@CF.

FIGS. 18A-18D show SEM images of (FIGS. 18A, 18B) Te@CF and (FIGS. 18C, 18D) S@CF after activation.

FIG. 19 shows EDX maps of Te@CF after activation.

FIGS. 20A-201 show SEM images and associated EDX maps of Te@CF after 50 cycles at 2 mA cm⁻² to 1 mAh cm⁻² capacity.

FIGS. 21A-21D show the Coulombic efficiencies of Na plating/stripping on Te@CF at different current densities and plating capacities.

FIGS. 22A-22B show Coulombic efficiencies of Na plating/stripping on Te@CF with different mass loadings. FIG. 22A shows the current density of 2 mA cm⁻² to the capacity of 1 mAh cm⁻². FIG. 22B shows the current density of 4 mA cm⁻² to the capacity of 2 mAh cm⁻².

FIGS. 23A-23P shows SEM analysis of Te@CF and CF with different Na plating/stripping capacities. Insets are digital photos showing the electrodes with different amounts of Na plated/stripped. FIGS. 23Q-23V show SEM images of Te@CF—Na deposition at various magnifications in different aspects.

FIGS. 24A-24G shows EDX mappings of Te@CF with different Na plating/stripping capacities.

FIGS. 25A-25D show EIS spectra of the three substrates tested at 2 mA cm⁻² to 1 mAh cm⁻² capacity after different cycles (FIGS. 25A-25C). Summary of impedance data after fitting the EIS curve with respective equivalent circuit shown as the inset (FIG. 25D).

FIGS. 26A-26D show cryo-FIB cross-section images and associated EDX map of Te@CF-TNa (FIGS. 26A, 26B). FIG. 26C, 26D show the same analysis of CF-TNa. FIGS. 26E and 26F depict SEM images of Te@CF-TNa.

FIGS. 27A-27C show the electrochemical performance of Te@CF-TNa symmetric cells tested at different current densities and capacities.

FIG. 28 depicts galvanostatic charge-discharge profiles of full batteries with NVP cathodes and Te@CF-TNa, CF-TNa, and Na anodes.

FIG. 29 depicts the voltage versus time profile of Te@CF-TNaLTD at 0.5 mA cm⁻².

FIGS. 30A-30K depict: FIG. 30A Galvanostatic discharge and charge profile of the Li|SE|Li₂Te—Cu cell at 0.1 mA cm⁻² at cycle 1; FIG. 30B Amplified discharge profile of the activation process; FIG. 30C XRD pattern and (d-e) XPS spectra of the Te—Cu electrode after activation; FIGS. 30F-30K Schematic diagrams and top-down/cross-section SEM images of the Li|SE|Li₂Te—Cu cell after (FIGS. 30F, 30I) activation, (FIGS. 30G, 30J) electrodeposition 1 mAh cm⁻² Li and (FIGS. 30H, 30K) electro-dissolution to 1.0V.

FIGS. 31A-31L depict: (FIGS. 31A-31D) Galvanostatic discharge profiles of Li|SE|Li₂Te—Cu and Li|SE|Cu cells during cycle 1 at different current densities; (FIG. 31E) Nucleation potential (FIG. 31F) electro-dissolution potential and (FIG. 31G) initial Coulombic Efficiency (ICE) of Li|SE|Li₂Te—Cu and Li|SE|Cu cells at various current densities; (FIG. 31H) Nyquist plots after electrodepositing 1 mAh cm⁻² at 0.5 mA cm⁻². Galvanostatic discharge profiles of (FIGS. 31I, 31J) Li|SE|Li₂Te—Cu and (FIGS. 31K, 31L) Li|SE|Cu at 0.5 and 1 mA cm⁻².

FIGS. 32A-32H depict coulombic efficiency measurement of (32A) Li|SE|Li₂Te—Cu and (FIG. 32B) Li|SE|Cu cells. Galvanostatic cycling performance of Li|SE|Li₂Te—Cu and Li|SE|Cu cells tested at (FIGS. 32C-32E) 0.1 mA cm⁻² and (FIGS. 32F-32H) 0.5 mA cm⁻² to a fixed electrodeposition capacity of 1 mAh cm⁻².

FIGS. 33A-33L depict Cryo-FIB cross-sectional SEM and EDXS of the Li|SE|Li₂Te—Cu cell, tested at 0.5 mA cm⁻² (FIGS. 33A-33C) electrodeposition 1 mAh cm⁻², (FIGS. 33D-33F) electrodeposition 3 mAh cm⁻², (FIGS. 33G-33I) electro-dissolution 1 mAh cm⁻² and (j-l) electro-dissolution to 1.0 V. The scale bar is 5 μm.

FIGS. 34A-34L depict: (FIG. 34A) Galvanostatic profile of the Li|SE|Cu cell with a capacity of 1 mAh cm⁻², tested at 0.5 mA cm⁻²; (FIG. 34B) Schematic of the Li|SE|Cu at electro-dissolved state with honeycomb-like SEI and dead metal remaining; (FIGS. 34C, 34D) Top-down SEM images of SEI in the separated cell showing SE surface; (FIGS. 34E, 34F) Same analysis of the Cu surface (not same area); (FIGS. 34G, 34H) Top-down and cryo-FIB SEM cross-section images of electrochemically inactive dead-metal on the electro-dissolved surface. (FIGS. 34I, 34J) Galvanostatic electrodeposition curve and corresponding EIS plots at 3 mA cm⁻² to 1 mAh cm⁻² at cycle 1; (FIGS. 34K, 34L) FIB cross-sectional SEM images of interface containing metal dendrites (circled) propagating into the SE, after plating to 3 mAh cm⁻².

FIGS. 35A-35J depict: (FIG. 35A) Schematic diagram of the working principle in an anode-free solid-state battery; (FIGS. 35B, 35D) Cryo-FIB SEM images and EDXS maps of the NMC cathode intermixed with the SE; (FIGS. 35E-35G) Galvanostatic charge/discharge profiles at 1^{st} cycle, 2^{nd}-7^{th} and 2^{nd}-5^{th} cycle; (FIG. 35H) Cycling performance of Li₂Te-Cu|SE|NMC and Cu|SE|NMC cells and (FIGS. 35I, 35J) Results of the EIS analysis of the two specimens at different stages of cycling.

FIGS. 36A-36H depict the characterization of Te₂Cu coated Cu current collector: (FIG. 36A) XRD pattern and (FIGS. 36B, 36C) XPS spectra; (36D-36E) SEM images; (FIGS. 36F-36H) FIB cross-sectional SEM and associated EDXS elemental mapping.

FIGS. 37A-37B depict: (FIG. 37A) a digital photograph; and (FIG. 37B) a schematic of the PEEK cell.

FIG. 38 depicts the galvanostatic discharge/charge (GCD) profile of Cu2Te coated Cu during the first five cycles, tested between 0-1 V.

FIG. 39 depicts SEM and EDXS maps of the Li₂Te—Cu collector. Scale bar: 5 μm.

FIGS. 40A-40B depict SEM images of the surfaces of: (FIG. 40A) Li₂Te—Cu; and (FIG. 40B) SE at a fully electro-dissolved state after cycling 100 times at 0.5 mA cm⁻² to 1 mAh cm⁻².

FIG. 41 depicts SEM and EDXS map of Te—Cu after electro-dissolution to 1 V. Scale bar: 5 μm.

FIG. 42 depicts a Cryo-FIB SEM image of baseline Cu after electrodepositing 1 mAh cm⁻² at 0.5 mA cm⁻².

FIG. 43 depicts a cryo-FIB-SEM cross-sectional image and EDXS map of the “dead Li” on Cu foil.

FIGS. 44A-44B depict: (FIG. 44A) Nyquist plot of Li|SE|Cu cell before electrodeposition; and (FIG. 44B) Amplified EIS plots of FIG. 34J.

FIGS. 45A-45F depict representative structures of Li₄ or Li₅ cluster binding on fcc Cu, bcc Li, and fcc Li₂Te surfaces: (FIG. 45A) Li₄ cluster and (FIG. 45D)Li₅ cluster on (100) fcc Cu surface. (FIG. 45B) Li₄ cluster and (FIG. 45E) Li₅ cluster on (110) bcc Li surface. (FIG. 45C) Li₄ cluster and (FIG. 45F) Li₅ cluster on (110) fcc Li₂Te surface, Color scheme: Li (pink), Te (yellow), Cu (brown), and Li in the binding site (purple).

FIGS. 46A-46F depict representative structures of 4 or 5 individual Li atoms binding on fcc Cu, bcc Li, and fcc Li₂Te, and surfaces: (FIG. 46A) 4 Li atoms and (FIG. 46D) 5 Li atoms on (100) fcc Cu surface. (FIG. 46B) 4 Li atoms and (FIG. 46E) 5 Li atoms on (110) bcc Li surface. (FIG. 46C) 4 Li atoms and (FIG. 46F) 5 Li atoms on (110) fcc Li₂Te surface. Color scheme: Li (pink), Te (yellow), Cu (brown), and Li in binding site (purple).

FIG. 47 depicts galvanostatic charge/discharge profiles of the Li₂Te-Cu|SE|NMC cells under different current densities.

FIGS. 48A-48B depicts Nyquist plots of Li₂Te-Cu|SE|NMC and Cu|SE|NMC cells after charging at different cycles.

FIGS. 49A-49B depict: (FIG. 49A) XRD profile and (FIG. 49B) Nyquist plot of the argyrodite electrolyte Li₆PS₅Cl.

FIG. 50 depicts a thermally infused Na.

FIG. 51 depicts SEM and EDX images of thermally infused Na on Te@CF.

FIG. 52 shows the SEM of symmetric Tl—Te@CF cell after 100 cycles in one aspect.

FIGS. 53A-53D show the electrochemical performance of Tl—Te@CF cells tested at different current densities and capacities in one aspect.

FIGS. 54A-54D depict SEM and EDX of copper foam.

FIGS. 55A-551 depict SEM and EDX images of the thermal infusion of Te@CF with limited Na.

### DETAILED DESCRIPTION

The present invention can be understood more readily by reference to the following detailed description, examples, drawings, and claims, and their previous and following description. However, before the present articles, systems, and/or methods are disclosed and described, it is to be understood that this invention is not limited to the specific or exemplary aspects of articles, systems, and/or methods disclosed unless otherwise specified, as such can, of course, vary. It is also to be understood that the terminology used herein is for the purpose of describing particular aspects only and is not intended to be limiting.

The following description of the invention is provided as an enabling teaching of the invention in its best, currently known aspect. To this end, those skilled in the relevant art will recognize and appreciate that many changes can be made to the various aspects of the invention described herein while still obtaining the beneficial results of the present invention. It will also be apparent that some of the desired benefits of the present invention can be obtained by selecting some of the features of the present invention without utilizing other features. Accordingly, those of ordinary skill in the pertinent art will recognize that many modifications and adaptations to the present invention are possible and may even be desirable in certain circumstances and are a part of the present invention. Thus, the following description is again provided as illustrative of the principles of the present invention and not in limitation thereof.

### Definitions

As used herein, the terms “optional” or “optionally” mean that the subsequently described event or circumstance can or cannot occur and that the description includes instances where said event or circumstance occurs and instances where it does not.

It is appreciated that certain features of the disclosure, which are, for clarity, described in the context of separate aspects, can also be provided in combination in a single aspect. Conversely, various features of the disclosure, which are, for brevity, described in the context of a single aspect, can also be provided separately or in any suitable subcombination.

As used in the description and the appended claims, the singular forms “a,” “an,” and “the” include plural referents unless the context clearly dictates otherwise. Thus, for example, a reference to “an element” includes two or more such elements, and a reference to “a battery” includes two or more such batteries and the like.

It is also to be understood that the terminology used herein is for the purpose of describing particular aspects only and is not intended to be limiting. As used in the specification and in the claims, the term “comprising” can include the aspects “consisting of” and “consisting essentially of.” Unless defined otherwise, all technical and scientific terms used herein have the same meaning as commonly understood by one of ordinary skill in the art to which this invention belongs. In this specification and in the claims which follow, reference will be made to a number of terms that shall be defined herein.

For the terms “for example” and “such as,” and grammatical equivalences thereof, the phrase “and without limitation” is understood to follow unless explicitly stated otherwise.

The expressions “ambient temperature” and “room temperature” as used herein are understood in the art and refer generally to a temperature from about 20° C. to about 35° C.

Notwithstanding that the numerical ranges and parameters setting forth the broad scope of the disclosure are approximations, the numerical values set forth in the specific examples are reported as precisely as possible. Any numerical value, however, inherently contains certain errors necessarily resulting from the standard deviation found in their respective testing measurements. Furthermore, when numerical ranges of varying scope are set forth herein, it is contemplated that any combination of these values, inclusive of the recited values, may be used. Further, ranges can be expressed herein as from “about” one particular value and/or to “about” another particular value. When such a range is expressed, another aspect includes from the one particular value and/or to the other particular value.

Similarly, when values are expressed as approximations, by use of the antecedent “about,” it will be understood that the particular value forms another aspect. It will be further understood that the endpoints of each of the ranges are significant both in relation to the other endpoint and independently of the other endpoint. Unless stated otherwise, the term “about” means within 5% (e.g., within 2% or 1%) of the particular value modified by the term “about.”

Throughout this disclosure, various aspects of the invention can be presented in a range format. It should be understood that the description in range format is merely for convenience and brevity and should not be construed as an inflexible limitation on the scope of the invention. Accordingly, the description of a range should be considered to have specifically disclosed all the possible subranges as well as individual numerical values within that range. For example, a description of a range such as from 1 to 6 should be considered to have specifically disclosed subranges such as from 1 to 3, from 1 to 4, from 1 to 5, from 2 to 4, from 2 to 6, from 3 to 6, etc., as well as individual numbers within that range, for example, 1, 2, 2.7, 3, 4, 5, 5.3, 6 and any whole and partial increments therebetween. This applies regardless of the breadth of the range.

As used herein, the term “composition” is intended to encompass a product comprising the specified ingredients in the specified amounts, as well as any product which results, directly or indirectly, from a combination of the specified ingredients in the specified amounts.

References in the specification and concluding claims to parts by weight of a particular element or component in a composition denotes the weight relationship between the element or component and any other elements or components in the composition or article for which a part by weight is expressed. Thus, in a mixture containing 2 parts by weight of component X and 5 parts by weight, components Y, X, and Y are present at a weight ratio of 2:5 and are present in such a ratio regardless of whether additional components are contained in the mixture.

A weight percent (wt. %) of a component, unless specifically stated to the contrary, is based on the total weight of the formulation or composition in which the component is included.

It will be understood that when an element is referred to as being “connected” or “coupled” to another element, it can be directly connected or coupled to the other element, or intervening elements may be present. In contrast, when an element is referred to as being “directly connected” or “directly coupled” to another element, there are no intervening elements present. Other words used to describe the relationship between elements or layers should be interpreted in a like fashion (e.g., “between” versus “directly between,” “adjacent” versus “directly adjacent,” “on” versus “directly on”).

As used herein, the term “and/or” includes any and all combinations of one or more of the associated listed items.

It will be understood that although the terms “first,” “second,” etc., may be used herein to describe various elements, components, regions, layers, and/or sections. These elements, components, regions, layers, and/or sections should not be limited by these terms. These terms are only used to distinguish one element, component, region, layer, or section from another element, component, region, layer, or section. Thus, a first element, component, region, layer, or section discussed below could be termed a second element, component, region, layer, or section without departing from the teachings of example embodiments.

As used herein, the term “substantially” means that the subsequently described event or circumstance completely occurs or that the subsequently described event or circumstance generally, typically, or approximately occurs.

Still further, the term “substantially” can, in some aspects, refer to at least about 80%, at least about 85%, at least about 90%, at least about 91%, at least about 92%, at least about 93%, at least about 94%, at least about 95%, at least about 96%, at least about 97%, at least about 98%, at least about 99%, or about 100% of the stated property, component, composition, or other condition for which substantially is used to characterize or otherwise quantify an amount.

In other aspects, as used herein, the term “substantially free,” when used in the context of a composition or component of a composition that is substantially absent, is intended to refer to an amount that is then about 1% by weight, e.g., less than about 0.5% by weight, less than about 0.1% by weight, less than about 0.05% by weight, or less than about 0.01% by weight of the stated material, based on the total weight of the composition.

As used herein, the terms “substantially identical reference composition,” “substantially identical reference article,” or “substantially identical reference electrochemical cell” refer to a reference composition, article, or electrochemical cell comprising substantially identical components in the absence of an inventive component. In another exemplary aspect, the term “substantially,” in, for example, the context “substantially identical reference composition,” or “substantially identical reference article,” or “substantially identical reference electrochemical cell,” refers to a reference composition, article, or an electrochemical cell comprising substantially identical components and wherein an inventive component is substituted with a common in the art component.

While aspects of the present invention can be described and claimed in a particular statutory class, such as the system statutory class, this is for convenience only and one of ordinary skill in the art will understand that each aspect of the present invention can be described and claimed in any statutory class. Unless otherwise expressly stated, it is in no way intended that any method or aspect set forth herein be construed as requiring that its steps be performed in a specific order. Accordingly, where a method claim does not specifically state in the claims or descriptions that the steps are to be limited to a specific order, it is in no way intended that an order be inferred in any respect. This holds for any possible non-express basis for interpretation, including matters of logic with respect to the arrangement of steps or operational flow, plain meaning derived from grammatical organization or punctuation, or the number or type of aspects described in the specification.

The present invention may be understood more readily by reference to the following detailed description of various aspects of the invention and the examples included therein and to the Figures and their previous and following description.

### Electrochemical Cell

In some aspects disclosed herein is an electrochemical cell comprising a conductive host material configured to sustain a plurality of plating/stripping cycles such that an active anode metal material is repeatedly plated and then stripped during the electrochemical cell operation. In certain aspects, the host material comprises of: a) a substrate; and b) a coating disposed on the substrate, where the coating comprises at least one chalcogen. In yet other aspects, at least one chalcogen comprises sulfur (S), tellurium (Te), selenium (Se), antimony (Sb), or a combination thereof.

In yet still further aspects, the substrate comprises a metal web, a metal foam, a metal wire, a metal foil, or a metal strip.

While in still further aspects, the substrate comprises a rough surface. In such aspects, the substrate can be roughened prior to disposing of the coating.

While in still further aspects, the substrate comprises copper, aluminum, alloys of copper, or alloys of aluminum. In yet still further aspects, the substrate can be non-metallic and comprise carbon. For example, in such exemplary and unlimiting aspects, the substrate can comprise graphite, reduced oxide graphene, exfoliated graphene, or epitaxial graphene.

In yet still further aspects, the coating comprises an in-situ formed intermetallic complex between the active material and at least one chalcogen.

In yet still further aspects, the intermetallic complex is irreversible.

In yet still further aspects, the intermetallic complex is formed in-situ during a first plating cycle.

In yet still further aspects, the coating can be disposed on at least one surface of the substrate. While in still further aspects, the coating forms a uniform or irregular covering of the substrate. It is understood that the term “uniform,” as referred herein related to the coating having a substantially identical thickness over various portions of the substrate. In yet still further aspects, the coating can conform to the at least one surface of the substrate. While in still further aspects, the coating is a continuous or discontinuous film over the substrate. In still further aspects, the coating has a thickness from 0.001 microns to 1,000,000 microns, including exemplary values of about 0.005 microns, about 0.01 microns, about 0.05 microns, about 0.1 microns, about 0.5 microns, about 1 micron, about 10 microns, about 50 microns, about 100 microns, about 500 microns, about 1,000 microns, about 5,000 microns, about 20,000 microns, about 50,000 microns, about 100,000 microns, about 250,000 microns, about 500,000 microns, about 900,000 microns. In yet still further aspects, the coating has a thickness from 0.001 microns to 1,000 microns, including exemplary values of about 0.005 microns, about 0.01 microns, about 0.05 microns, about 0.1 microns, about 0.5 microns, about 1 micron, about 10 microns, about 50 microns, about 70 microns, about 100 microns, about 200 microns, about 300 microns, about 400 microns, about 600 microns, about 700 microns, about 800 microns, and about 900 microns.

In yet still further aspects, the at least one chalcogen is present in the coating in an amount from about 0.0001 mg/cm² to about 100 mg/cm². In still further aspects, the amount can include exemplary values of about 0.1 mg/cm², about 0.2 mg/cm², about 0.3 mg/cm², about 0.4 mg/cm², about 0.5 mg/cm², about 0.6 mg/cm², about 0.7 mg/cm², about 0.8 mg/cm², about 0.9 mg/cm², about 0.99 mg/cm², about 1 mg/cm², about 10 mg/cm², about 15 mg/cm², about 20 mg/cm², about 25 mg/cm², about 30 mg/cm², about 35 mg/cm², about 40 mg/cm², about 45 mg/cm², about 50 mg/cm², about 55 mg/cm², about 60 mg/cm², about 65 mg/cm², about 70 mg/cm², about 75 mg/cm², about 80 mg/cm², about 85 mg/cm², about 90 mg/cm², about 95 mg/cm², and about 100 mg/cm².

In yet still further aspects, the coating comprises at least one single element of the at least one chalcogen, a reactive oxide of the at least one chalcogen, a solid solution of two or more chalcogens, or an intermetallic compound of two or more chalcogens.

In yet still further aspects, the coating can be formed by vapor deposition, solution deposition, co-rolling, thermal processing, chemical deposition, electrochemical deposition, spray drying, spin coating, hydrothermally, or any combination thereof.

In some aspects, the electrochemical cell can further comprise an electrolyte. In still further aspects, any suitable for the desired purpose electrolytes can be utilized. In still further aspects, the electrolyte comprises a salt and a non-aqueous solvent.

In some exemplary aspects, the salt can comprise any salt commonly used in the batteries. In yet further aspects, the salt comprises a potassium, sodium, lithium, magnesium, calcium, or aluminum salt of bis(fluorosulfonyl) imide, perchlorate, tetrafluoroborate hexafluorophosphate, hexafluroarsenate, or a potassium, sodium, or lithium salt of aluminum tetrachloride, boron tetrachloride iodide, chlorate, borate, iodate, or a combination thereof. In yet further aspects, the salt comprises ions of the active anode metal material.

In some aspects, the non-aqueous solvent comprises dioxane, ethylene carbonate, dimethyl carbonate, diethyl carbonate, ethyl methyl carbonate, polyoxylene, fluoroethylene carbonate, propylene carbonate, N-methyl acetamide, acetonitrile, symmetric sulfone, sulfolane, polyethylene glycol, dimethoxyethane, 1,3-dioxolane, glymes, siloxane, ethylene oxide grafted sulfolane, or a combination thereof.

In some aspects, the electrolyte is a solid electrolyte. In still further aspects, the solid electrolyte can comprise sulfide compounds, garnet structure oxides, LISICON-type solids, NASICON-or KSICON-type phosphate glass ceramics, perovskite-type and anti-perovskite type compounds, nitrides, oxynitrides, argyrodite-type, or polymer-based electrolytes, or any combination thereof. If the electrolyte is polymer-based, such electrolytes can further comprise an alkali metal, an alkaline-earth metal salt, or a combination thereof.

In still further aspects, the alkali metal salt or alkaline-earth metal salt present in the solid electrolyte can comprise any of the alkali metal salt that is suitable for the desired application. It is also understood that the alkali metal salt or alkaline-earth metal salt composition can be defined by the final use. For example, if the solid electrolyte is designed for use in a lithium electrochemical cell, the alkali metal salt can comprise Li cations. However, it is also understood that if the solid electrolyte is designed for use in sodium or potassium electrochemical cells, the alkali metal salt can comprise Na or K cations and the like.

In still further aspects, the alkali metal salt comprises one or more of bis(trifluoromethane)sulfonimide lithium salt (LiTFSI), lithium perchlorate (LiClO₄), lithium tetrafluoroborate (LiBF₄), lithium hexafluorophosphate (LiPF₆), lithium hexafluroarsenate (LiAsF₆), lithium bis(fluorosulfonyl)imide (LiFSI), lithium aluminum tetrachloride (LiAlCl₄), lithium boron tetrachloride (LiBCl₄), lithium iodide (LiI), lithium chlorate (LiClO₃), LiBrO₃, LiIO₃, or a combination thereof. It is understood that similar salts of K and Na can also be utilized if desired.

In still further aspects, the polymer can comprise poly(ethylene oxide) (PEO) polymer, polyethylene glycol (PEG), polyvinylidene fluoride (PVDF), poly(vinyl alcohol) (PVA), poly(vinyl chloride) (PVC), polyacrylonitrile (PAN), poly(methyl methacrylate) (PMMA), poly(vinylidene fluoride-co-hexafluoropropylene) (PVdF-HFP), or any combination thereof. In still further aspects, the polymer can comprise a mixture of the polymers, for example, and without limitations, such as a cross-linked polymer blend comprising PEO or PEO-PVDF may be selected.

In still further aspects, the solid electrolyte can further comprise a lithium germanium phosphorous sulfide electrolyte, a lithium phosphorus oxynitride electrolyte, a lithium phosphorous sulfide electrolyte, lithium lanthanum zirconium oxide, lithium lanthanum titanium oxide, lithium aluminum germanium phosphate, lithium nitride, or any combination thereof. While in other aspects, if the anode material is K or Na, the solid electrolytes disclosed above can comprise Na or K incorporated within in addition to Li or instead of Li. For example, and without limitations, it can be a sodium phosphorus sulfide electrolyte or a potassium phosphorus sulfide electrolyte.

In yet other aspects, the solid electrolytes can comprise mixed-anion anti-perovskite, such as Li₃OCl_{0.5}Br_{0.5} and Na₃SCl_{0.5}(BCl₄)_{0.5}. In yet other aspects, the solid electrolytes can comprise Li₇PS₆, Na₃Zr₂Si₂PO₁₂, LiBH₄, Na₃PS, Li₂OHCl, Li₇La₃Zr₂O₁₂. In yet, in still further aspects, Li₇La₃Zr₂O₁₂ electrolytes can also be doped with other metals such as, for example, and without limitations, Ca, Al, W, Ni, Mn, Nb, or any combination thereof. In yet still further aspects, the doped Li₇La₃Zr₂O₁₂ electrolytes can have additional coatings such as Al coating, Si coating, Ge coating, graphite coating, or a combination thereof. In still further exemplary and unlimiting aspects, the solid electrolytes can also comprise any of Na₃SbS₄, Na₃PS₄, Ma₃P_{0.62}As_{0.38}S₄, Na₃Zr₂PSi₂O₁₂, Na_{3.2}Ca_{0.1}Zr_{1.9}PSi₂O₁₂, Na_{3.2}Zr₂P_{0.6}Si_{2.4}O₁₂, Na₃Zr₂PSi₂O₁₂/PEO/NaClO₄ composite, Na₃Zr₂PSi₂O₁₂/Na₂B₄O₇, Na_{3.4}Zr_{1.9}Zn_{0.1}Si_{2.2}P₀·8O₁₂/polydopamine, and the like.

In still further aspects, the electrolyte is a hybrid liquid-solid electrolyte. In such aspects, any of the disclosed above liquid electrolytes (electrolytes comprising the disclosed above salts and non-aqueous solvents) and any of the disclosed above solid electrolytes can be combined to form the hybrid liquid-solid electrolyte.

In still further aspects, the support material disclosed above can be disposed on a substrate. In such aspects, the substrate comprises stainless steel, aluminum, titanium, tungsten, copper, or a combination thereof. Yet, in other aspects, any known in the art of battery support materials can be used. In certain aspects, the support material can be a polymer. Again, any polymers known in the art of batteries can be utilized for this purpose.

In still further aspects, the electrochemical cell disclosed herein can be a battery. In some aspects, the battery is a primary battery. While in other aspects, the battery is a secondary battery. In such exemplary aspects, the battery can be a metal battery or an ion-metal battery.

In yet still further aspects, the active anode metal material comprises Li, Na, K, Zn, Mg, Li alloys, Na alloys, K alloys, or any combination thereof. In aspects disclosed herein, the anode can comprise ions and/or metals of potassium, sodium, lithium, or a combination thereof.

In yet further aspects, the host material is plated with the anode metal material, the anode metal material exhibits a discharge capacity from about 0.001 mAh cm² to about 1,000,000 mAh cm², including exemplary values of about 0.005 mAh cm², about 0.01 mAh cm², about 0.05 mAh cm² about 0.1 mAh cm², about 0.5 mAh cm², about 1 mAh cm², about 10 mAh cm², about 50 mAh cm², about 100 mAh cm², about 500 mAh cm², about 1,000 mAh cm², about 5,000 mAh cm², about 20,000 mAh cm², about 50,000 mAh cm², about 100,000 mAh cm², about 250,000 mAh cm², about 500,000 mAh cm², and about 900,000 mAh cm². In yet still further aspects, the plated anode metal material exhibits a discharge capacity from about 0.001 mAh cm² to 1,000 mAh cm², including exemplary values of about 0.005 mAh cm², about 0.01 mAh cm², about 0.05 mAh cm², about 0.1 mAh cm², about 0.5 mAh cm², about 1 mAh cm², about 10 mAh cm², about 50 mAh cm², about 70 mAh cm², about 100 mAh cm², about 200 mAh cm², about 300 mAh cm², about 400 mAh cm², about 600 mAh cm², about 700 mAh cm², about 800 mAh cm², and about 900 mAh cm².

In yet further aspects, the anode metal material uniformly plates the host material.

In yet still further aspects, the plated active anode metal material exhibits substantially no dendrites in the plating or stripping cycle.

In still further aspects, the electrochemical cells described herein can exhibit cumulative plating/stripping of up to at least about 800 cycles, up to about 900 hours, up to about 1,000 hours, up to about 1,100 hours, up to about 1,200 hours, up to about 1,300 hours, up to about 1,400 hours, up to about 1,500 hours, up to about 1,600 hours, up to about 1,700 hours, up to about 1,800 hours, up to about 1,900 hours, up to about 2,000 hours, up to about 2,100 hours, up to about 2,200 hours, up to about 2,300 hours, up to about 2,400 hours, up to about 2,500 hours, up to about 2,600 hours, up to about 2,700 hours, up to about 2,800 hours, up to about 2,900 hours, up to about 3,000 hours, hours, up to about 5,000 hours, up to about 10,000 hours, up to about 20,000 hours, up to about 30,000 hours, up to about 40,000 hours, up to about 50,000 hours, up to about 60,000 hours, up to about 70,000 hours, up to about 80,000 hours, up to about 90,000 hours, or up to about 100,000 hours at a current density from greater than about 0.001 mA cm⁻² to about 1000 mA cm⁻², including exemplary values of about 1 mA cm⁻², about 50 mA cm⁻², about 150 mA cm⁻², about 200 mA cm⁻² about 250 mA cm⁻², about 300 mA cm⁻², about 350 mA cm⁻², about 400 mA cm⁻² about 450 mA cm⁻², about 500 mA cm⁻², about 550 mA cm⁻², about 600 mA cm⁻² about 650 mA cm⁻², about 700 mA cm⁻², about 750 mA cm⁻², about 800 mA cm⁻² about 850 mA cm⁻², about 900 mA cm⁻², about 950 mA cm⁻², and about 1000 mA cm⁻².

In yet still further aspects, the active anode metal material is substantially fully removed from the host material in the stripping cycle.

In further aspects, the disclosed electrochemical cell further comprises a cathode material. It is understood that any known in the art cathode materials that can be useful for the desired purpose can be utilized. In some aspects, the cathode can be a metal cathode or composite cathode.

If the metal cathode is used, such an electrochemical cell can be a symmetrical electrochemical cell. In such an exemplary aspect, when the electrochemical cell is symmetrical, both anode and cathode comprise the same material, for example, and without limitation, it can comprise Li or K or Na, or a combination thereof.

In yet still further aspects, the cathode is a metal cathode, ceramic cathode, or composite cathode. In yet still further aspects, the cathode comprises copper, carbon, graphite, sodium, potassium, lithium, magnesium, calcium, aluminum, layered oxides, vanadium-based cathode, sulfur-based cathode, spinels, olivines, or any combination thereof.

In still further aspects, the cathode material can be a composite material. In such aspects, if the electrochemical cell is a lithium electrochemical cell, any known in the art cathode materials that are useful in the Li cell can be utilized. If the electrochemical cell is K or Na cell, any known in the art cathode materials that are useful in Na or K cells can be utilized.

In some aspects, the cathode can also comprise copper, carbon, graphite, sodium, potassium, lithium, magnesium, calcium, aluminum, layered oxides, vanadium-based cathode, sulfur-based cathode, manganese-based cathode, rocksalt cathode, disordered rocksalt cathode, lithium-rich cathode, high voltage ceramic, low voltage ceramic, NMC (nickel-manganese-cobalt oxide) cathode, NCA (nickel-cobalt-aluminum oxide) cathode, LCO (lithium-cobalt oxide) cathode, LFP (lithium iron phosphate) cathode, fluoride-based cathode, sulfur selenium cathode, sulfur selenium tellurium cathode, spinels, olivines, or any combination thereof.

In yet still further aspects, the cathode can comprise a LiFePO₄ composite cathode, a LiNi_{0.8}Co_{0.15}Al_{0.05}O₂, a LiNi_{1/3}Mn_{1/3}Co_{1/3}O₂, a LiNi_{0.4}Mn_{0.3}Co_{0.3}O₂, a LiNi_{0.5}Mn_{0.3}Co_{0.2}O₂, a LiNi_{0.6}Mn_{0.2}Co_{0.2}O₂, a LiNi_{0.8}Mn_{0.1}Co_{0.1}O₂ composite cathode. In still further aspects, the cathode can comprise KFe^{II}Fe^{III}(CN)₆, NaFe^{II}Fe^{III}(CN)₆, Na₃V₂(PO₄)₃, LiFePO₄, Li(NiCoMn)O₂, or any combination thereof. In yet still further aspects, the cathode material can also comprise a poly(ethylene oxide), cellulose, carboxymethylcellulose (CMC), and a polytetrafluoroethylene (PTFE), styrene-butadiene rubber (SBR), or a polyvinylidene fluoride binder.

In still further aspects, the cell exhibits a reversible capacity of at least about 50 mAh g⁻¹, about 70 mAh g⁻¹, about 100 mAh/g⁻¹, about 200 mAh/g⁻¹, about 300 mAh/g⁻¹, about 400 mAh/g⁻¹, about 500 mAh/g⁻¹, about 600 mAh/ g⁻¹, about 700 mAh/g⁻¹, about 800 mAh/g⁻¹, about 900 mAh/g⁻¹, or about 1,000 mAh/g⁻¹ after 10,000 cycles at a current density of about 0.01 C to about 20 C, including exemplary values of about 0.1 C, about 1 C, about 2 C, about 3 C, about 4 C, about 5 C, about 6 C, about 7 C, about 8 C, about 9 C, about 10 C, about 11 C, about 12 C, about 13 C, about 14 C, about 15 C, about 16 C, about 17 C, about 18 C, about 19 C, and about 20 C.

In yet still further aspects, the electrochemical cells described herein can exhibit a coulombic efficiency of greater than about 50%, greater than about 55%, greater than about 60%, greater than about 65%, greater than about 70%, greater than about 75%, greater than about 80%, greater than about 85%, greater than about 90%, greater than about 95%, or greater than about 99%.

In yet still further aspects, the cell exhibits a coulombic efficiency of greater than about 95%, including exemplary values of greater than 96%, greater than 97%, greater than 98%, and greater than 99%. In yet still further aspects, the cell exhibits a coulombic efficiency of greater than about 99%, including exemplary values of greater than 99.1%, greater than 99.2%, greater than 99.3%, greater than 99.4%, greater than 99.5%, greater than 99.6%, greater than 99.7%, greater than 99.8%, and greater than 99.9%.

In still further aspects, the electrochemical cell is configured to operate in a temperature range from about 20° C. up to about 60° C., including exemplary values of about 25° C., about 30° C., about 35° C., about 40° C., about 45° C., about 50° C., and about 55° C. It is understood that a time window for the cell operation can be dependent on the operating conditions, such as operating current density and areal capacity.

In some additional aspects disclosed herein is an electrochemical cell comprising a conductive host material configured to sustain a plurality of plating/stripping cycles such that an active anode metal material is repeatedly plated and stripped during the electrochemical cell operation and wherein the host material further comprises a substrate and a coating, wherein the coating comprises an in-situ formed intermetallic complex comprising at least one first element and at least one second element, wherein at least one second element comprises the active anode metal material.

The disclosed cell has significant advantages over the currently existing Li (or alternatively Na or K) batteries, as it can be formed by simplified manufacturing procedures. The methods of making the host material do not require the presence of a glove box. The simple use of an oven allows a thermal deposition of the first element on the substrate. The intermetallic complex is formed under standard cell operating procedures during the first plating cycle. The formed complex is irreversible. The coating comprising this irreversible intermetallic complex exhibits an improved wettability to the anode metal material during the cell operation and thus provides a highly efficient and safe battery. In yet still further aspects, at least one first element is selected from sulfur (S), tellurium (Te), selenium (Se), antimony (Sb), aluminum, magnesium, or alloys thereof. In yet still further aspects, at least one second element is selected from Li, Na, K, Zn, Mg, Li alloys, Li intermetallics, Li compounds, Na alloys, Na intermetallics, Na compounds, K alloys, K intermetallics, K compounds or any combination thereof.

In yet still further aspects, the in-situ formed intermetallic complex is irreversible.

In still further aspects, this exemplary electrochemical cell can comprise an electrolyte. In such exemplary and unlimiting aspects, the electrolyte can be a solid electrolyte comprising at least one of sulfide compounds, garnet structure oxides, LISICON-type solids, NASICON-or KSICON-type phosphate glass ceramics, perovskite-type and anti-perovskite type compounds, nitrides, oxynitrides, argyrodite-type, or polymer-based electrolytes, or any combination thereof. If the electrolyte is polymer-based, such electrolytes can further comprise an alkali metal, an alkaline-earth metal salt, or a combination thereof.

In yet still further aspects, the active anode metal material comprises Li, Na, K, Zn, Mg, Li alloys, Li intermetallics, Li compounds, Na alloys, Na intermetallics, Na compounds, K alloys, K intermetallics, K compounds or any combination thereof.

In yet still further aspects, at least the first element is coated on the substrate prior to in-situ formation of the intermetallic complex between the at least first element and the at least the second element.

In yet still further aspects, the coating can be disposed on at least one surface of the substrate. While in still further aspects, the coating forms a uniform or irregular covering of the substrate. It is understood that the term “uniform,” as referred herein related to the coating having a substantially identical thickness over various portions of the substrate. In yet still further aspects, the coating can conform to the at least one surface of the substrate. While in still further aspects, the coating is a continuous or discontinuous film over the substrate. In still further aspects, the coating has a thickness from about 0.001 microns to about 1,000,000 microns, including exemplary values of about 0.005 microns, about 0.01 microns, about 0.05 microns, about 0.1 microns, about 0.5 microns, about 1 micron, about 10 microns, about 50 microns, about 100 microns, about 500 microns, about 1,000 microns, about 5,000 microns, about 20,000 microns, about 50,000 microns, about 100,000 microns, about 250,000 microns, about 500,000 microns, about 900,000 microns. In yet still further aspects, the coating has a thickness from about 0.001 microns to about 1,000 microns, including exemplary values of about 0.005 microns, about 0.01 microns, about 0.05 microns, about 0.1 microns, about 0.5 microns, about 1 micron, about 10 microns, about 50 microns, about 70 microns, about 100 microns, about 200 microns, about 300 microns, about 400 microns, about 600 microns, about 700 microns, about 800 microns, and about 900 microns.

In yet still further aspects, the at least one first element is present in the coating in an amount from about 0.0001 mg/cm² to about 100 mg/cm². In still further aspects, the amount can include exemplary values of about 0.1 mg/cm², about 0.2 mg/cm², about 0.3 mg/cm², about 0.4 mg/cm², about 0.5 mg/cm², about 0.6 mg/cm², about 0.7 mg/cm², about 0.8 mg/cm², about 0.9 mg/cm², about 0.99 mg/cm², about 1 mg/cm², 1 about 0 mg/cm², about 15 mg/cm², about 20 mg/cm², about 25 mg/cm², about 30 mg/cm², about 35 mg/cm², about 40 mg/cm², about 45 mg/cm², about 50 mg/cm², about 55 mg/cm², about 60 mg/cm², about 65 mg/cm², about 70 mg/cm², about 75 mg/cm², about 80 mg/cm², about 85 mg/cm², about 90 mg/cm², about 95 mg/cm², and about 100 mg/cm².

In yet still further aspects, during the operation of the electrochemical cell, the plated anode metal material exhibits a discharge capacity from about 0.001 mAh cm² to about 1,000,000 mAh cm², including exemplary values of about 0.005 mAh cm², about 0.01 mAh cm², about 0.05 mAh cm² about 0.1 mAh cm², about 0.5 mAh cm², about 1 mAh cm², about 10 mAh cm², about 50 mAh cm², about 100 mAh cm², about 500 mAh cm², about 1,000 mAh cm², about 5,000 mAh cm², about 20,000 mAh cm², about 50,000 mAh cm², about 100,000 mAh cm², about 250,000 mAh cm², about 500,000 mAh cm², about 900,000 mAh cm². In yet still further aspects, the plated anode metal material exhibits a discharge capacity from about 0.001 mAh cm² to 1,000 mAh cm², including exemplary values of about 0.005 mAh cm², about 0.01 mAh cm², about 0.05 mAh cm², about 0.1 mAh cm², about 0.5 mAh cm², about 1 mAh cm², about 10 mAh cm², about 50 mAh cm², about 70 mAh cm², about 100 mAh cm², about 200 mAh cm², about 300 mAh cm², about 400 mAh cm², about 600 mAh cm², about 700 mAh cm², about 800 mAh cm², and about 900 mAh cm².

In yet still further aspects, during the operation of the electrochemical cell, the anode metal material uniformly plates the host material.

In yet still further aspects, during the operation of the electrochemical cell, the plated active anode metal material exhibits substantially no dendrites in the plating or stripping cycle.

In yet still further aspects, it is understood that the intermetallic complex allows improved wettability of the host material with the active anode metal material, and therefore the active anode metal material uniformly plates the host substantially without forming any dendrites in the plating or stripping cycle.

In yet still further aspects, the disclosed electrochemical cell exhibits up to at least 800 cycles of cumulative plating/stripping at a current density from greater than 0.001 mA cm⁻² to about 1000 mA cm⁻², including exemplary values of about 1 mA cm⁻², about 50 mA cm⁻², about 150 mA cm⁻², about 200 mA cm⁻², about 250 mA cm⁻², about 300 mA cm⁻², about 350 mA cm⁻², about 400 mA cm⁻², about 450 mA cm⁻² about 500 mA cm⁻², about 550 mA cm⁻², about 600 mA cm⁻², about 650 mA cm⁻² about 700 mA cm⁻², about 750 mA cm⁻², about 800 mA cm⁻², about 850 mA cm⁻² about 900 mA cm⁻², about 950 mA cm⁻², and about 1,000 mA cm⁻².

In yet still further aspects, the active anode metal material is substantially fully removed from the host material in the stripping cycle.

If the metal cathode is used, such an electrochemical cell can be a symmetrical electrochemical cell. In such an exemplary aspect, when the electrochemical cell is symmetrical, both anode and cathode comprise the same material, for example, and without limitation, it can comprise Li or K or Na, or a combination thereof.

In yet still further aspects, the cathode is a metal cathode, ceramic cathode, or composite cathode. In yet still further aspects, the cathode comprises copper, carbon, graphite, sodium, potassium, lithium, magnesium, calcium, aluminum, layered oxides, vanadium-based cathode, sulfur-based cathode, spinels, olivines, or any combination thereof.

In still further aspects, the cathode material can be a composite material. In such aspects, if the electrochemical cell is a lithium electrochemical cell, any known in the art cathode materials that are useful in the Li cell can be utilized. If the electrochemical cell is K or Na cell, any known in the art cathode materials that are useful in Na or K cells can be utilized.

In some aspects, the cathode can also comprise copper, carbon, graphite, sodium, potassium, lithium, magnesium, calcium, aluminum, layered oxides, vanadium-based cathode, sulfur-based cathode, manganese-based cathode, rocksalt cathode, disordered rocksalt cathode, lithium-rich cathode, high voltage ceramic, low voltage ceramic, NMC (nickel-manganese-cobalt oxide) cathode, NCA (nickel-cobalt-aluminum oxide) cathode, LCO (lithium-cobalt oxide) cathode, LFP (lithium iron phosphate) cathode, fluoride-based cathode, sulfur selenium cathode, sulfur selenium tellurium cathode, spinels, olivines, or any combination thereof.

In yet still further aspects, the cathode can comprise a LiFePO₄ composite cathode, a LiNi_{0.8}Co_{0.15}Al_{0.05}O₂, a LiNi_{1/3}Mn_{1/3}Co_{1/3}O₂, a LiNi_{0.4}Mn_{0.3}Co_{0.3}O₂, a LiNi_{0.5}Mn_{0.3}Co_{0.2}O₂, a LiNi_{0.6}Mn_{0.2}Co_{0.2}O₂, a LiNi_{0.8}Mn_{0.1}Co_{0.1}O₂ composite cathode. In still further aspects, the cathode can comprise KFe^{II}Fe^{III}(CN)₆, NaFe^{II}Fe^{III}(CN)₆, Na₃V₂(PO₄)₃, LiFePO₄, Li(NiCoMn)O₂, or any combination thereof. In yet still further aspects, the cathode material can also comprise a poly(ethylene oxide), cellulose, carboxymethylcellulose (CMC), and a polytetrafluoroethylene (PTFE), styrene-butadiene rubber (SBR), or a polyvinylidene fluoride binder.

In still further aspects, this exemplary cell comprising the intermetallic complex in the coating on the substrate can exhibit a reversible capacity of at least about 50 mAh g⁻¹, about 70 mAh g⁻¹, about 100 mAh/g⁻¹, about 200 mAh/g⁻¹, about 300 mAh/g⁻¹, about 400 mAh/g⁻¹, about 500 mAh/g⁻¹, about 600 mAh/g⁻¹, about 700 mAh/g⁻¹, about 800 mAh/g⁻¹, about 900 mAh/g⁻¹, or about 1,000 mAh/g⁻¹ after 10,000 cycles at a current density of about 0.01 C to about 20 C, including exemplary values of about 0.1 C, about 1 C, about 2 C, about 3 C, about 4 C, about 5 C, about 6 C, about 7 C, about 8 C, about 9 C, about 10 C, about 11 C, about 12 C, about 13 C, about 14 C, about 15 C, about 16 C, about 17 C, about 18 C, about 19 C, and about 20 C.

In yet still further aspects, the electrochemical cells described herein can exhibit a coulombic efficiency of greater than about 50%, greater than about 55%, greater than about 60%, greater than about 65%, greater than about 70%, greater than about 75%, greater than about 80%, greater than about 85%, greater than about 90%, greater than about 95%, or greater than about 99%.

In yet still further aspects, the cell exhibits a coulombic efficiency of greater than about 95%, including exemplary values of greater than 96%, greater than 97%, greater than 98%, and greater than 99%. In yet still further aspects, the cell exhibits a coulombic efficiency of greater than about 99%, including exemplary values of greater than 99.1%, greater than 99.2%, greater than 99.3%, greater than 99.4%, greater than 99.5%, greater than 99.6%, greater than 99.7%, greater than 99.8%, and greater than 99.9%.

In still further aspects, the electrochemical cell is configured to operate in a temperature range from about 20° C. up to about 60° C., including exemplary values of about 25° C., about 30° C., about 35° C., about 40° C., about 45° C., about 50° C., and about 55° C. It is understood that a time window for the cell operation can be dependent on the operating conditions, such as operating current density and areal capacity.

In still further aspects, a battery comprises of an electrochemical cell of any of the present disclosures.

By way of example, electrochemical cells of the present disclosure may be used in portable batteries, including those in hand-held and/or wearable electronic devices, such as a phone, watch, or laptop computer; in stationary electronic devices, such as a desktop or mainframe computer; in an electric tool, such as a power drill; in an electric or hybrid land, water, or air-based vehicle, such as a boat, submarine, bus, train, truck, car, motorcycle, moped, powered bicycle, airplane, drone, other flying vehicle, or toy versions thereof; for other toys; for energy storage, such as in storing electric power from wind, solar, wave, hydropower, or nuclear energy and/or in grid storage, or as a stationary power store for small-scale use, such as for a home, business, or hospital.

In addition, batteries, according to the present disclosure, may be multi-cell batteries containing at least about 10, at least about 100, at least about 500, between 10 and 10,000, between 100 and 10,000, between 1,000 and 10,000, between 10 and 1000, between 100 and 1,000, or between 500 and 1,000 electrochemical cells of the present disclosure. Cells in multi-cell batteries may be arranged in parallel or in series.

### Methods

Also disclosed herein are the methods of making the disclosed herein electrochemical cells. In such aspects, the methods comprise providing a) a host material comprising wherein of a substrate and a coating disposed on the substrate where the coating comprises at least one chalcogen, b) providing an electrolyte; and c) plating an active anode metal material to form an anode.

In still further aspects, the host material is formed by depositing the at least one chalcogen comprising sulfur (S), tellurium (Te), selenium (Se), and antimony (Sb) or a combination thereof on at least one surface of the substrate.

In yet still further aspects, the substrate comprises a metal web, a metal foam, a metal wire, a metal foil, or a metal strip.

In yet still further aspects, the substrate comprises copper, aluminum, alloys of copper, or alloys of aluminum.

In yet still further aspects, during a first plating cycle an intermetallic complex is formed in the coating between the active anode metal material and at least one chalcogen.

In yet still further aspects, the intermetallic complex is irreversible.

In yet still further aspects, the step of depositing comprises one or more of vapor deposition, solution deposition, co-rolling, thermal processing, chemical deposition, electrochemical deposition, spray drying, spin coating, hydrothermally, or any combination thereof.

Still further disclosed herein are additional methods of making the disclosed herein electrochemical cells. In yet still, further aspects, disclosed herein is a method of making the disclosed electrochemical cell comprising of: (a) providing a host material comprising of a substrate and a coating disposed on the substrate where the coating comprises comprising at least one first element; (b) providing an electrolyte; (c) in-situ forming an intermetallic complex comprising the at least one first element and at least one second element, wherein at least one second element comprises an active anode metal material; and (d) plating the active anode metal material to form an anode.

In yet still further aspects, the coating is formed by vapor deposition, solution deposition, co-rolling, thermal processing, chemical deposition, electrochemical deposition, spray drying, spin coating, hydrothermally, or any combination thereof.

In yet still further aspects, the coating is formed by thermal deposition.

In yet still further aspects, the intermetallic complex is formed during a first plating cycle of the anode material, and wherein the intermetallic complex is irreversible

In yet still further aspects, the at least one first element is selected from sulfur (S), tellurium (Te), selenium (Se), antimony (Sb), aluminum, magnesium, or alloys thereof.

In yet still further aspects, at least one second element is selected from Li, Na, K, Zn, Mg, Li alloys, Li intermetallics, Li compounds, Na alloys, Na intermetallics, Na compounds, K alloys, K intermetallics, K compounds or any combination thereof. In such aspects, if the electrochemical cell is a lithium electrochemical cell, any known in the art cathode materials that are useful in the Li cell can be utilized. If the electrochemical cell is K or Na cell, any known in the art cathode materials that are useful in Na or K cells can be utilized.

In yet still further aspects, the electrolyte is a solid electrolyte comprising at least one of sulfide compounds, garnet structure oxides, LISICON-type solids, NASICON-or KSICON-type phosphate glass ceramics, perovskite-type and anti-perovskite type compounds, nitrides, oxynitrides, argyrodite-type, or polymer-based electrolytes, or any combination thereof.

In yet still further aspects, the active anode metal material comprises Li, Na, K, Zn, Mg, Li alloys, Li intermetallics, Li compounds, Na alloys, Na intermetallics, Na compounds, K alloys, K intermetallics, K compounds, or any combination thereof.

In yet still further aspects, the method of making the disclosed electrochemical cell further comprises of providing a cathode, wherein the cathode is a metal cathode, a ceramic cathode, or a composite cathode. It is understood that any known in the art cathode materials that can be useful for the desired purpose can be utilized. In some aspects, the cathode can be a metal cathode or composite cathode.

If the metal cathode is used, such an electrochemical cell can be a symmetrical electrochemical cell. In such an exemplary aspect, when the electrochemical cell is symmetrical, both anode and cathode comprise the same material, for example, and without limitation, it can comprise Li or K or Na, or a combination thereof.

In yet still further aspects, the cathode is a metal cathode, ceramic cathode, or composite cathode. In yet still further aspects, the cathode comprises copper, carbon, graphite, sodium, potassium, lithium, magnesium, calcium, aluminum, layered oxides, vanadium-based cathode, sulfur-based cathode, spinels, olivines, or any combination thereof.

In still further aspects, the cathode material can be a composite material. In such aspects, if the electrochemical cell is a lithium electrochemical cell, any known in the art cathode materials that are useful in the Li cell can be utilized. If the electrochemical cell is K or Na cell, any known in the art cathode materials that are useful in Na or K cells can be utilized.

In yet still further aspects, the cathode comprises copper, carbon, graphite, sodium, potassium, lithium, magnesium, calcium, aluminum, layered oxides, vanadium-based cathode, sulfur-based cathode, spinels, olivines, or any combination thereof. In some aspects, the cathode can also comprise copper, carbon, graphite, sodium, potassium, lithium, magnesium, calcium, aluminum, layered oxides, vanadium-based cathode, sulfur-based cathode, manganese-based cathode, rocksalt cathode, disordered rocksalt cathode, lithium-rich cathode, high voltage ceramic, low voltage ceramic, NMC (nickel-manganese-cobalt oxide) cathode, NCA (nickel-cobalt-aluminum oxide) cathode, LCO (lithium-cobalt oxide) cathode, LFP (lithium iron phosphate) cathode, fluoride-based cathode, sulfur selenium cathode, sulfur selenium tellurium cathode, spinels, olivines, or any combination thereof.

In yet still further aspects, the cathode can comprise a LiFePO₄ composite cathode, a LiNi_{0.8}Co_{0.15}Al_{0.05}O₂, a LiNi_{1/3}Mn_{1/3}Co_{1/3}O₂, a LiNi_{0.4}Mn_{0.3}Co_{0.3}O₂, a LiNi_{0.5}Mn_{0.3}Co_{0.2}O₂, a LiNi_{0.6}Mn_{0.2}Co_{0.2}O₂, a LiNi_{0.8}Mn_{0.1}Co_{0.1}O₂ composite cathode. In still further aspects, the cathode can comprise KFe^{II}Fe^{III}(CN)₆, NaFe^{II}Fe^{III}(CN)₆, Na₃V₂(PO₄)₃, LiFePO₄, Li(NiCoMn)O₂, or any combination thereof. In yet still further aspects, the cathode material can also comprise a poly(ethylene oxide), cellulose, carboxymethylcellulose (CMC), and a polytetrafluoroethylene (PTFE), styrene-butadiene rubber (SBR), or a polyvinylidene fluoride binder.

In still further aspects, the cell exhibits a reversible capacity of at least about 50 mAh g⁻¹, about 70 mAh g⁻¹, about 100 mAh/g⁻¹, about 200 mAh/g⁻¹, about 300 mAh/g⁻¹, about 400 mAh/g⁻¹, about 500 mAh/g⁻¹, about 600 mAh/g⁻¹, about 700 mAh/g⁻¹, about 800 mAh/g⁻¹, about 900 mAh/g⁻¹, or about 1,000 mAh/g⁻¹ after 10,000 cycles at a current density of about 0.01 C to about 20 C, including exemplary values of about 0.1 C, about 1 C, about 2 C, about 3 C, about 4 C, about 5 C, about 6 C, about 7 C, about 8 C, about 9 C, about 10 C, about 11 C, about 12 C, about 13 C, about 14 C, about 15 C, about 16 C, about 17 C, about 18 C, about 19 C, and about 20 C.

In yet still further aspects, the electrochemical cells described herein can exhibit a coulombic efficiency of greater than about 50%, greater than about 55%, greater than about 60%, greater than about 65%, greater than about 70%, greater than about 75%, greater than about 80%, greater than about 85%, greater than about 90%, greater than about 95%, or greater than about 99%.

In yet still further aspects, the cell exhibits a coulombic efficiency of greater than about 95%, including exemplary values of greater than about 96%, greater than about 97%, greater than about 98%, and greater than about 99%. In yet still further aspects, the cell exhibits a coulombic efficiency of greater than about 99%, including exemplary values of greater than about 99.1%, greater than about 99.2%, greater than about 99.3%, greater than about 99.4%, greater than about 99.5%, greater than about 99.6%, greater than about 99.7%, greater than about 99.8%, and greater than about 99.9%.

In still further aspects, the electrochemical cell is configured to operate in a temperature range from about 20° C. up to about 60° C., including exemplary values of about 25° C., about 30° C., about 35° C., about 40° C., about 45° C., about 50° C., and about 55° C. It is understood that a time window for the cell operation can be dependent on the operating conditions, such as operating current density and areal capacity.

By way of a non-limiting illustration, examples of certain aspects of the present disclosure are given below.

### EXAMPLES

The following examples are put forth so as to provide those of ordinary skill in the art with a complete disclosure and description of how the compounds, compositions, articles, devices, and/or methods claimed herein are made and evaluated and are intended to be purely exemplary and are not intended to limit the disclosure. Efforts have been made to ensure accuracy with respect to numbers (e.g., amounts, temperature, etc.), but some errors and deviations should be accounted for. Unless indicated otherwise, parts are parts by weight, temperature is degrees C. or is at ambient temperature, and pressure is at or near atmospheric.

### Example 1

In this study, a facile one-step annealing process is employed to fabricate chalcogen-treated three-dimensional (3D) copper foam (CF) with enhanced sodiophilicity for a stable Na metal anode. CF was chosen as the current collector due to its superior mechanical properties and commercial availability. Sulfur (S) and tellurium (Te) are selected as the representative chalcogens to modify the surface chemistry of CF, and the resulting sodiophilic substrates, especially Te-treated CF (Te@CF), showed improved Na wettability and electrochemical performance in both half cells and full cells compared with baseline CF. Particularly, symmetric cells with thermally infused Na electrodes (Te@CF-TNa) offered stable Na plating/stripping over 7000 hours, and full cells consisting of Te@CF-TNa anodes and Na₃V₂(PO₄)₃ cathodes exhibited superior electrochemical performance with up to 30 C rate and 10,000 stable cycles at 5 C and 10 C. Cryogenic electron microscopy (Cryo-EM) was applied for an in-depth mechanistic study of Na electroplating/electrostripping behaviors on different substrates. The fact is a sodiophilic surface promotes the wettability of Na, leading to the formation of a conformal film with uniform SEI covering on its surface. A sodiophobic surface, in turn, leads to poor Na wetting, subsequently forming a heterogenous island structure and a thickening SEI. The discrepant Na deposition behavior on different substrates can be observed even at a very early stage.

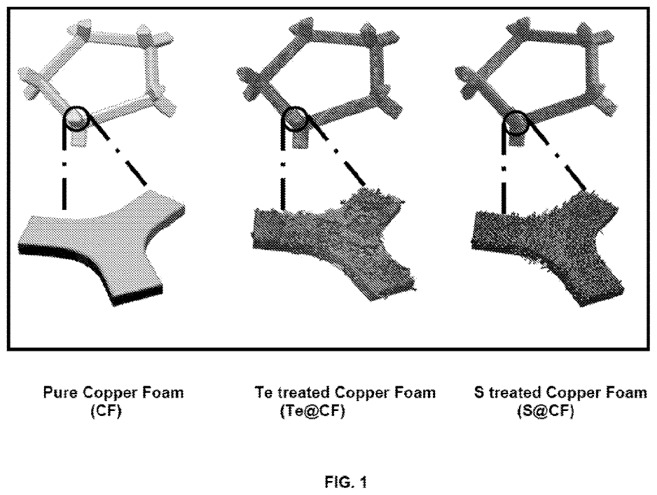

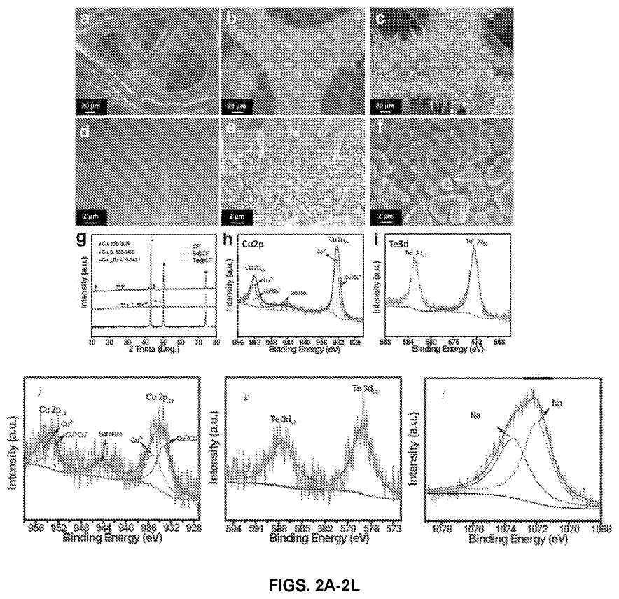

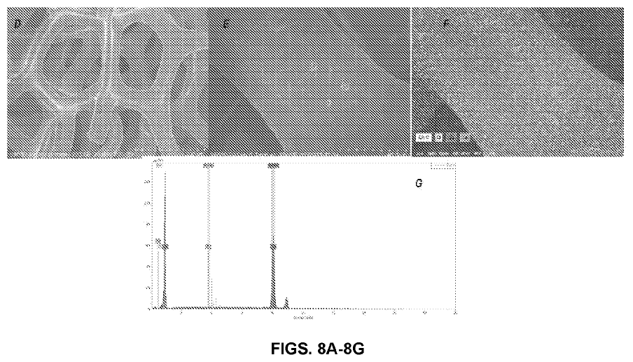

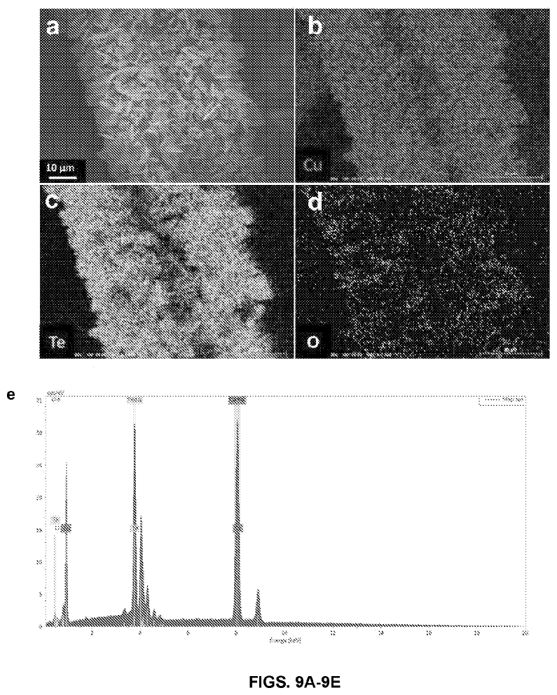

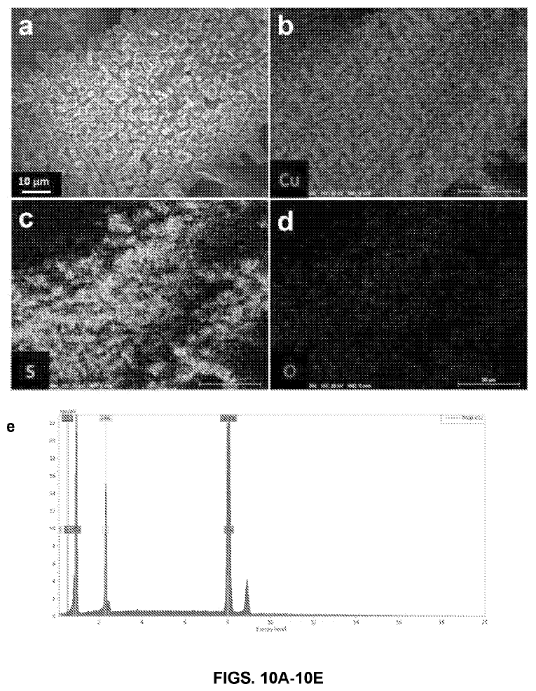

To prepare chalcogen-modified copper foams, commercial copper foam (CF) was first pressed to a thickness of 360 um by a hydraulic press (FIG. 8A). During the one-step sulfurization or tellurization process, evaporated Te and S molecules would react with CF at elevated temperatures, and the chalcogenization degree can be easily controlled by the amount of chalcogens added. FIG. 8B shows the front view of the as-obtained substrates with the color changing from reddish brown (CF) to grey for S@CF and black for Te@CF, indicating the alteration of surface chemistries. The back side (FIG. 8C), however, remains almost unchanged, and this single-face modification allows maximum utilization of the active materials. FIG. 1 illustrates the structural evolution of chalcogen-modified copper foams, and detailed surface morphologies are characterized by scanning electron microscopy (SEM). As shown in FIGS. 2A-2F, the originally smooth and glossy surface of CF changes completely after chalcogen treatment. Interlaced nanosheets with an average thickness of 200 nm and isolated nanorods with an average diameter of 2 μm can be observed vertically grown on Te@CF and S@CF sample surfaces, respectively. FIGS. 9A-9D show energy-dispersive X-ray spectroscopy (EDXS) analysis of Te@CF, and it may be concluded that the distribution of Te is geometrically uniform throughout the copper surface. The EDXS spectrum (FIG. 9E) indicates that no other impurity can be found except oxygen, which is owing to slight sample oxidation after exposure to air. A similar analysis was also performed on S@CF (FIG. 10).

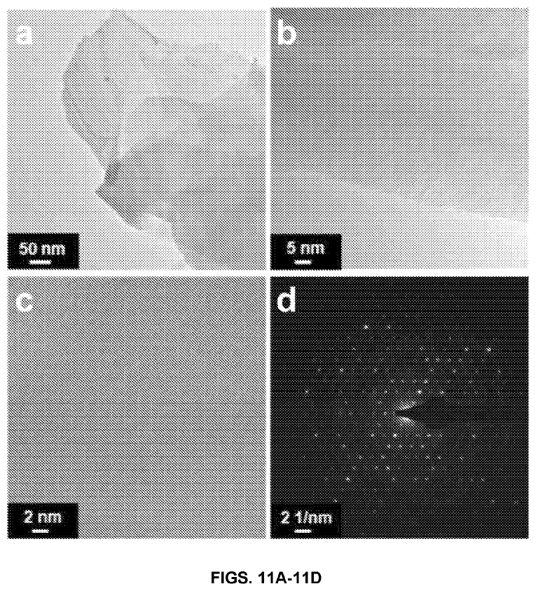

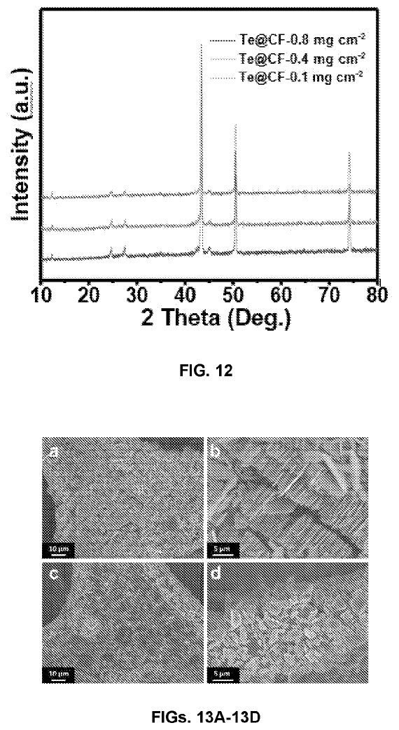

X-ray diffraction (XRD) measurement was carried out to study the physical structures of the modified copper foams. As shown in FIG. 2G, baseline commercial CF belongs to the fcc cubic Fm-3m space group (a=b=c=0.3613 nm) and exhibits three characteristic peaks at 43.3°, 50.4°, and 74.1°, corresponding to the (111), (200), (220) planes. After tellurization, four additional diffraction peaks at 12.2°, 24.6°, 27.5°, and 45.1° can be observed, which belong to the Cu₂₋ₓTe structure with hexagonal P3m1 space group (a=b=0.8342 nm, c=2.169 nm). FIG. 11 provides a transmission electron microscopy (TEM) study of the specimen that was collected from the surface of Te@CF. High-resolution TEM (HRTEM) images in FIGS. 11B-11C show clear lattice fringes, indicating its highly crystalized structure. The interplanar distance is xyz nm, which is in agreement with the d spacing of the (abs) plan and shows the growth direction is along [abc].

X-ray photoelectron spectroscopy (XPS) was performed to investigate the surface chemistry of Te@CF. FIG. 2H displays the high-resolution Cu 2p spectrum. The peaks at 931.8 and 951.5 eV can be assigned to Cu⁰/Cu⁺2p_{3/2} and Cu⁰/Cu⁺2p_{1/2}, while the peaks at 932.5 and 952.2 eV are ascribed to Cu²⁺2p_{3/2} and Cu²⁺2p_{1/2}. Per FIG. 2I, there is one pair of peaks in the high-resolution Te 3d spectrum, which corresponds to the Te²⁻3d_{5/2} at 572.4 eV and Te²⁻3d_{3/2} at 582.8 eV, respectively. The structure and surface chemistry of S@CF were also examined using XRD and XPS. As shown in FIG. 2G, there are a few new peaks that appeared after the sulfurization process of CF, all of which can be assigned to the monoclinic Cu₂S phase with the P21/c space group (JCPDS #33-0490). FIG. 14 further confirms the formation of Cu₂S on its surface.

To evaluate the electrochemical performance of the CF, Te@CF, and S@CF substrates as Na metal hosts, galvanostatic tests were carried out using coin cells. For asymmetric cells, baseline and modified copper foams were employed as the working electrodes, pure Na metal foil was served as the reference and counter electrode, the separator was made of the polymeric membrane, and the electrolyte contained 1 M NaPF₆ in G2 without any other additives.

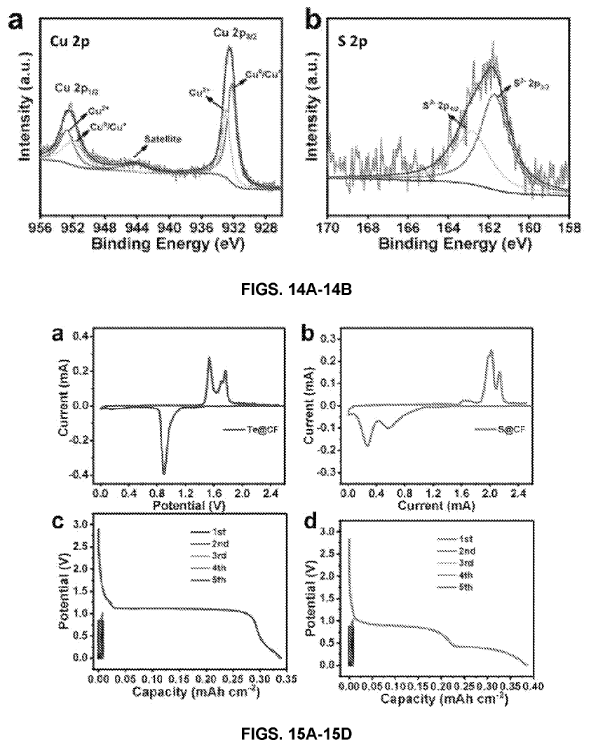

To standardize the test, all cells were pre-cycled between 0-1 V for 5 cycles to eliminate the contaminates and activate the electrodes. FIG. 15A provides the cyclic voltammetry (CV) analysis of Te@CF at cycle 1, tested at a scan rate of 0.1 mV s⁻¹ in the potential window of 0-2.5 V. During the first cathodic process, a strong reduction peak centered at 0.9 V is present followed by a weak one at 0.15 V, which corresponds to the conversion of Cu₂₋ₓTe to Cu and Na₂Te, and the formation of solid electrolyte interphase (SEI). During the anodic scan, no oxidation peaks can be observed until the voltage reaches 1.45 V, indicating the anodic stability of the reduction products under the potential window between 0 and 1 V. Similar conclusion can be drawn for the S@CF electrode as no anodic peak is distinguishable until 1.55 V. FIGS. 15C and 15D show the galvanostatic profiles of Te@CF and S@CF during activation cycles, both of which exhibit two plateaus during the first discharge process, in agreement with their respective CV analysis. In addition, none of them shows discernible plateaus or capacities afterward, which confirms the reaction between the Te@CF and S@CF with Na is irreversible, and the reduction products are stable within a cut-off voltage of 1 V. It is worth mentioning that reversible redox reactions may occur if the cut-off voltage exceeds the anodic stability. This can lead to repeated alloying/conversion reactions upon cycling, and accompanied volume shrinkage/expansion could result in the falling-off of the active layers from the current collector. Therefore, the high anodic stability of the sodiophilic species can prevent the damage caused by the volume change during reversible sodiation/desodiation reactions.

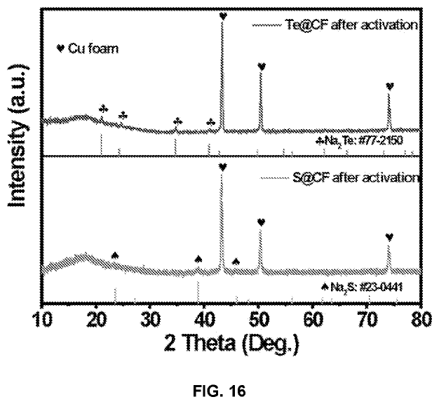

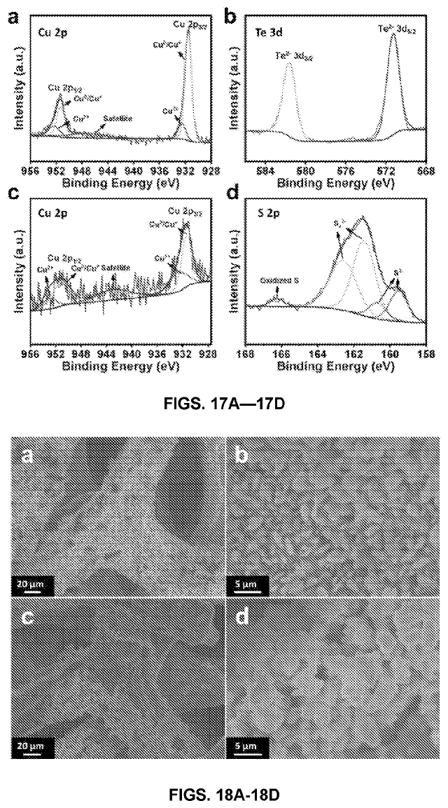

The compositional and morphological changes of Te@CF and S@CF after the initial activation process were further investigated using XRD, XPS, and SEM. As shown in FIG. 16, characteristic peaks of Cu₂₋ₓTe of the Te@CF specimen totally vanished after activation. Instead, the diffraction peaks at 21.1°, 24.6°, 34.9°, and 41.1° can be assigned to Na₂Te (JCPDS #77-2150). Similarly, Na₂S (JCPDS #23-0441) was detected as the product after the activation of S@CF. FIGS. 17A and 17B provide the high-resolution Cu 2p and Te 3d XPS spectra of the activated Te@CF sample. It may be noteworthy that the ratio of Cu²⁺ to Cu⁰/Cu⁺ decreases compared to that of the pristine sample (FIG. 2H), indicating a major reduction of Cu species. By contrast, Te remains in the reduction state with two peaks at 571.2 eV and 581.6 eV, respectively. FIGS. 17C and 17D display the high-resolution of Cu 2p and S 2p XPS spectra of activated S@CF, from which a similar conclusion can be drawn: The activation process leads to a reduction of Cu species and the formation of sulfides. Therefore, the electrochemical reactions of Te@CF and S@CF during the 1^{st} discharge process can be expressed as follows:

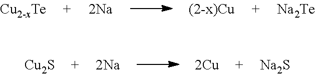

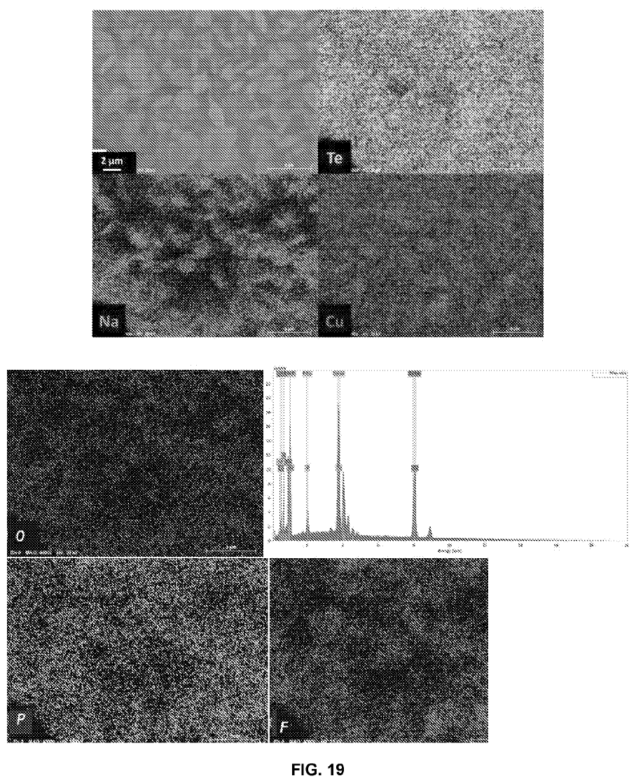

Per FIGS. 18A and 18B, the surficial morphology of Te@CF altered from nanosheets to irregular nanoparticles after activation. The EDXS analysis in FIG. 19 indicates a homogenous distribution of the activated nanoparticles throughout the surface. In the case of S@CF (FIGS. 18C and 18D), the activation process not only leads to the morphological change from nanorods to irregular nanoparticles but also causes the falling-off of partial nanoparticles on the surface as indicated by the exposed Cu skeleton. The good affinity of the sodiophilic layer in Te@CF may be one reason for its outperformance over S@CF.

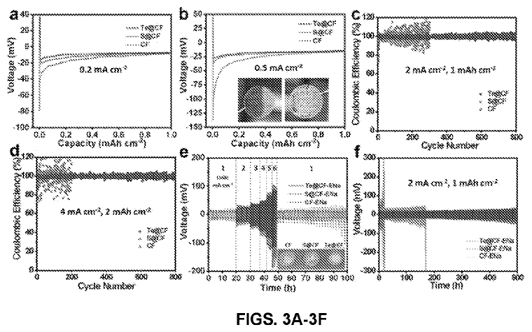

The nucleation overpotential and Coulombic efficiency (CE) tests were both performed in asymmetric cell configurations. As shown in FIG. 3A, benefiting from the formation of sodiophilic layers, the initial nucleation overpotentials were reduced from 79 mV on bare CF to 18 mV on Te@CF and 23 mV on S@CF at a current density of 0.2 mA cm⁻². The overpotential of Te@CF also remains the lowest, with a value of 28 mV when the current increases to 0.5 mA cm⁻², in contrast to 140 mV of CF and 37 mV of S@CF. In order to visualize the preference of Na deposition on the substrate with and without sodiophilic coatings, a customized electrode was fabricated with half of the area treated by Te and the other half remaining untreated. As shown in FIG. 3B insets, after plating 1 mAh cm⁻² Na at 0.5 mA cm⁻², the Te treated side was uniformly covered by Na deposition while almost no Na was plated on the untreated side, providing a direct correlation between the sodiophilicity and Na wettability and its associated deposition preference. FIGS. 3B and 3D compare the CEs of Te@CF, S@CF, and CF at 2 mA cm⁻² to 1 mAh cm⁻² and 4 mA cm⁻² to 2 mAh cm⁻². In both scenarios, baseline CF shows unstable cycling with fluctuated CE right from the onset, while S@CF displays relatively stable CE in the first 100 cycles and then starts to be unstable. In comparison, Te@CF achieves stable cycling over 800 cycles with cumulative plating/stripping capacities of 800 mAh cm⁻² at 2 mA cm⁻² and 1600 mAh cm⁻² at 4 mA cm⁻². FIG. 52 shows exemplary SEM images obtained on a symmetric-Tl—Te@CF cell after 100 cycles in some other aspects.

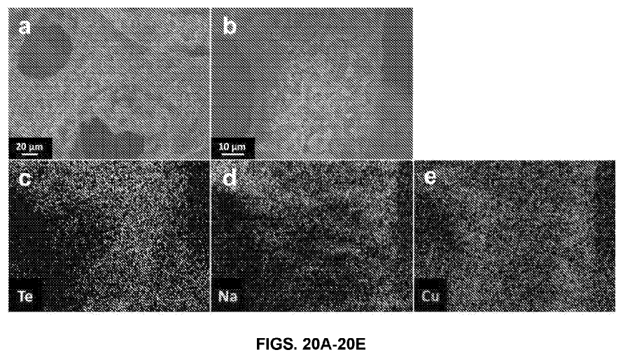

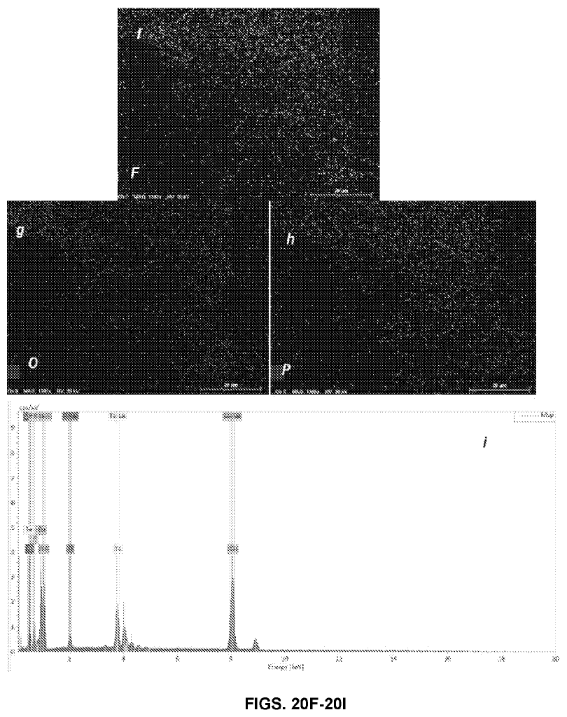

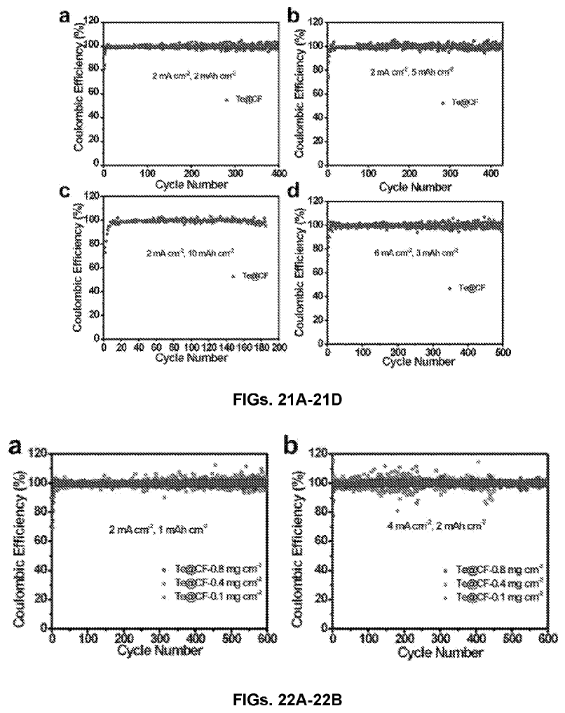

FIG. 20 provides SEM and associated EDXS analysis of the Te@CF electrode, collected after 50 cycles at 2 mA cm⁻² to 1 mA cm⁻². It may be concluded that the surface is homogeneously covered by the sodiophilic nanoparticles, which remain closely packed and free from pulverization FIG. 21 shows additional cycling data collected at 2 mA cm⁻² to 2, 5 and 10 mAh cm⁻², and at 6 mA cm⁻² to 3 mAh cm⁻². Here again, Te@CF exhibits excellent performance with stable CEs. FIG. 22 provides the cycling tests of Te@CF with different Te loadings, collected at 2 mA cm⁻² to 1 mAh cm⁻² and 4 mA cm⁻² to 2 mAh cm⁻². The symmetric cells based on electrodes with a higher mass loading of Te exhibit a more stable cycling performance, although all the specimens are superior to the baseline CF. The relatively higher Te loading leads to relatively more sodiophilic sites that are available for Na plating. This should reduce the effective current density and the associated overpotentials. Table 1 compares the plating capacity and accumulated capacity of Te@CF with state-of-the-art Na metal hosts in previous literature. It may be observed that the performance of Te@CF is among the most favorable.

TABLE 1
Performance comparison of reported asymmetrical
cells in the literature and this work.

| | | Current | Plating | | |
|---|---|---|---|---|---|
| | | density | capacity | Cycle life | |
| Methods | Electrolyte | (mA cm⁻²) | (mAh cm⁻²) | (h) | Ref. |
| Te treated | 1M NaPF₆ | 2 | 1 | 800 | This work |
| copper | in G2 | 2 | 5 | 430 | |
| foam | | 2 | 10 | 180 | |
| | | 6 | 3 | 500 | |
| Ni | 1M NaPF₆ | 6 | 1 | 100 | ¹ |
| nanoparticles | in G2 | | | | |
| modified 3D | | | | | |
| carbon | | | | | |
| skeleton | | | | | |
| CF@ZnO | 1M NaOTF | 3 | 1 | 150 | ² |
| | in G2 | | | | |
| Silver- | 1M NaPF₆ | 2 | 4 | 100 | ³ |
| modified | in G2 | | | | |
| carbon | | | | | |
| nanofiber | | | | | |
| Porous rGO | 1M NaPF₆ | 1 | 1 | 800 | ⁴ |
| film | in G2 | | | | |
| Co-MOF- | 1M NaOTF | 1 | 1 | 400 | ⁵ |
| derived | in DME | | | | |
| carbon | | | | | |
| Au sputtered | 1M NaOTF | 2 | 1 | 150 | ⁶ |
| on carbon | in G2 | | | | |
| fibers | | | | | |
| Porous | 1M NaOTF | 1 | 1 | 600 | ⁷ |
| carbon | in G2 | | | | |
| nanofibers | | | | | |
| N-doped | 1M NaPF₆ | 0.5 | 1 | 800 | ⁸ |
| graphene on | in G2 | | | | |
| nickel foam | | | | | |
| Doped- | 1M NaPF₆ | 1 | 1 | 600 | ⁹ |
| hollow | in G2 | | | | |
| carbon fibers | | | | | |
| 3D-printed | 1M NaPF₆ | 1 | 1 | 500 | ¹⁰ |
| graphene | in G2 | | | | |
| lattice | | | | | |
| Sn | 1M NaPF₆ | 2 | 1 | 500 | ¹¹ |
| nanoparticles | in G2 | | | | |
| embedded | | | | | |
| carbon | | | | | |
| network | | | | | |
| Au sputtered | 1M NaOTF | 2 | 1 | 300 | ¹² |
| on copper | in DME | | | | |

To further confirm the role of the sodiophilic layers, Te@CF, S@CF, and baseline CF hosts were electrochemically pre-deposited with 5 mAh cm⁻² Na and denoted as Te@CF-ENa, S@CF-ENa, and CF-ENa. The inset of FIG. 3E shows the photographs of these three electrodes, and a more uniform deposition is achieved in Te@CF-ENa. It may be observed how inhomogeneous the plating of Na metal on a standard CF collector is. The metal is concentrated in the center of the collector, with macroscopic holes in the film through which the bare Cu is discernable. Apart from the main bulk of the Na film localized towards the middle portion of the collector, there are also isolated spots of nucleated Na on the edges. It may be concluded that Na plating is macroscopically nonuniform from the onset, which explains the early voltage runaway failure observed during the cycling of the baseline. Symmetric cells consisting of two identical electrodes were assembled to evaluate the electrochemical performances in terms of rate capability and cycling stability. As shown in FIG. 3E, the CF-ENa cell displays much larger overpotentials under each current, and the difference between S@CF-ENa and Te@CF-ENa occurs when the current rises to 4 mA cm⁻² and above, indicating the Na plating/stripping is more kinetically favorable in Te@CF-ENa. The cycling performance (FIG. 3F) shows a similar trend that the Te@CF-ENa symmetric cell has the lowest overpotential during repeated Na plating/stripping. In addition, CF-ENa and S@CF-ENa symmetric cells fail much faster, with fluctuations occurring by cycles 21 and 167, respectively. By contrast, Te@CF—Na symmetric cells remain stable up to 500 cycles.

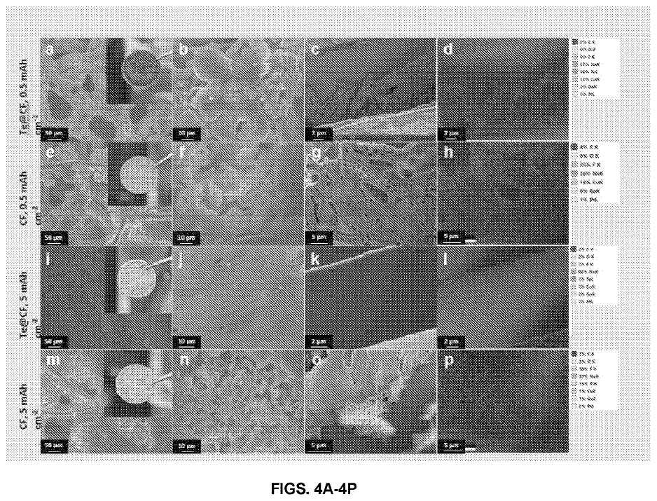

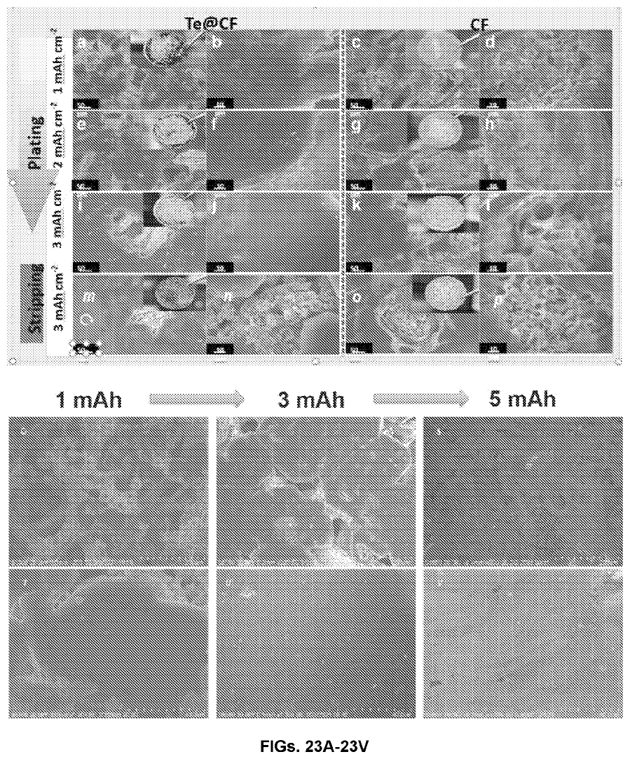

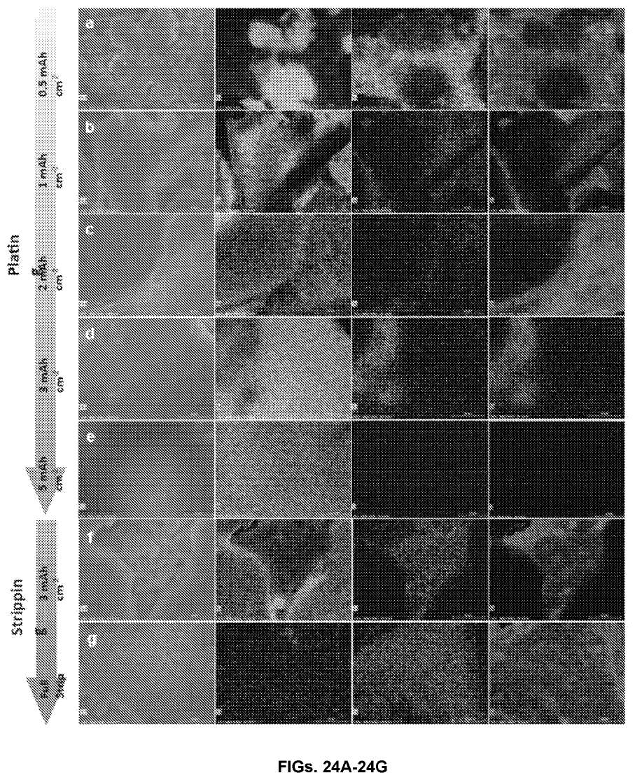

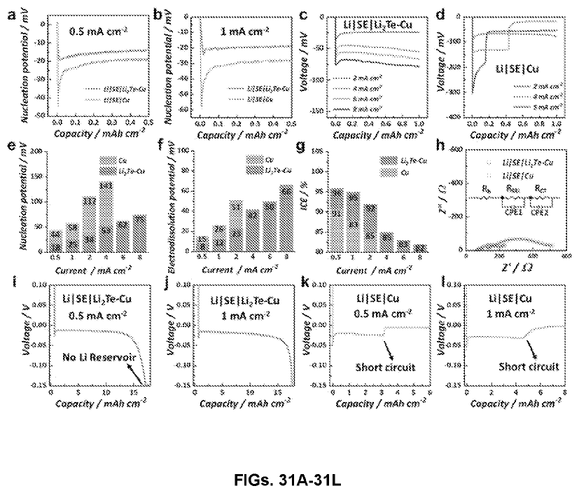

To elucidate the different Na electrodeposition behaviors of Te@CF and baseline CF, the electrodes after Na plating were characterized by electron microscope and optical photographs. FIG. 4 presents SEM, cryogenic focus ion beam (cryo-FIB) cross-sectional SEM, and associated EDXS analysis comparing Te@CF versus baseline CF in the plated condition. Samples were prepared at 1 mA cm⁻² with plated capacities of 0.5 and 5 mAh cm⁻². FIGS. 3A-3D and 31-3L highlight the analysis of Te@CF, while FIGS. 3E-3H and 3M-3P show comparable analysis of CF. There is a marked difference in the structure and morphology of the plated metal for the two specimens, even at a very early stage, i.e., 0.5 mAh cm⁻² (FIGS. 3A-3H). For the case of Te@CF, Na metal directly plates on the top of the sodiophilic layer, being dense and flat with no evidence of dendrites. The deposited metal is free from pores and from embedded SEI. By contrast, dendritic Na starts to develop surrounding the skeleton of the baseline CF right from the onset, being filamentary and covered by SEI. Micrometer-scale pores are present everywhere throughout the plated Na metal, being visible in the FIB cross-sectional SEM. FIG. 23 provides an additional top-down SEM analysis of Te@CF and CF with plated capacities of 1, 2, and 3 mAh cm⁻². FIGS. 31-3P show the SEM and cryo-FIB cross-sectional analysis after plating a capacity of 5 mAh cm⁻² on top of Te@CF and CF. FIG. 24 shows the corresponding EDXS analysis of Te@CF at a different plated status. The observed structures are consistent under these conditions: smooth and dense metal deposition on Te@CF versus a porous dendritic structure for baseline CF,

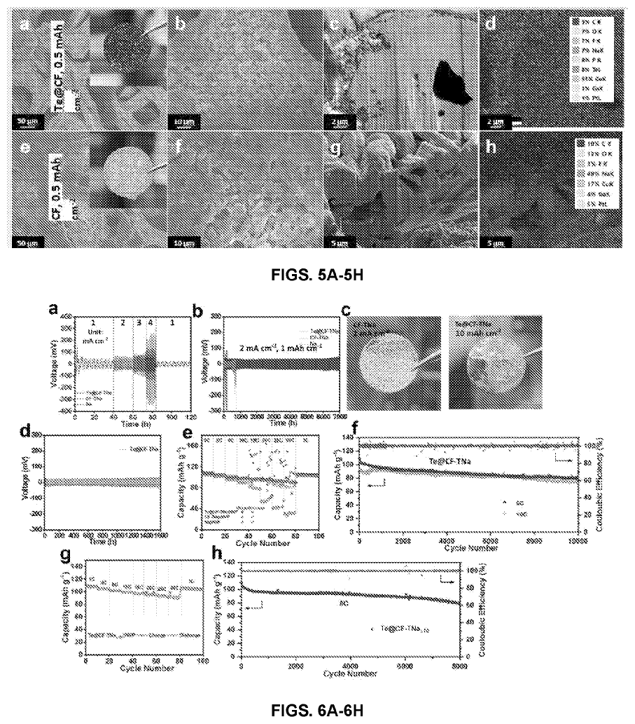

FIG. 5 presents similar sets of analyses of Te@CF versus CF in the fully-stripped condition. Samples were firstly plated with 5 mAh cm⁻² Na at 1 mA cm⁻² and then stripped to a cut-off voltage of 0.5 V under the same current density. FIGS. 4A-4D highlight the analysis of Te@CF, while FIGS. 4E-4H display a comparable analysis of CF. The digital photographs as insets in FIGS. 4A and 4E provide a direct comparison between these two specimens. For the case of baseline CF, widespread shiny Na metal is present on the electrode even after it was stripped to the terminal anodic voltage limit of 0.5 V. This is the “Dead Metal” or “Dead Sodium,” which was not strippable either due to being electrically isolated from the collector or due to being ionically blocked from dissolving. In addition, the discoloration of the CF is likely associated with the remaining SEI layer, which is not removed by the electrode-washing procedure. Both scenarios can be driven by excessive SEI growth. By contrast, sporadically shiny spots can be observed on the Te@CF substrate after attempting to strip all the Na metal from its surface, indicating minimal “dead Na” that is not electrochemically active enough to be removed. The magnified SEM with cryo-FIB cross-sectional analysis gives further illustration as the holes of 3D CF were filled with “dead Na” with a dendritic structure. It is noteworthy that there is a clear gap between the dead metal and the CF skeleton, which is evidence of the breakage of electrical pathways. In addition, the cross-sectional view of SEM shows that the “dead metal” has a tubular structure with hollow channels (FIG. 5G), indicating the stripping process propagates from the core to the shell. However, the outer shell is heavily covered by SEI (FIG. 5G), which makes this process kinetically unfavorable, therefore leaving substantial electrochemically inactive dead metals.

On the contrary, no discernible dead Na can be found on the Te@CF substrate after Na was fully stripped (FIGS. 5A and 5B). Instead, sodiophilic nanoparticles remain intact and closely packed on the CF surface, demonstrating their structural robustness and anti-pulverization (FIGS. 5C and 23). The cross-sectional view further confirms the existence of a thin active layer, being free from dead metal and extensive SEI (FIG. 5D). FIGS. 23 and 24 provide additional analysis of Te@CF and CF with a stripping capacity of 3 mAh cm² i.e., 60% Na removal. The observed structures are consistent: smooth and uniform metal extraction on Te@CF versus a dendritic structure for baseline CF.

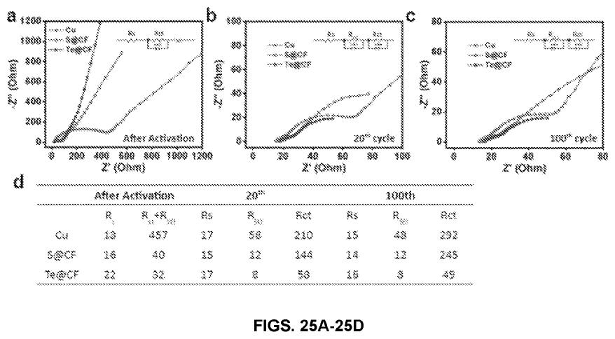

To further understand the improvement made by the sodiophilic layers, the electrochemical impedance spectroscopy (EIS) technique was applied to study the resistive difference at various cycle numbers. FIG. 25 displays the EIS results for the three sets of asymmetric cells in different cycling conditions. The inset in each figure shows the respective model used for fitting the data. It may be observed that both Te@CF and S@CF exhibited lower charge-transfer and SEI combined resistance (R_{ct}+R_{SEI}) than that of baseline CF after activation, being 32 Ω, 40Ω, and 475Ω, respectively, indicating the formation of a sodiophilic layer markedly promotes the conductivity on the copper surface, which efficiently prevents localized charge accumulation that may drive the uneven deposition of sodium metal. The difference in interfacial resistance among the three specimens was further amplified after 20 and 100 cycles, where two resistance R_{SEI} and R_{ct}, can be effectively distinguished. The SEI resistance (R_{SEI}) remained smaller for chalcogen-treated samples, with Te@CF being the lowest (8Ω), which is indicative of a thinner, less resistive SEI layer formed with Te@CF. In addition, the Te@CF asymmetric cell also maintains the lowest R_{ct} (58Ω) after 20 cycles and remains stable (49Ω) upon progressive cycling. By contrast, the R_{ct} increases from 210Ω to 292Ω for baseline CF and from 144Ω to 245Ω for S@CF, as “dead lithium” starts to accumulate with fluctuated CEs after a few cycles per FIG. 3C. The summary of impedance data is listed in FIG. 25C.

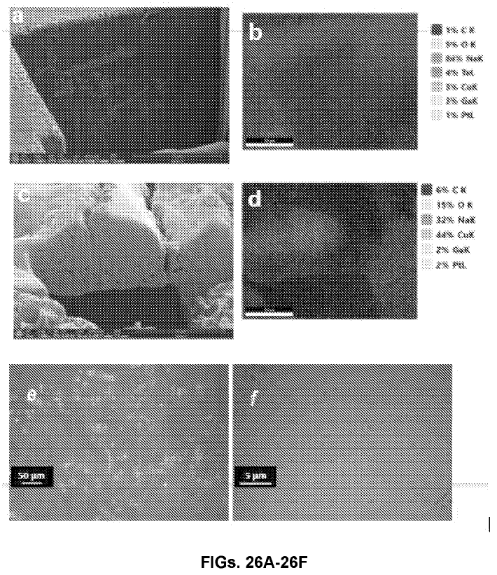

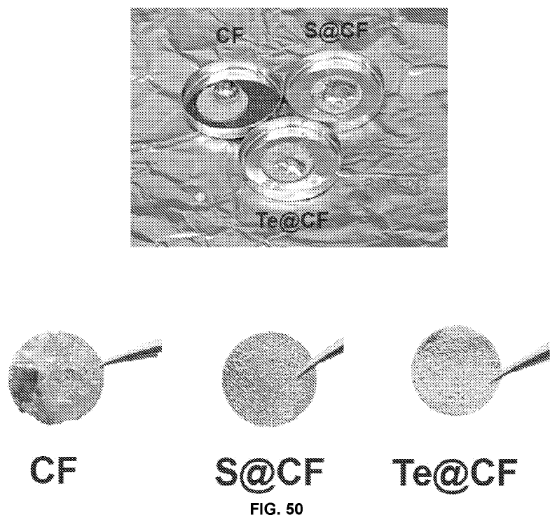

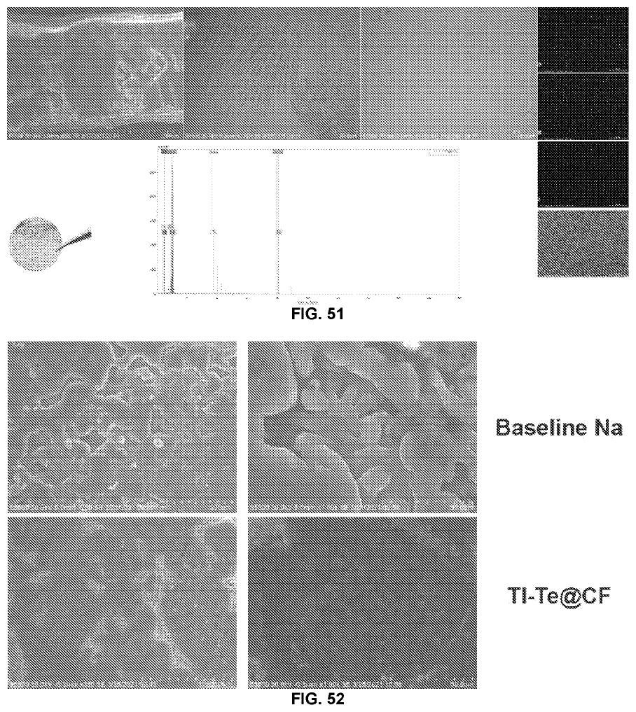

For practical applications, however, the electrochemical deposition of Na is not favored since it is time-consuming and requires a relatively more complicated process. Thermal infusion of Na, in turn, provides a more feasible and rapid way to fabricate Na metal anodes (FIG. 50). For demonstration, Te@CF and CF were immersed in molten Na, and the resulted composite electrodes are denoted as Te@CF-TNa and CF-TNa, respectively. SEM and EDX images obtained in one aspect are shown in FIG. 51 and FIGS. 55A-551. FIGS. 26A-26D provide cryo-FIB cross-sectional SEM and associated EDXS analysis in a different aspect. The thermally infused Na on baseline CF is macroscopically inhomogeneous, with porous Na being mainly located in the permeable micron-sized holes encircled by the copper skeleton. A gap between Na and the edge of CF can be clearly seen, further indicating the strong sodiophobicity of the baseline CF. By contrast, Na can be uniformly impregnated onto the sodiophilic Te@CF, being dense and free from porosity. FIGS. 26E and 26F show the surface of Te@CF-TNa, which is smooth and homogeneously covered by Na metal.

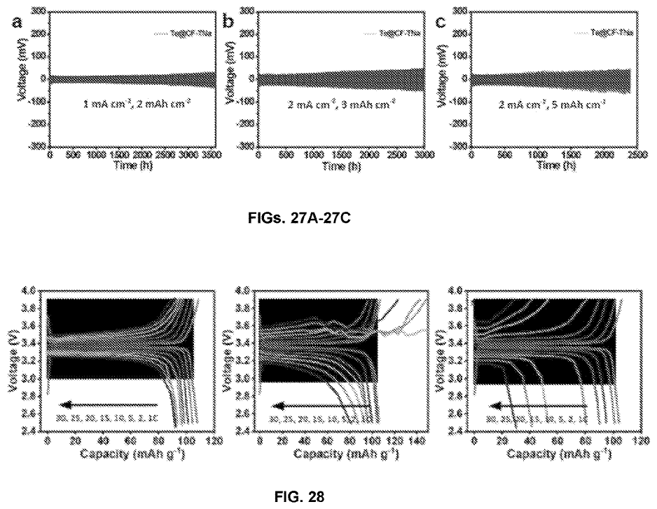

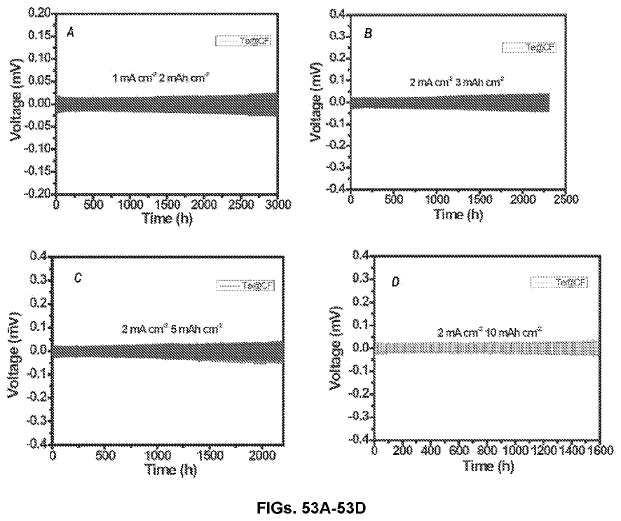

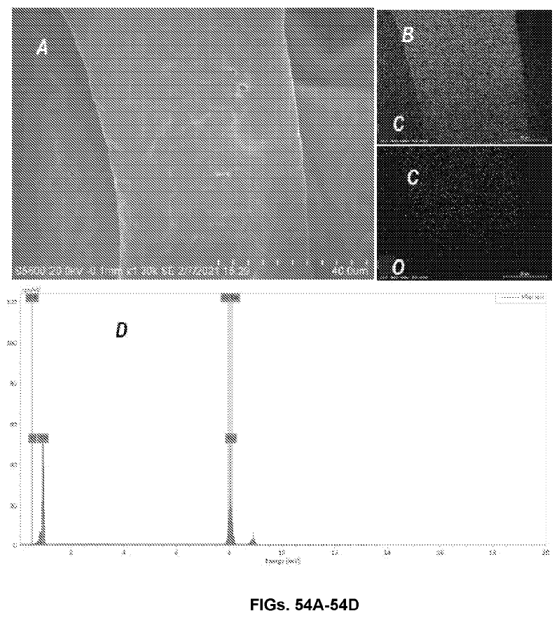

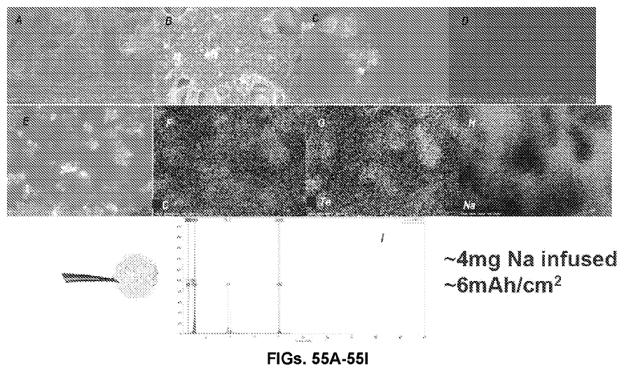

FIGS. 6A-6C and FIG. 27 display the electrochemical performance of Te@CF-TNa, baseline CF-TNa and baseline Na in symmetric configurations. FIGS. 53A-53D show the electrochemical performance of Tel-Te@CFin in a different aspect. FIG. 6A provides the rate capability of these three specimens, tested under various current densities to reach a targeted capacity of 2 mAh cm⁻². It may be observed that the Te@CF-TNa electrode exhibits markedly lower voltage polarization at each current density, and the difference versus the baseline increases with current. FIG. 6B shows the voltage versus time profiles, tested at 2 mA cm⁻² to 1 mAh cm⁻². The baseline CF-TNa∥CF-TNa and Na∥Na cells display early onsets of unstable voltages, with marked fluctuations incurring by cycles 138 and 658, respectively. By contrast, the Te@CF-TNa∥Te@CF-TNa cells remain stable even after 6000 hours with a cumulative capacity of 6000 mAh cm⁻², which is among the most favorable per Table 2. FIG. 6C and FIG. 27 show addition cycling data of Te@CF-TNa, collected at 2 mA cm⁻² to 10 mAh cm⁻², 1 mA cm⁻² to 2 mAh cm⁻², 2 mA cm⁻² to 3 mAh cm⁻² and 2 mA cm⁻² to 5 mAh cm⁻². Here again, Te@CF-TNa cells display excellent stability at each testing condition.

To further evaluate the feasibility of Te@CF-TNa anodes in SMBs, full cells were assembled based on Na₃V₂(PO₄)₃ (NVP) cathodes combined with Te@CF-TNa or CF-TNa or Na. FIG. 6D shows the rate capability of Te@CF-TNa∥NVP, CF-TNa∥NVP and Na∥NVP cells. Stepwise increasing the current densities from 1 C, 2 C, 5 C, 10 C, 15C, 20 C, and 25 C to 30 C, the Te@CF-TNa∥NVP cell delivers reversible capacities of 108, 104, 101, 99, 97, 95, 93 and 91 mAh g⁻¹, respectively. When the current is switched from 30 C back to 1 C, the reversible capacity is restored to the original level. By contrast, the baseline CF-TNa∥NVP and Na∥NVP exhibit lower capacities under every current and overcharge when the current exceeds 15 C. The charge process in the full cell corresponds to the Na plating on the substrates, and therefore the severe overcharge in CF-TNa∥NVP cell can be ascribed to the unfavorable Na deposition on the sodiophobic surface of CF— Na. FIG. 28 provides the galvanostatic charge/discharge profiles under each current density. It can be concluded that the Te@CF-TNa∥NVP cell delivers a much smaller polarization voltage, especially under high current densities, implying that the sodiophilic layer can effectively enhance the diffusion kinetics and enable fast charging/discharging of SMBs. FIG. 6E displays the long cycling performance of Te@CF-TNa∥NVP cells. Impressively, reversible capacities of 80 and 75 mAh g⁻¹ can be obtained after 10000 cycles at high currents of 5 C and 10 C, respectively. Such excellent performance is among the most favorable per Table 3.

TABLE 2
Performance comparison of reported symmetrical
cells in the literature and this work.

| | | Current | Plating | | |
|---|---|---|---|---|---|
| | | density | capacity | Cycle life | |
| Methods | Electrolyte | (mA cm⁻²) | (mAh cm⁻²) | (h) | Ref. |
| Te treated | 1M NaPF₆ | 1 | 2 | 3500 | This work |
| copper foam | in G2 | 2 | 1 | 7000 | |
| with thermal | | 2 | 3 | 3000 | |
| infused Na | | 2 | 10 | 1600 | |
| NiSb-coated | 1M NaClO₄ in | 1 | 1 | 2000 | ¹³ |
| carbon cloth | EC/DEC/FEC | 1 | 10 | 1000 | |
| with thermally | | | | | |
| infused Na | | | | | |
| Carbon cloth | 1M NaPF₆ | 1 | 1 | 1000 | ¹⁴ |
| with thermally | in FEC/DMC | 3 | 1.5 | 600 | |
| infused Na | | | | | |
| Na—Sn | 1M NaOTF | 1 | 1 | 700 | ¹⁵ |
| alloy/Na₂O | in G2 | 2 | 1 | 500 | |
| framework | | | | | |
| Nanocrevasse- | 1M NaOTF | 1 | 1 | 200 | ¹⁶ |
| rich carbon | in DME | 3 | 1 | 80 | |
| fibers with | | | | | |
| thermally | | | | | |
| infused Na | | | | | |
| rGO with | 1M NaPF₆ | 1 | 1 | 600 | ¹⁷ |
| thermally | in G2 | | | | |
| infused Na | | | | | |
| Na—Na₂S- | 1M NaClO₄ in | 1 | 0.5 | 300 | ¹⁸ |
| carbon hybrid | EC/DEC/FEC | | | | |
| Lignin- | 1M NaPF₆ | 0.5 | 0.5 | 800 | ¹⁹ |
| derived | in PC/FEC | 1 | 1 | ~350 | |
| carbon nanofiber | | | | | |
| with thermally | | | | | |
| infused Na | | | | | |
| Cu₂O | 1M NaClO₄ in | 1 | 1 | 500 | ²⁰ |
| nanowires on | EC/DMC/FEC | | | | |
| copper foam | | | | | |
| with thermally | | | | | |
| infused Na | | | | | |
| N- | 1M NaOTF | 1 | 1 | 1700 | ²¹ |
| functionalized | in G2 | 2 | 2 | 800 | |
| hard carbon | | | | | |
| with thermally | | | | | |
| infused Na | | | | | |
| N,S-doped | 1M NaOTF | 1 | 1 | 500 | ²² |
| carbon | in G2 | | | | |
| nanotube on | | | | | |
| Na surface | | | | | |
| Na/Bi anode | 1M NaOTF | 0.5 | 1 | 1000 | ²³ |
| | in G2 | 2 | 1 | 90 | |

TABLE 3
Performance comparison of reported NVP cells with
modified Na anodes in the literature and this work.

| | | Rate Capability | | | | | |
|---|---|---|---|---|---|---|---|
| | | (mAh g⁻¹) | | Cycling Performance | | | |
| | | Current | Capacity | Current | Capacity | Cycle | |
| Anode Materials | Electrolyte | (C) | (mAh g⁻¹) | (C) | (mAh⁻¹) | Number | Ref. |
| Te treated | 1M NaPF₆ | 30 | 91 | 5 | 80 | 10000 | This |
| copper foam | in G2 | | | 10 | 5 | 10000 | work |
| with thermal | | | | | | | |
| infused Na | | | | | | | |
| N-doped | 1M NaPF₆ | 20 | 75 | 2 | 3 | 250 | ⁸ |
| graphene on Ni | in G2 | | | | | | |
| foam@deposited | | | | | | | |
| Na | | | | | | | |
| (Ti₃C₂Tₓ)-coated | 1M NaClO₄ | ~8.5 C | ~80 | ~4.2 | 88 | 300 | ²⁴ |
| carbon | in EC/DMC/EMC/ | | | | | | |
| cloth@infused | FEC | | | | | | |
| Na | | | | | | | |
| Activated SnS- | 1M NaClO₄ | N/A | N/A | 0.4 | 4 | 400 | ²⁵ |
| graphene | in EC/DEC/FEC | | | | | | |
| membrane@Na | | | | | | | |
| 3D Ni foam@Na | 1M NaPF₆ | 2 | 76 | 1 | 5 | 200 | ²⁶ |
| | in TEGDME | | | | | | |
| Cu₂O—NWs | 1M NaClO₄ | N/A | N/A | 1 | 9 | 400 | ²⁰ |
| modified Cu | in EC/DMC/FEC | | | | | | |
| foam@infused | | | | | | | |
| Na | | | | | | | |
| Porous carbon | 1M NaOTf | N/A | N/A | 1 | 5 | 900 | ⁷ |
| nanofibers@deposited | in G2 | | | | | | |
| Na | | | | | | | |
| 3D porous | 1M NaPF₆ | N/A | N/A | 1 | 2 | 100 | ²⁷ |
| Cu@deposited | in G2 | | | | | | |
| Na | | | | | | | |
| Na—Na₂S-carbon | 1M NaClO₄ | 20 | 33 | 1 | 54 | 500 | ¹⁸ |
| hybrid | in EC/DEC/FEC | | | | | | |
| 3D printed | 1M NaPF₆ | N/A | N/A | ~0.85 | 8 | 100 | ²⁸ |
| rGO/CNT@deposited | in G2 | | | | | | |
| Na | | | | | | | |
| Porous | 1M NaPF₆ | N/A | N/A | ~3 | 5 | 350 | ⁴ |
| rGO@deposited | in G2 | | | | | | |
| Na | | | | | | | |
| SnCl₂ additive | 1M NaClO₄ | 10 | 101 | 1 | 100 | 250 | ²⁹ |
| | in EC/PC | | | | | | |
| N-doped hollow | 1M NaClO₄ | 5 | 102 | N/A | 4 | 200 | ⁹ |
| carbon | in EC/PC | | | | | | |
| fibers@deposited | | | | | | | |
| Na | | | | | | | |
| Na | 1M NaPF₆in | 5 | 85 | N/A | N/A | N/A | ³⁰ |
| | G2/Ionic | | | | | | |
| | liquid | | | | | | |
| Na | 1M NaTFSI | 5 | 85 | 1 | 3 | 400 | ³¹ |
| | in TMP/FEC/HFE | | | | | | |

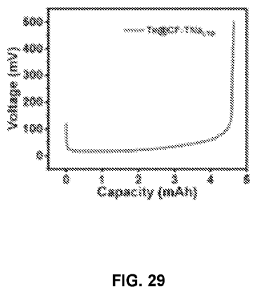

Although thermal infusion provides a possible solution to the practical manufacturing of Na metal anodes, the substantially excessive Na metal may trigger safety concerns and lower the energy density. Therefore, how to control the amount of thermally infused Na is important. To achieve a limited Na infusion, a small piece of Na metal was firstly weighed (~4 mg) and melted on the hot plate. The Te@CF was then placed on the top of the molten Na droplet, and due to the strong sodiophilic surface, molten Na can be easily impregnated into its skeleton, and the obtained composite is denoted as Te@CF-TNaLTD. FIG. 29 shows the voltage versus capacity profile of Na after attempting to strip the Te@CF-TNaLTD to a cut-off voltage of 0.5 V. Approximate 4.6 mAh Na was extracted from the electrode, corresponding to an areal Na loading of 5.8 mAh cm⁻² and a total amount of ~3.9 mg Na, which indicates that almost all initially added Na was impregnated into the Te@CF and remains active during the subsequent stripping process. To demonstrate the electrochemical performance of Te@CF-TNaLTD electrodes, full cells coupled with NVP cathodes were assembled. FIG. 6F displays the rate performance of the Te@CF-TNaLTD∥NVP cell, which delivers almost the same capacities under each current as of the Te@CF-TNa∥NVP cell. In addition, the Te@CF-TNaLTD∥NVP still has a specific capacity of 80 mAh g⁻¹ over 8000 cycles at 5 C with a CE of ~100% (FIG. 6G).

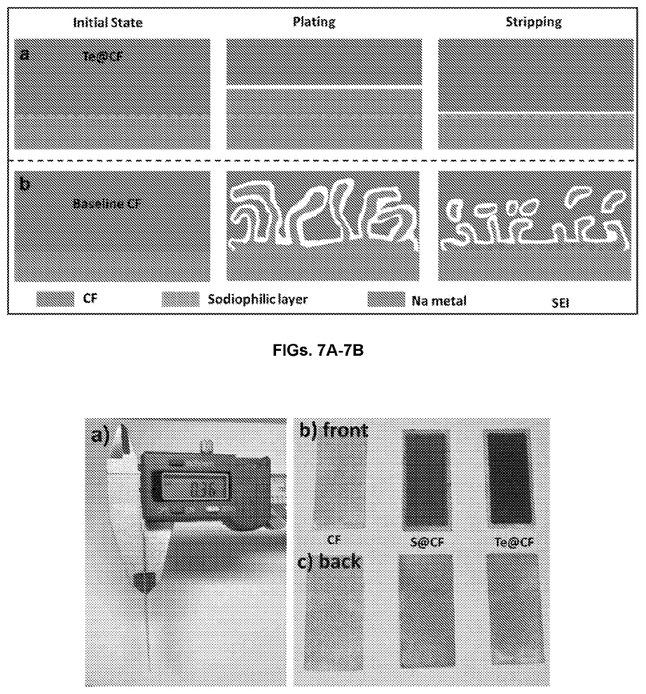

FIG. 7 summarizes the enhancement effect on the plating and stripping behavior of Te@CF, comparing it to the baseline CF. For the case of baseline CF, the plating overpotential is much higher than that for Te@CF, indicating the wetting behavior of Na metal on bare CF substrate is poor. Rather than forming a conformal thin film, a macroscopically heterogeneous island structure with nonuniform SEI covering the metal surface is formed at the onset during initial plating. The deleterious effect of continuous development of uneven metal deposition and thickening of SEI prevails during the subsequent plating process, which eventually leads to the formation of “dead metal” upon cycle one stripping. The poor CE of the half cells and high resistance from EIS analysis indicate the SEI is not stable during cycling, with additional dead metal being formed. By contrast, a sodiophilic layer is in-situ formed after activation, which effectively promotes the wetting behavior of Na on its surface, therefore displaying a lowered overpotential. At the onset of initial plating, planar Na metal film starts to develop on the top of the sodiophilic surface, being dense and pore-free. A thin and uniform SEI formed on the metal surface, which remains stable with low resistance upon progressive cycling. The stripping process reversibly removes pre-deposited Na on the surface and exposes the sodiophilic layer with minimum “dead metal” left, leading to a high CE. The plating/stripping process of Te@CF can be stably repeated for hundreds of hours without failure, in contrast to the rapid CE fluctuation of baseline CF.

### Example 2

This example described an anode-free all-solid-state battery (AF-ASSB), enabled through tuning the wetting of lithium metal on an “empty” current-collector. Fast ion-conducting sulfide-based solid electrolyte (SE) (argyrodite Li₆PS₅Cl LPSCl) is employed without any modifications or secondary interlayers. Lithiophilic 1 μm Li₂Te coating on standard copper foil significantly reduces electrodeposition/electro-dissolution overpotentials and improves Coulombic efficiency (CE). During continuous plating experiments using half-cells (1 mA cm⁻²), the accumulated thickness of electrodeposited Li on Li₂Te—Cu is more than 70 μm, which is the thickness of Li foil counter-electrode. AF-ASSB using NMC811 (external pressure 13 MPa) delivers an initial CE of 82% at 0.1 C, with a steady-state cycling CE of 99.5%. Cryo-stage FIB sectioning demonstrates uniform electrodeposited metal microstructure, with no signs of voids or dendrites at the collector-SE interface. Cryo-FIB also demonstrates that electro-dissolution is uniform and complete, the lithiophilic coating remaining adherent on the collector. Unmodified Cu collector promotes inhomogeneous Li electrodeposition-electro-dissolution, electrochemically inactive “dead metal,” dendrites that extend into the SE, and extensive non-uniform solid electrolyte interphase (SEI) interspersed with pores. DFT demonstrates the thermodynamic stability of lithium atoms on the Li₂Te surface (leading to planar wetting) versus Li clusters that are more stable on Cu (leading to three-dimensional island growth).

Lithium metal-based batteries (LMBs) employ a Li-metal anode coupled with a conventional high-voltage ceramic cathode. The higher capacity of Li vs. graphite (3861 mAh g⁻¹ vs. 372 mAh g-1) combined with a wider voltage window results in an over 50% increase in the specific energy versus conventional ion-insertion anodes. Employing solid-state electrolytes (SEs) is a path toward greater battery safety since most inorganic SEs are non-flammable or have much higher ignition temperatures than organic-based electrolytes. Solid-state batteries (SSBs) can achieve the sought-after high energies when employing cathodes such as LiNi_{0.8}Mn_{0.1}Co_{0.1}O₂ (NMC811) and LiNi_{0.5}Mn_{1.5}O₄. Having the SEs be as thin as practically possible maximizes the energy of the cells by both reducing the total weight and achieving a voltage window closer to the theoretical due to reduced impedance. Likewise, a thin metal anode is sought-after since it reduces the cell weight as well as the risk associated with accidental ignition of the metal. This point will be covered more thoroughly later in the introduction as well as in the results and discussion.

It is known that sulfide SEs display highly promising ionic conductivities and hence the possibility of reaching 400 Wh kg⁻¹ at the cell level. State-of-the-art sulfide SEs receiving interest include thio-LISICON (Li₁₀GeP₂S₁₂), Li₆PS₅X (X═Cl, Br, I), and binary Li₂S—P₂S₅. These sulfide electrolytes typically display a bulk room-temperature Li-ion conductivity of above 10⁻³ S cm⁻¹. However, SSBs using these sulfide SEs still suffer from several major shortcomings. One key issue is the reactivity between the sulfides and both of the electrodes, which leads to ongoing impedance rise associated with the formation of a mixed conducting interphase (MCI). The interface between the metal anode and the SE should be either thermodynamically stable or be passivated to be kinetically stable. Sulfide SEs are not thermodynamically stable at 0 V vs. Li/Li⁺, forming either MCI or a (partially) kinetically stabilized solid electrolyte interphase (SEI). For example, thio-LISICON type electrolyte Li₁₀GeP₂S₁₂ has an excellent conductivity around 10⁻² S cm⁻¹ but displays an unstable MCI due to the reduction of Ge⁴⁺ to Ge²⁺ and Ge⁰ upon contact with Li metal. Binary Li₂S—P₂S₅ also displays such instability.

Argyrodite SEs such as Li₆PS₅Cl (LPSCl) and Li₆PS₅Br (LPSBr) form terminal decomposition products such as Li₃P and Li₂S at the metal anode. However, it is the presence of halide-based decomposition products such as LiCl that kinetically stabilizes the interface. For example, substantially improved SSB performance has been achieved with “sandwich” structures such as LPSCl/LGPS/LPSCl. The lithium halide phases formed at the interface may also be effective in reducing the extent of dendrite growth in such systems. Research efforts with argyrodites have focused on introducing thin film protective interlayers between the metal anode and the SE or constructing hybrid cell architectures. Without such interface modification strategies, both Li plating and stripping processes display a current density (for dendrites and/or voids) that is too low. Sizable voids will form above the current density, indicating that Li electro-dissolution at the Li-SE interface is faster than Li diffusion and creep for replenishment. Researchers have also employed alloy anodes to reduce SE decomposition as well as to suppress dendrite growth. While alloy anodes improve the cell's interfacial stability, the cell voltage is subsequently decreased (e.g., Li—In ~0.6 V vs. Li/Li⁺, Li—Al~0.38 V, Li—Si~0.4 V). The external stack pressure also plays an albeit complex role in determining the currents. The stack pressure for SSBs is closely related to the current density, area capacity, and temperature. When area capacity and temperature are constant, a stack pressure in the 10-15 MPa range is required to prevent voids formation and hence enable battery cycling. For example, Bruce et al. estimated a pressure over 7 MPa is needed for Li cycling at 1 mA cm⁻² or higher.

For most SSB architectures, relatively thick metallurgically-rolled lithium is employed, with the capacity of the metal anode far exceeding the capacity of the cathode. However, limiting the amount of lithium is helpful in achieving SSBs with the targeted energy. For example, anode-free Li batteries can deliver a 30% high specific energy than identical cells with three times excess Li. Existing anode-free studies focus on liquid electrolyte-based batteries, with the concept receiving much less attention for SSBs. Pioneering development of anode-free (AF) SSBs firstly reported in the thin-film solid-state batteries using Li phosphorus oxynitride (LiPON). The electrolyte LiPON is stable with Li and is straightforward to deposit using magnetron sputtering. However, its ionic conductivity (~10⁻⁶ S cm⁻¹) precludes its use as the primary electrolyte for thicker/larger cells. Sakamoto et al. studied the feasibility of garnet solid electrolyte Li₇La₃Zr₂O₁₂ (LLZO) for anode-free SSBs.

Achieving stable cycling behavior in an anode-free all-solid-state battery (AF-ASSB) remains a great challenge due to the ongoing loss of lithium that reacts with the solid-state electrolyte (SE) as well as the formation of voids and dendrites. To date, there have not been reports of anode-free sulfide-based SSB configurations. In this study, it was demonstrated that a difference in the solid-state wetting of lithium on an anode current collector is a key determinant for AF-ASSB stability. As a result, this is the first to report an anode-free all-solid-state battery (AF-ASSB) employing a sulfide-based solid electrolyte. A Li-activated tellurium coating (transformed to 1 μm Li₂Te) on a standard planar copper current collector coupled to argyrodite Li₆PS₅Cl (LPSCl) solid-electrolyte (SE) to enable uniform lithium metal electrodeposition and electro-dissolution was tested. In parallel, it is demonstrated that the baseline uncoated standard Cu collector foil is poorly wetted, with pores and irregular SEI products being present near the metal-collector interface. This leads to tremendous differences in the electrochemical performance and associated microstructure of the AF-SSB cells, allowing for stable cycling with Li₂Te—Cu collector versus rapid electrical shorting with the baseline.

### Preparation of Materials:

Te—Cu substrate: Commercial Cu foil (9 μm thickness, MTI, USA) was first cut into 2 cm×5 cm pieces and cleaned with ethanol under sonication. To prepare Te—Cu 2.5 mg Te powder was added to the bottom of a rectangular crucible with a piece of cleaned Cu foil placed on the top of it. The crucible was then transferred to a tube furnace and heated to 600° C. for 1 h at a ramping rate of 10° C. min⁻¹ under a continuous Ar flow. After cooling down to room temperature, the Te—Cu was obtained and cut into disks with a diameter of 10 mm for electrochemical tests. The mass loading of Cu₂Te is ~0.4 mg cm⁻².

Li₆PS₅Cl (LPSCl) solid-electrolyte: To prepare argyrodite electrolyte Li₆PS₅Cl, a stoichiometric amount of Li₂S (>99.9%, Sigma Aldrich), P₂S₅ (>99.9%, Sigma Aldrich) and LiCl (>99.9%, Sigma Aldrich) were ground together in an air-tight ZrO₂ jar with ZrO₂ balls using high energy ball-milling machine (SPEX SamplePrep, 8000M Mixer/Mill) for two hours. The obtained powder was then sintered at 550° C. for 12 hours in an Ar-filled glovebox. The XRD profile is shown in FIG. 49A. The ionic conductivity at room temperature was measured to be 3.2 mS cm⁻¹ per FIG. 49B.

### Battery Assembly

All-solid-state asymmetric half-cell: 150 mg solid electrolyte powder was first pressed under 75 MPa in a poly(aryl-ether-ether-ketone) (PEEK) mold with a diameter of 12 mm. The surface layer of Li foils was removed with a blade and rolled to a thickness of around 100 μm before use. Then, a piece of Li foil and a Cu or Te—Cu foil were placed on two sides of the electrolyte pellets. The laminated battery was further pressed under 225 MPa to improve the contact between Li and electrolyte before being mounted to the cell holder with a stack pressure of approximately 13 MPa. Anode-free all-solid-state Li cell with LiNi_{0.8}Co_{0.1}Mn_{0.1}O₂ (NMC811) cathode. NMC811 (MSE corporation) was ground together with SE powder at a weight ratio of 8:2 without any carbon being added. When assembling the battery, 150 mg LPSCl powder was first pressed in a PEEK mold under 75 MPa. Then about 5 to 10 mg cathode powder (NCM@SE) was uniformly dispersed on one side of the electrolyte, and a piece of Cu/Te—Cu foil was placed on the other side. 225 MPa pressure was finally applied to the battery to get close contact before electrochemical tests. Finally, the cells were mounted to the cell holder with a stack pressure of 13 MPa.

### Electrochemical Measurements

The impedance tests of the half and full cells were conducted on a Princeton PARSTAT MC electrochemical workstation. A perturbation voltage of 10 mV in the frequency range of 1 MHz to 0.1 Hz was applied. Z-view software was used to analyze the plot coupled with equivalent circuit fitting. The Li ionic conductivities of all the composite electrolytes were calculated based on the equation a=L/RS, where L is the thickness of the pressed pellet, S is the area of the surface, and R is the resistance recorded using a PEEK cell. The galvanostatic charge/discharge profiles were recorded on a Land CT2001A system, and all electrochemical tests were carried out at room temperature in this work.

### Material Characterization

Scanning electron microscopy (SEM) images were collected using a field emission scanning electron microscope (FE-SEM, Hitachi S-5500) equipped with an energy-dispersive X-ray spectrometer (EDX). Cryo-EM analysis was performed on a Thermo Scientific Scios 2 Dual Beam SEM/FIB with a Leica VCT cryogenic stage and EDX detector. To preserve the structural integrity of the beam-sensitive Li-based materials and to reduce artificial inclusion, the sample was cooled to −150° C. The Ga⁺ FIB milling was performed at an accelerating voltage of 30 keV. X-ray diffraction (XRD) profiles were recorded on Rigaku Miniflex 600 diffractometer with Cu Kα radiation (A=1.54178 Å) at a scan rate of 5° per minute within the 20 range from 10° to 80°. X-ray photoelectron spectroscopy (XPS) analysis was performed on a customized XPS system based on a Hemispherical Energy Analyzer PHOIBOS 100 (SPECS Surface Nano Analysis GmbH) with Mg Kα as the excitation source. All post-cycled electrodes were extracted from disassembled cells in an Ar-filled glovebox (<0.1 ppm of H₂O and O₂).

### Results and Discussion

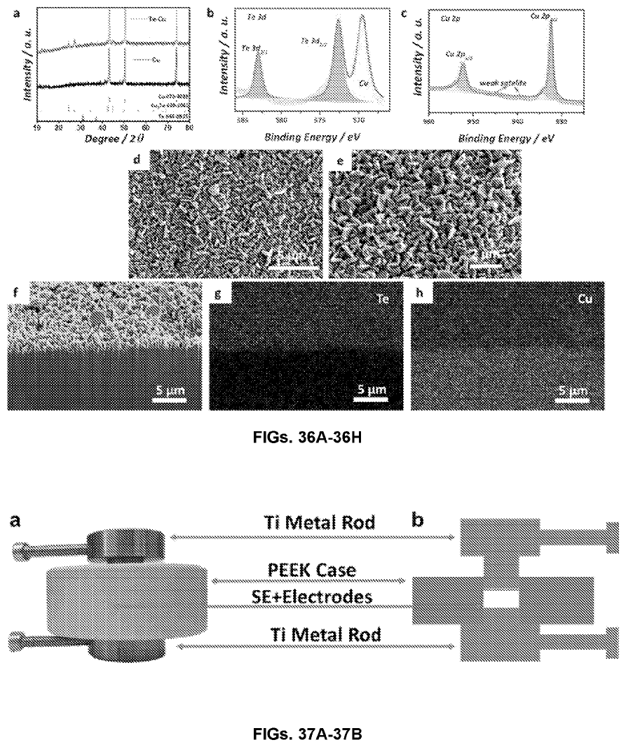

The tellurium-coated copper current collector (Te—Cu) was prepared using a one-step tellurization process. In summary, a section of cleaned battery-grade Cu foil was placed on top of a crucible containing a set amount of Te powder, which was transferred to a programmed furnace and annealed at 600° C. for 1 hour under continuous Ar flow. During this process, the Cu surface reacts with the evaporated Te to form a uniform layer of copper telluride (Cu₂Te) intermetallic crystallites. The calculated mass loading of Cu₂Te is 0.4 mg cm⁻². FIG. 36A shows an X-ray diffraction (XRD) analysis of the as-synthesized coating. Baseline Cu foil belongs to the Fm-3m space group (a=0.3613 nm) and exhibits three characteristic peaks at 43.3°, 50.4° and 74.1°, corresponding to the 111, 200, and 220 reflections. After tellurization, four additional diffraction peaks at 12.1°, 24.4°, 27.2° and 44.8° are present. These are associated with the 001, 100, 101, and 103 reflections of the Cu₂Te structure belonging to the P6/mmm space group (a=0.4237 nm, c=0.7274 nm). X-ray photoelectron spectroscopy (XPS) was performed to investigate the bonding of the layer. FIG. 36B displays the high-resolution XPS spectrum of Te 3d. The Te²⁻3d_{5/2} (572.5 eV) and Te²⁻3d_{3/2} (582.9 eV) can be observed along with Cu LMM Auger. The high-resolution Cu 2p spectrum is shown in FIG. 36C, where peaks at 932.4 and 952.2 eV can be assigned to Cu⁰/Cu⁺2p_{3/2} and Cu⁰/Cu⁺2p_{1/2}, while the peaks at 934.2 and 954.0 eV are ascribed to Cu²⁺2p_{3/2} and Cu²⁺2p_{1/2}. The XRD and XPS results confirm the formation of Cu₂Te on the copper surface after the tellurization process. The surface morphology of the Cu₂Te layer was characterized by scanning electron microscopy (SEM). As shown in FIG. 36D and FIG. 36E, the Cu₂Te crystallites uniformly grow on the Cu surface. FIGS. 36F-36H show the focused ion beam (FIB) cross-sectional SEM image along with the associated energy-dispersive X-ray spectroscopy (EDXS) elemental maps. The thickness of the Cu₂Te layer is about 1 μm, with the images further highlighting the geometrically uniform distribution of the crystallites on the foil surface.

Electrochemical tests were carried out using poly(aryl-ether-ether-ketone) (PEEK) mold cells using a two-electrode configuration shown in FIG. 37. Tellurium-modified or (baseline) unmodified copper current collectors were employed as the working electrodes. Pure Li metal foil served as the reference and counter electrode. An argyrodite-type Li₆PS₅Cl solid-state electrolyte (SE) was used as the separator without any modifications or additional interlayers. To standardize the test, all cells were tested under a pressure of approximately 13 MPa at room temperature. In-situ lithium activation of the Cu₂Te intermetallic was employed to fabricate the final Li₂Te coating layer directly on the collector. The activation process was performed in an asymmetric current collector—SE-Li counter electrode configuration in the PEEK cell. For the remaining of the discussion, this configuration will be referred to as a “half-cell.” This is the configuration representative of anode-free all-solid-state batteries (AF-SSBs). As will be demonstrated, the formation of Li₂Te is irreversible under the tested electrochemical conditions, meaning there is no Li source on the anode current collector.

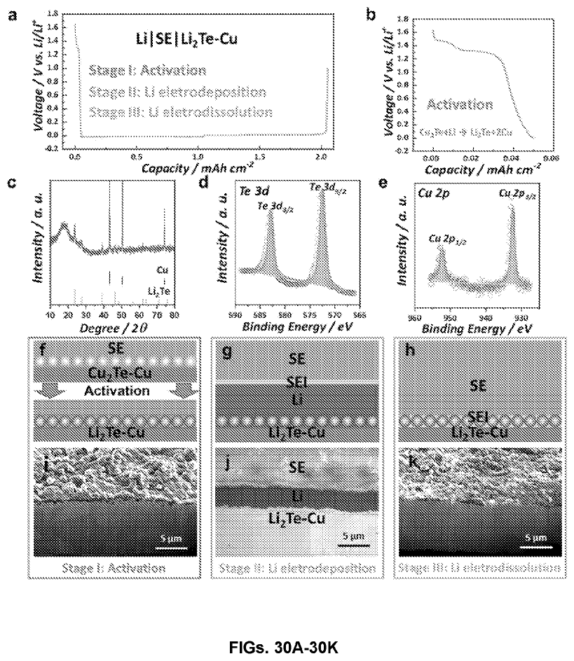

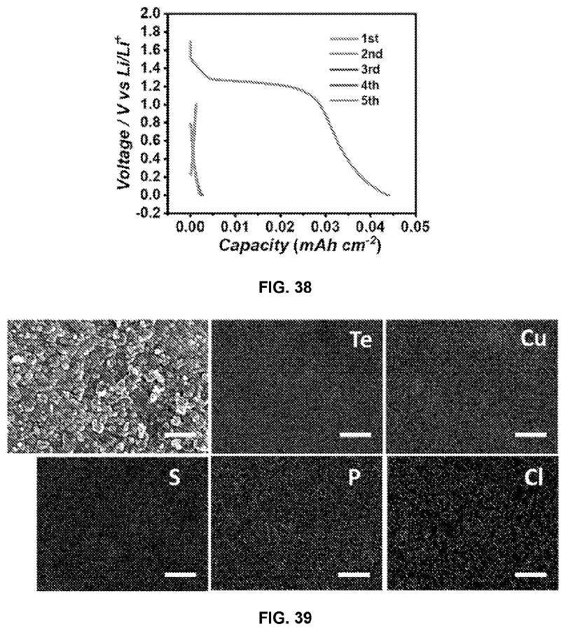

FIG. 30A shows the single galvanostatic discharge/charge (GDC) profile of the Cu₂Te coated foil employed for Li activation, tested at 0.1 mA cm⁻². The activation process entails a conversion reaction where Cu₂Te reacts with Li to form Li₂Te and Cu. The zoomed-in voltage-capacity curve is shown in FIG. 30B. Two plateaus at ~1.4 V and 1.3 V can be observed, corresponding to the stepped lithiation of Cu₂Te. From the two figures, it may be observed that reversing this conversion reaction requires voltages substantially higher than the 1 V anodic limit used for the electrochemical experiments. According to FIG. 30A, once the electrodeposited Li is electro-dissolved, there is negligible additional capacity. This point is examined in more detail in FIG. 38. It may be observed that the Li₂Te coated electrode delivered negligible capacity during the first delithiation process as well as in the sequent cycles, indicating that the conversion reaction is irreversible within an anodic voltage of 1 V. Therefore, the Li₂Te layer does not serve as a source of Li during subsequent testing.

The morphology and chemistry of the coating layer after the activation process was investigated using SEM, XRD, and XPS. As shown in FIG. 39, the electrochemical reaction of Cu₂Te with Li to form Li₂Te leads to morphological changes in the film, although the layer remains approximately 1 μm thick (FIG. 30F). The Te signal is correlated with S, P, and Cl signals, which is caused by the limited decomposition of the argyrodite electrolyte near 0 V and the formation of S, P, and CI-containing solid-electrolyte interphase (SEI). Per FIG. 30C, characteristic peaks of Cu₂Te vanished after activation. Instead, the diffraction peaks appearing at 23.6°, 27.3°, 39.1°, 46.2°, 48.3°, and 62.0° are assigned to Li₂Te (JCPDS #23-0370). FIGS. 30D and 30E provide the high-resolution Te 3d and Cu 2p XPS spectra of the activated sample. The relative intensity of Cu⁰/Cu⁺ vs. Cu²⁺ increases significantly as compared to that of the non-activated Cu₂Te layer (FIG. 36). This indicates that Li activation converts much of the Cu back to its metallic form. The Te remains in its reduced state with two peaks at 527.5 eV and 582.9 eV, respectively. Therefore, activation can be expressed as the following equilibrium reaction:

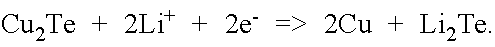

Following in-situ Li activation, the PEEK half-cell is tested in a standard manner as described herein. The process is represented schematically in FIGS. 30F-30H, with corresponding cross-sectional cryo-state FIB-SEM images shown in FIGS. 30I-30K. Per FIGS. 30I-30K, the morphologically stable lithiophilic Li₂Te surface film facilitates Li wetting and uniform Li electrodeposition/dissolution. Without wishing to be bound by any theory, it is assumed that the in-turn has a significant influence on the electrochemical performance of the anode-free cells. In this example, the properties of Li₂Te—Cu were explored through combined experiments and modeling.

Galvanostatic electrodeposition/electro-dissolution and EIS measurements of Li|SE|Li₂Te—Cu and baseline Li|SE|Cu half-cells were performed to unravel the role of the Li₂Te current collector coating on the electrochemical properties of the cells. In all electrochemical tests conducted in this study, an external pressure of 13 MPa was employed. Per FIG. 31A, tested at 0.5 mA cm⁻², the cycle one Li electrodeposition nucleation potential is 18 mV for Li₂Te—Cu and 44 mV for baseline Cu. Per FIG. 31B at 1 mA cm⁻², the cycle one nucleation potential for Li₂Te—Cu is 25 mV versus 58 mV for Cu. FIGS. 31C and 31D show the galvanostatic electrodeposition profiles of these two samples at high current densities, 2 mA cm⁻² and above. With baseline Cu, during electrodeposition at 4 mA cm⁻², there is a sudden voltage drop prior to reaching the targeted 1 mAh cm⁻², indicating a short-circuit. At 5 mA cm⁻², the baseline Cu cell short-circuited at a capacity of only 0.2 mAh cm⁻².

It was found that incomplete wetting of plated Li on the Cu surface can lead to a range of interfacial problems, including current/electrical field focusing in the wetted areas (the electrochemically active interfacial area is lower than the geometrical interfacial area). It was further assumed that it could lead to dendrite growth that ultimately leads to the observed electrical short circuits. By contrast, the Li₂Te—Cu cell displays stable electrodeposition/electro-dissolution profiles. The cells show no sign of short-circuiting even at a very high rate of 8 mA cm⁻², demonstrating a significant enhancement in the current density.

FIGS. 31E and 31F summarize the nucleation (peak) overpotentials and mean electro-dissolution overpotentials for Li₂Te—Cu and baseline Cu, current collectors at different current densities. As compared to Li₂Te—Cu, the baseline Cu makes a less favorable surface for Li electrodeposition, as evidenced by the higher nucleation potentials. With Li₂Te—Cu, the lower nucleation overpotentials at every tested current density are indicative of its lithiophilicity, which is further demonstrated by the DFT below. Without wishing to be bound by any theory, it was assumed that the collector surface chemistry can influence the mean electro-dissolution overpotentials. It was further assumed that the chemistry of the underlying support can influence the morphology of the plated metal and of the SEI. Without wishing to be bound by any theory, it was hypothesized that these factors can, in-turn affect the kinetic ease at which the complete dissolution process occurs at every cycle.

FIG. 31G compares the initial Coulombic efficiency (ICE) of the samples tested at different current densities with a fixed electrodeposition capacity of 1 mAh cm⁻². The Li₂Te—Cu cells displays ICEs of 96%, 95%, 92%, 85%, 83% and 82% at current densities of 0.5, 1, 2, 4, 6 and 8 mA cm⁻². The baseline Cu cell exhibits much lower ICEs of 91%, 88%, and 85% at 0.5, 1, and 2 mA cm⁻², while the cells appear to short-circuit at higher rates. FIG. 31H displays the Nyquist plots of the two specimens after electrodepositing at a capacity of 1 mAh cm⁻² at 0.5 mA cm⁻². Both plots are fitted by an equivalent circuit composed of a bulk resistance Rb and SEI resistance R_{SEI} (higher frequency) in series with a parallel connection of a constant phase element CPE1 and a charge transfer resistance R_{CT} in series with a parallel connection of CPE2. The two semicircles overlap, with the combined R_{SEI} and R_{CT} being 62Ω for Li₂Te—Cu and 360Ω for baseline Cu.

To examine the utility of Li₂Te—Cu supports for high mass loading cathode applications, continuous Li electrodeposition tests were performed. FIG. 31I and FIG. 31L show these results, where Li was continually electrodeposited on the two substrates. At a current density of 0.5 mA cm⁻², 3.1 mAh cm⁻² of Li can be electrodeposited on the baseline Cu foil, with a short circuit occurring afterward. At 1 mA cm⁻² where the voltage abruptly dropped after accumulating 4.5 mAh cm⁻² capacity. For the Li₂Te—Cu cells, stable electrodeposition profiles are maintained for over 15 mAh cm⁻² at both current densities. The point where the voltage starts to increase is ascribed to the exhaustion of the Li on the counter electrode. The accumulated thickness of electrodeposited Li on Li₂Te—C is calculated to be more than 70 μm, which matches the thickness of the Li foil counter-electrode. In contrast, the allowable amount of Li deposited on baseline Cu foil is less than 20 μm.

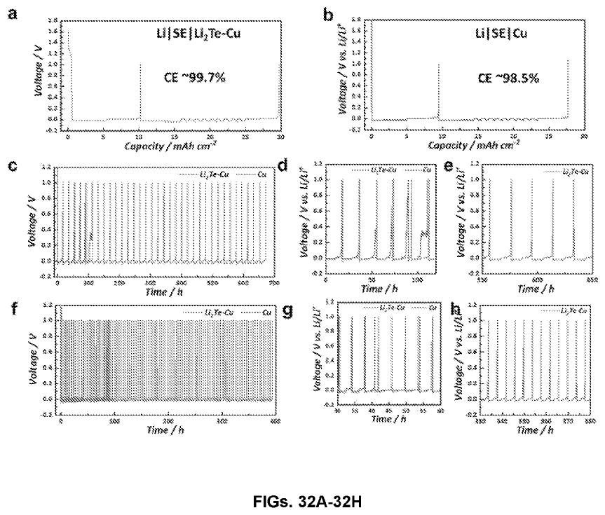

FIGS. 32A-32H display the electrochemical performance results of Li₂Te—Cu and identically tested baseline Cu half-cells. FIGS. 32A and 32B compare the Coulombic efficiencies (CEs) during the initial Li electrodeposition/electro-dissolution process. The tests were carried out according to the standard protocol reported previously for evaluating the efficiency of Li cycling. An initial formation cycle was performed at 0.5 mA cm⁻² to a capacity of 5 mAh cm⁻², followed by electro-dissolution at the same current to an anodic limit of 1 V vs. Li/Li⁺. This was followed by electrodepositing 5 mAh cm⁻² Li reservoir at 0.5 mA cm⁻², followed by 10 cycles of electrodeposition/electro-dissolution (from that reservoir) of 1 mAh cm⁻² at 1 mA cm⁻². The last step in the test was the electro-dissolution of the entire reservoir at 1 mA cm⁻² to the 1 V anodic limit. The final measured CE for the entire process with Li₂Te—Cu and with baseline Cu was 99.70% and 98.47%, respectively. The difference in the CEs between the two specimens can be explained in terms of a combination of SEI growth from the reaction of the SE with the Li metal and the formation of electrochemically inactive dead-metal on the collector surface. Both factors were more extreme for the baseline Cu, as will be demonstrated by microstructural analysis.

The cycling performance of Li₂Te—Cu and baseline Cu half-cells is shown in FIGS. 32C-32H. The figures display tests at 0.1 mA cm⁻² to 1 mAh cm⁻² and 0.5 mA cm⁻² to 1 mAh cm⁻², respectively. In each row, the smaller second and third panels are the enlarged profiles of selected regions in the first larger panel. With these asymmetric configurations, there is no “extra” Li reservoir employed. Since the CE is never 100%, an anodic voltage of 1 V is employed, after which point the current is reversed. Significant differences in the voltage-time profiles are evident at both current densities. For baseline Cu tested at 0.1 mA cm⁻² to 1 mAh cm⁻², the profile begins to substantially deteriorate from the 3^{rd} cycle onward. This is illustrated in FIG. 32D. By contrast, the Li₂Te—Cu cell exhibits stable electrodeposition and electro-dissolution for up to 650 hours, corresponding to 200 cycles. These results are shown in FIG. 32E. According to FIGS. 32F-32H, the baseline Cu tested at 0.5 mA cm⁻² became unstable starting from the 12^{th} cycle (43 hours). The Li₂Te—Cu, however, can stably cycle more than 380 hours at this current. FIG. 40 shows the SEM top-down images illustrating the surface morphology of Li₂Te—Cu and of the SE after cycling 100 times to 1 mAh cm⁻² at 0.5 mA cm⁻² (after the last electro-dissolution cycle, the cell was physically separated for imaging). The Li₂Te—Cu collector surface retains its roughened morphology, while the SE surface remains relatively smooth and uniform.

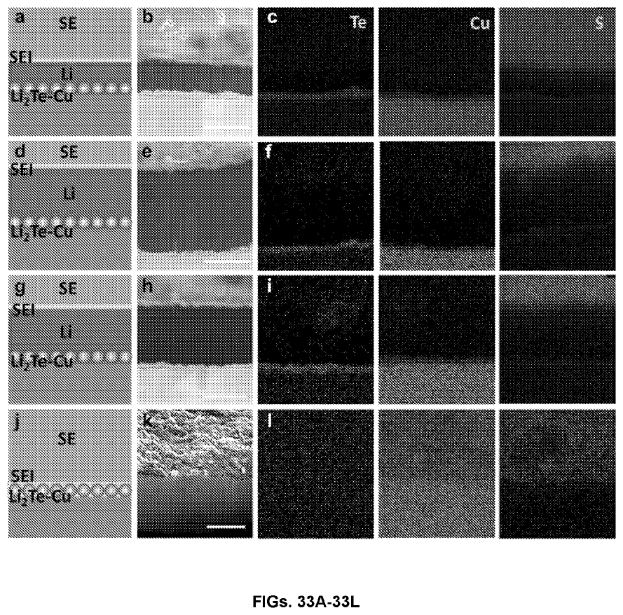

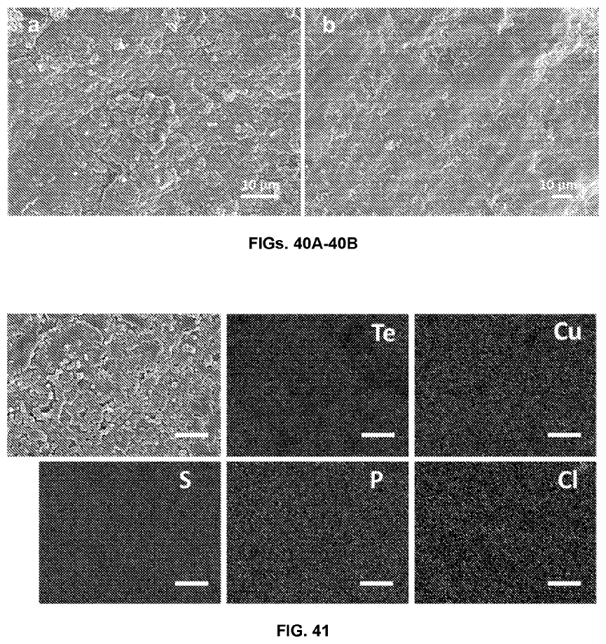

FIG. 33 presents the cross-section cryo-FIB SEM and EDXS-based microstructural analysis of post-electrodeposited and post-electro-stripped Li₂Te—Cu cells as well as the associated schematics to aid in visualizing the results. All the testing was performed at 0.5 mA cm⁻². FIGS. 33A-33C display the cell microstructure after electrodeposition of 1 mAh cm⁻², while FIGS. 33D-33C display the microstructures after electrodeposition 3 mAh cm⁻². FIGS. 33G-33I display the microstructure after electro-dissolving 1 mAh cm⁻² to a remnant capacity of 2 mAh cm⁻² and after electro-dissolving the remaining Li to the 1 V anodic limit. It may be observed that the Li deposited on the top of the Li₂Te—Cu is dense and uniform. The deposited metal is free from pores and from embedded SEI. The Li microstructure is consistent after accumulating a capacity of 3 mAh cm⁻² and subsequently electro-dissolving of 1 mAh cm⁻² of this capacity. In this terminally electro-dissolved state, there is no evidence of dead metal left on the Li₂Te—Cu surface, while the Li₂Te layer is continuous and relatively undistorted. Per the top-down SEM images shown in FIG. 41, in this fully electro-dissolved state, the current collector is easily detached from the SE with the two interfaces remaining intact.

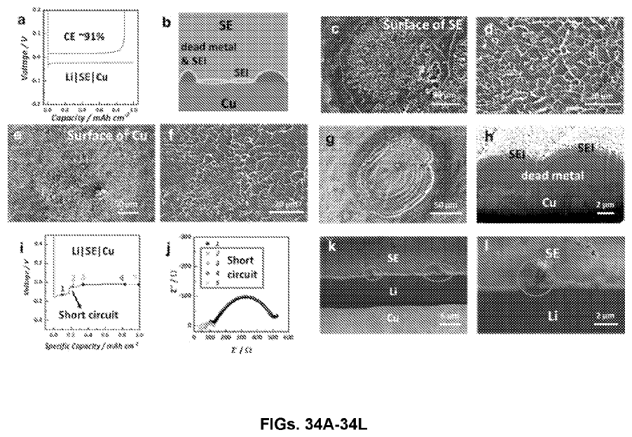

FIGS. 34A-34H display the analysis of baseline Cu substrate after one electrodeposition/electro-dissolution cycle to a capacity of 1 mAh cm⁻² at 0.5 mA cm⁻². FIG. 34A shows the GCD profile of the baseline Cu cell tested at 0.5 mA cm⁻². The ICE of the baseline Cu cell is 91% vs. 96% measured for Li₂Te—Cu. As the next set of panels will illustrate, this difference is due to extensive and irregular SEI formation and the presence of electrochemically inactive dead metal in the baseline Cu. A schematic illustration of the Cu cell after Li electro-dissolution is shown in FIG. 34B, highlighting these two deleterious features of the electro-stripped interface.

FIGS. 34C-34F display the top-down SEM images of the electro-stripped surface of SE and the Cu collector, respectively. A key feature of both interfaces is the special islands of honeycomb-like SEI that remains on both surfaces. These islands possess a diameter in the 100-200 micrometer range and are caused by the reaction between the SE and the Li metal. The known reaction products between Li₆PS₅Cl and Li include equilibrium Li₂S, Li₃P, and LiCl, as several metastable phases, including Li₃PS₄, S, P, and P₂S₅. The fact that the SEI has the shape of islands indicates that the Li metal is not fully wetted on the Cu current collector, as otherwise, the SEI would be continuous across the surfaces. The SEI appears to be adherent to both Cu and the SE, with the circular islands being relatively whole on both surfaces.

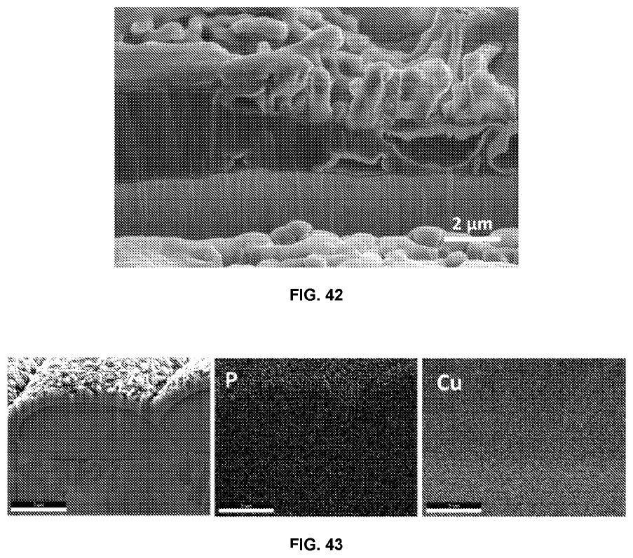

FIG. 42 shows cryo-FIB cross-section SEM results of the baseline Cu after electrodepositing 1 mAh cm⁻² at 0.5 mA cm⁻². It may be observed that the Li metal is poorly wetted on the Cu support and is intermixed with pores and with SEI reaction products. Such incompletely wetted Li on the Cu collector will lead to a localized increase in the current density and electric field focusing, in-turn promoting accelerated SE decomposition and metal dendrite growth. FIG. 34G presents top-down SEM images highlighting the irregular surface of the electro-stripped Cu with circular island-like features on the 100-200 micrometer scale. FIG. 34H displays the cross-sectional cryo-FIB SEM image of the selected area in FIG. 34G. According to FIG. 34G, on the electro-stripped Cu surface, there is non-dissolved dead Li metal with droplet-like morphology (further supporting the poor-wetting scenario). The dead metal, along with the extensive SEI, is the two key features explaining the low CE observed for the baseline Cu. These two undesirable microstructural features are not detected for the Li₂Te—Cu specimens in the electro-dissolved state. As shown by the EDXS maps in FIG. 43, the dead metal is also covered by a thick SEI layer that can be readily distinguished by its chemical features.

FIGS. 34I-34J show the cross-sectional cryo-FIB SEM images of the Li deposited to a capacity of 3 mAh cm⁻² at 0.5 mA cm⁻². Both sets of analyses, performed on different wetted portions of the Li metal, demonstrate dendrites protruding into the SE. The images are presented at a lower and a higher magnification to illustrate both the general morphology of the interface and the specific morphology of a single-branched dendrite. FIGS. 34K-34L show the galvanostatic electrodeposition curve and corresponding EIS Nyquist plots for baseline Cu tested at 3 mA cm⁻². FIG. 44 shows these Nyquist plots at higher resolution. At this high current, a short-circuit occurs after depositing a capacity of capacity of approximately 0.1 mAh cm⁻². This is evident by both the sharp drop in the overpotential during electrodeposition (due to the onset of mixed electron-ion conduction) and a sharp decrease in the cell impedance for the same reason.

TABLE 4
Binding energies for multiple lithium atoms and
lithium clusters on the relevant surfaces.

| Binding | Four | Li₄ | Five | Li₅ |
|---|---|---|---|---|
| Energy per Li (eV) | Li atoms | cluster | Li atoms | cluster |
| (111) fcc Cu | — | — | — | — |
| | 0.570 | 0.560 | 0.531 | 0.529 |
| (110) bcc Li | 0.168 | 0.121 | 0.188 | 0.111 |
| (110) fcc Li₂Te | 0.535 | 0.630 | 0.538 | 0.595 |

### Example 3

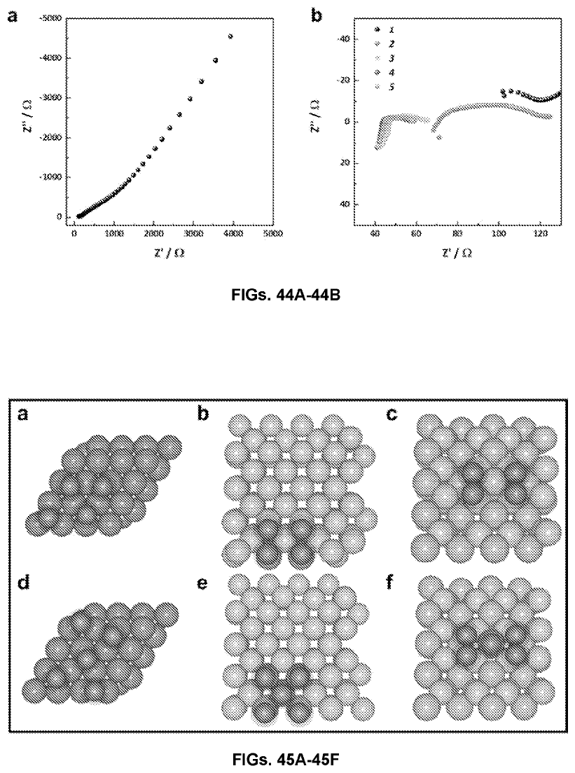

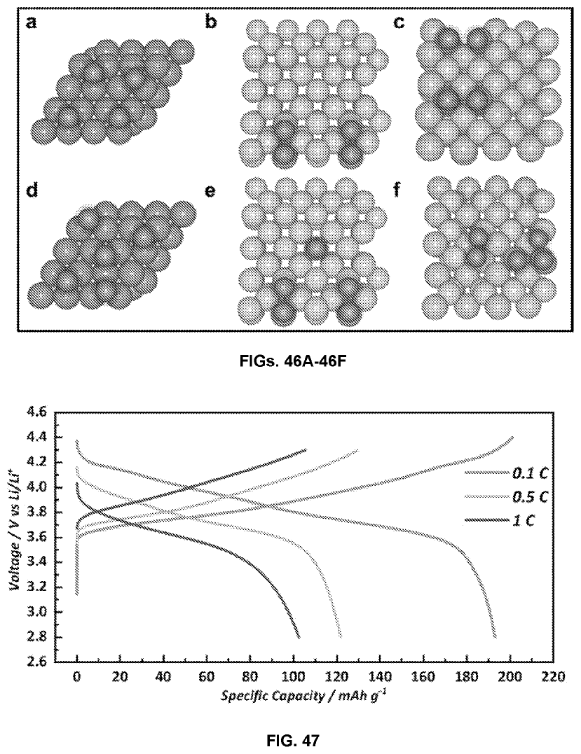

The electrodeposition behavior of Li on the Li₂Te—Cu and baseline Cu surfaces was further examined through Density Functional Theory (DFT) calculations. Without wishing to be bound by any theory, it was assumed that if Li clusters are more thermodynamically stable than individual Li atoms, then early-stage wetting behavior will favor three-dimensional islands rather than atomically thin continuous films. This would naturally lead to dendrites as the film thickness increases. If Li atoms are more stable as compared to Li clusters, the initially electrodeposited film will cover the surface uniformly. This scenario does not exclude the possibility of Stransk-Krastanov type dewetting away from the interface during the later stages of deposition. However, there is little evidence for such behavior with Te—Cu support. The binding energies of Li atoms and Li clusters on the (110) fcc Li₂Te surface were calculated and compared to (111) fcc Cu and (110) bcc Li. The binding energies were calculated in two configurations: (a) Li clusters and (b) individual Li atoms. The structures of Li₄/Li₅ clusters and four/five individual Li atoms on the respective surfaces are shown in FIGS. 45 and 46. As discussed, a relatively stronger binding energy of individual Li atoms as compared to clusters indicates the propensity to deposit uniformly on a given surface.

The binding energy of the Li₄ cluster, Li₅ cluster, and four and five Li atoms are shown in Table 4. Outcomes with the most positive binding energy are the least thermodynamically stable. The simulation has shown that on the Cu (111) surface, the four/five individual Li atoms and Li₄/Li₅ clusters are almost equally stable, indicating there is a minimal energetic preference for early-stage islands versus early-stage planar films. Without wishing to be bound by any theory, these results indicate that the experimentally observed early-stage electrodeposited film morphology is kinetically determined, being influenced by factors such as the heterogeneity of the Li-ion flux through the argyrodite SE that is not 100% dense and through the formed SEI. Per the FIB analysis, with the baseline Cu, the SEI is geometrically heterogeneous, making uniform Li electrodeposition difficult and favoring island growth. With Li₂Te, four and five Li atoms were found to be significantly more stable than the clusters, indicating that there is a thermodynamic driving force for complete coverage of the support during early-stage electrodeposition. Interestingly, it was found that on pre-existing Li metal, the individual atoms are less stable than the clusters. Without wishing to be bound by any theory, these results imply a thermodynamic propensity for roughening of the Li metal surface during ongoing film growth (S-K growth). Such behavior is not observed at the plated capacities and analyzed. One could reasonably surmise that the external pressure on the cells aids in suppressing such instabilities at later stages of electrodeposition. Thermodynamic propensity of Li to roughen as it electrodeposits on pre-existing metal may also be a reason why it is near-universally reported that significant external pressure is necessary to achieve stable cycling with solid-state electrolytes.

As proof of principle, anode-free all-solid-state batteries (AF-ASSB) were fabricated and tested. Since, for AF-ASSB, there is no active ion reservoir apart from what is in the cathode, CEs approaching 100% are crucial. The cells were based on LiNi_{0.8}Mn_{0.1}Co_{0.1}O₂ (NMC811) cathodes and argyrodite Li₆PS₅Cl LPSCl electrolyte. Both Li₂Te—Cu and baseline Cu anode current collectors were analyzed.

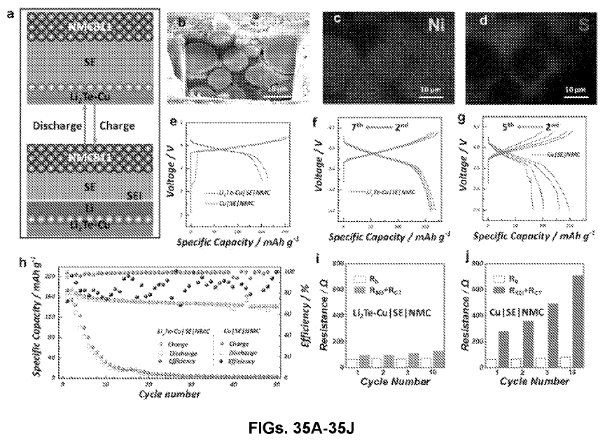

FIG. 35A illustrates the working principle of the Li₂Te-Cu|SE|NMC cell. FIG. 35B shows the cryo-FIB SEM analysis of the cathode structure where NMC is mixed with SE to achieve sufficient ionic flux. No carbon additives were employed to construct the cathode architectures. FIGS. 35C-35D present the EDXS maps that indicate homogenous mixing of the active cathode material and the SE. FIG. 35E displays the first cycle galvanostatic profiles of Li₂Te-Cu|SE|NMC and Cu|SE|NMC cells at a current density of 0.2 C (1 C equals to 200 mA g⁻¹ based on the mass of NMC). It may be observed that a small plateau is present in the Li₂Te-Cu|SE|NMC full cell at a voltage of ~2.5 V, which corresponds to the in-situ reaction process between Cu₂Te and Li for, Li₂Te, as discussed earlier. This kinetically irreversible reaction occurs only on the initial charge cycle. Neither the subsequent discharge nor the following charge cycles display the plateau. The Li₂Te-Cu|SE|NMC cell exhibits initial charge and discharge capacities of 199 and 165 mAh g⁻¹, corresponding to an ICE of 83%. By contrast, the Cu|SE|NMC cell delivered 208 and 151 mAh g⁻¹, corresponding to an ICE of 72%. Without wishing to be bound by any theory, the increased CE of Li₂Te-Cu|SE|NMC was directly attributed to the lithiophilic Li₂Te—Cu surface.

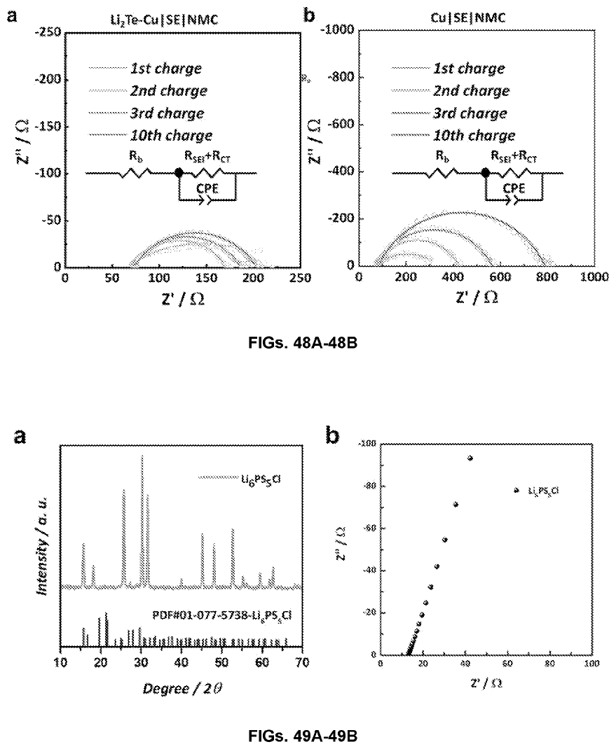

FIGS. 35F-35G compare the galvanostatic profiles of Li₂Te-Cu|SE|NMC and Cu|SE|NMC cells in the subsequent cycles. It may be observed that the Cu|SE|NMC cell undergoes significant capacity decay at each cycle, with capacities of 148, 130, 101, and 83 mAh g⁻¹ at cycles 2-5. The cell's voltage-capacity profile begins to notably deteriorate from the 3^{rd} discharge onwards. By contrast, the Li₂Te-Cu|SE|NMC cells exhibit relatively stable charge/discharge profiles and deliver reversible capacities of 168, 163, 159, and 159 mAh g⁻¹ at cycles 2-5. FIG. 47 shows the rate capability of Li₂Te-Cu|SE|NMC, with discharge capacities of 193, 121, and 103 mAh g⁻¹ being obtained at 0.1, 0.5, and 1 C. FIG. 35H contrasts the cycling performance of Li₂Te-Cu|SE|NMC and Cu|SE|NMC cells. A substantial capacity decay can be found with the Cu|SE|NMC cell, with 33 mAh g⁻¹ being sustained after 10 cycles and nil capacity soon afterward. The Li₂Te-Cu|SE|NMC cell exhibits more stable cycling with a capacity retention of 80% after 50 cycles and an average CE above 99%.

FIGS. 35I-35J and FIG. 48 display the electrochemical impedance behaviors of both Li₂Te-Cu|SE|NMC and Cu|SE|NMC cells after charging at different cycles. Both plots are fitted by an equivalent circuit composed of an Rb and overlapped R_{SEI}+R_{CT} in series with a parallel connection of CPE. The R_{SEI}+R_{CT} value of the 1^{st}, 2^{nd}, 3^{rd} and 10^{th} charging was 95, 95, 110, and 126Ω for Li₂Te-Cu|SE|NMC, and 275, 358, 490, 708Ω for Cu|SE|NMC. Overall, these AF-SSB results agree well with the analytical and electroanalytical findings for the half-cells.

### CONCLUSIONS

In summary, a standard copper current collector but with a lithiophilic surface (1 mm Li₂Te intermetallic in-situ grown) coupled to an argyrodite Li₆PS₅Cl (LPSCl) SE allows uniform lithium metal wetting, while a standard uncoated foil is only partially wetted. As LPSCl kinetically forms a stable SEI when being directly interfaced with the lithium, no secondary barrier layer or membrane was employed. Wetting of the current collector dictates electrodeposition/electro-dissolution overpotentials as well as Coulombic efficiency (CE) throughout the battery cycling life. Cryo-stage FIB demonstrates that Li electrodeposits uniformly, with no signs of voids or dendrites at the collector-SE interface. Baseline bare Cu surface yields inhomogeneous Li electrodeposition, “dead metal” formation, and irregular honeycomb-like solid electrolyte interphase (SEI) interspersed with pores. The reaction between the lithium metal and the SE appears to be more severe in the proximity of the unwetted copper, be it due to current focusing and/or some galvanic effects that need to be further understood. Density Functional Theory (DFT) demonstrates thermodynamic stability and favorable binding of lithium atoms on Li₂Te and of clusters on bare Cu, the latter favoring three-dimensional island growth and, ultimately dendrites.

### EXEMPLARY ASPECTS

EXAMPLE 1: An electrochemical cell comprising: a conductive host material configured to sustain a plurality of plating/stripping cycles such that an active anode metal material is repeatedly plated and stripped during the electrochemical cell operation and wherein the host material comprises: a) a substrate; and b) a coating disposed on the substrate, where the coating comprises at least one chalcogen.

EXAMPLE 2: The electrochemical cell of any examples herein, particularly example 1, wherein the at least one chalcogen comprises sulfur (S), tellurium (Te), selenium (Se), antimony (Sb), or a combination thereof.

EXAMPLE 3: The electrochemical cell of any examples herein, particularly examples 1 or 2, wherein the substrate comprises a metal web, a metal foam, a metal wire, metal foil, or a metal strip.

EXAMPLE 4: The electrochemical cell of any examples herein, particularly example 3, wherein the substrate comprises a rough surface.

EXAMPLE 5: The electrochemical cell of any examples herein, particularly example 3 or 4, wherein the substrate comprises copper, aluminum, alloys of copper, or alloys of aluminum.

EXAMPLE 6: The electrochemical cell of any examples herein, particularly examples 1-5, wherein the coating comprises an in-situ formed intermetallic complex between the active anode metal material and at least one chalcogen.

EXAMPLE 7: The electrochemical cell of any examples herein, particularly example 6, wherein the intermetallic complex is irreversible.

EXAMPLE 8: The electrochemical cell of any examples herein, particularly example 7, wherein the intermetallic complex is formed in-situ during a first plating cycle.

EXAMPLE 9: The electrochemical cell of any examples herein, particularly examples 1-8, wherein the coating is disposed on at least one surface of the substrate.

EXAMPLE 10: The electrochemical cell of any examples herein, particularly examples 1-9, wherein the coating forms a uniform or irregular covering of the substrate.

EXAMPLE 11: The electrochemical cell of any examples herein, particularly examples 1-10, wherein the coating is a continuous or discontinuous film over the substrate.

EXAMPLE 12: The electrochemical cell of any examples herein, particularly examples 1-11, wherein the coating has a thickness from 0.001 to 1,000 microns.

EXAMPLE 13: The electrochemical cell of any examples herein, particularly examples 1-12, wherein the at least one chalcogen is present in the coating in an amount from about 0.0001 mg/cm² to about 100 mg/cm².

EXAMPLE 14: The electrochemical cell of any examples herein, particularly examples 1-13, wherein the coating comprises at least one single element of the at least one chalcogen, a reactive oxide of the at least one chalcogen, a solid solution of two or more chalcogens, or an intermetallic compound of two or more chalcogens.

EXAMPLE 15: The electrochemical cell of any examples herein, particularly examples 1-14, wherein the coating is formed by vapor deposition, solution deposition, co-rolling, thermal processing, chemical deposition, electrochemical deposition, spray drying, spin coating, hydrothermally, or any combination thereof.

EXAMPLE 16: The electrochemical cell of any examples herein, particularly examples 1-15, wherein the electrochemical cell further comprises an electrolyte.

EXAMPLE 17: The electrochemical cell of any examples herein, particularly example 16, wherein the electrolyte comprises a salt and a non-aqueous solvent.

EXAMPLE 18: The electrochemical cell of any examples herein, particularly example 17, wherein the salt comprises a potassium, sodium, lithium, magnesium, calcium, or aluminum salt of bis(fluorosulfonyl) imide, perchlorate, tetrafluoroborate hexafluorophosphate, hexafluroarsenate, or a potassium, sodium, or lithium salt of aluminum tetrachloride, boron tetrachloride iodide, chlorate, borate, iodate, or a combination thereof.

EXAMPLE 19: The electrochemical cell of any examples herein, particularly examples 17 or 18, wherein the salt comprises ions of the active anode metal material.

EXAMPLE 20: The electrochemical cell of any examples herein, particularly examples 17-19, wherein the non-aqueous solvent comprises dioxane, ethylene carbonate, dimethyl carbonate, diethyl carbonate, ethyl methyl carbonate, polyoxylene, fluoroethylene carbonate, propylene carbonate, N-methyl acetamide, acetonitrile, symmetric sulfone, sulfolane, polyethylene glycol, dimethoxyethane, 1,3-dioxolane, glymes, siloxane, ethylene oxide grafted sulfolane, or a combination thereof.

EXAMPLE 21: The electrochemical cell of any examples herein, particularly example 16, wherein the electrolyte is a solid electrolyte.

EXAMPLE 22: The electrochemical cell of any examples herein, particularly example 21, wherein the solid electrolyte comprises at least one of sulfide compounds, garnet structure oxides, LISICON-type solids, NASICON-or KSICON-type phosphate glass ceramics, perovskite-type and anti-perovskite type compounds, nitrides, oxynitrides, argyrodite-type, or polymer-based electrolytes, or any combination thereof.

EXAMPLE 23: The electrochemical cell of any examples herein, particularly examples 16-22, wherein the electrolyte is a hybrid liquid-solid electrolyte.

EXAMPLE 24: The electrochemical cell of any examples herein, particularly examples 1-23, wherein the active anode metal material comprises Li, Na, K, Zn, Mg, Li alloys, Li intermetallics, Li compounds, Na alloys, Na intermetallics, Na compounds, K alloys, K intermetallics, K compounds or any combination thereof.

EXAMPLE 25: The electrochemical cell of any examples herein, particularly examples 1-24, wherein when the host material is plated with the active anode metal material, the anode metal material exhibits a discharge capacity from about 0.001 mAh cm² to about 1,000,000 mAh cm².

EXAMPLE 26: The electrochemical cell of any examples herein, particularly example 25, wherein the active anode metal material uniformly plates the host material.

EXAMPLE 27: The electrochemical cell of any examples herein, particularly examples 1-26, wherein the plated active anode metal material exhibits substantially no dendrites in the plating or stripping cycle.

EXAMPLE 28: The electrochemical cell of any examples herein, particularly examples 1-27, exhibiting up to at least 800 cycles of cumulative plating/stripping at a current density from greater than 0.001 mA cm⁻² to about 1,000 mA cm⁻².

EXAMPLE 29: The electrochemical cell of any examples herein, particularly examples 1-28, wherein the active anode metal material is substantially fully removed from the host material in the stripping cycle.

EXAMPLE 30: The electrochemical cell of any examples herein, particularly examples 1-29, further comprising a cathode material.

EXAMPLE 31: The electrochemical cell of any examples herein, particularly example 30, wherein the cathode is a metal cathode, a ceramic cathode, or a composite cathode.

EXAMPLE 32: The electrochemical cell of any examples herein, particularly example 31, wherein the cathode comprises copper, carbon, graphite, sodium, potassium, lithium, magnesium, calcium, aluminum, layered oxides, vanadium-based cathode, sulfur-based cathode, spinels, olivines, or any combination thereof.

EXAMPLE 33: The electrochemical cell of any examples herein, particularly examples 30-32, wherein the cell exhibits a reversible capacity of at least about 50 mAh g⁻¹ after 10,000 cycles at a current density of about 0.01 C to about 20 C.

EXAMPLE 34: The electrochemical cell of any examples herein, particularly examples 30-33, wherein the cell exhibits a coulombic efficiency of greater than about 95%.

EXAMPLE 35: The electrochemical cell of any examples herein, particularly example 34, wherein the cell exhibits a coulombic efficiency of greater than about 99%.

EXAMPLE 36: A battery comprising an electrochemical cell of any examples herein, particularly examples 1-35.

EXAMPLE 37: A method of making the electrochemical cell of any examples herein, particularly examples 1-35: a) providing a host material comprising: i) a substrate; and ii) a coating disposed on the substrate where the coating comprises at least one chalcogen; b) providing an electrolyte; and c) plating an active anode metal material to form an anode.

EXAMPLE 38: The method of any examples herein, particularly example 37, wherein the host material is formed by depositing the at least one chalcogen comprising sulfur (S), tellurium (Te), selenium (Se), antimony (Sb), or a combination thereof on at least one surface of the substrate.

EXAMPLE 39: The method of any examples herein, particularly example 38, wherein the substrate comprises a metal web, a metal foam, a metal wire, metal foil, or a metal strip.

EXAMPLE 40: The method of any examples herein, particularly example 39, wherein the substrate comprises copper, aluminum, alloys of copper, or alloys of aluminum.

EXAMPLE 41: The method of any examples herein, particularly examples 37-40, wherein during a first plating cycle an intermetallic complex is formed in the coating between the active anode metal material and at least one chalcogen.

EXAMPLE 42: The method of any examples herein, particularly example 41, wherein the intermetallic complex is irreversible.

EXAMPLE 43: The method of any examples herein, particularly examples 35-42, wherein the step of depositing comprises one or more of vapor deposition, solution deposition, co-rolling, thermal processing, chemical deposition, electrochemical deposition, spray drying, spin coating, hydrothermally, or any combination thereof.

EXAMPLE 44: An electrochemical cell comprising: a conductive host material configured to sustain a plurality of plating/stripping cycles such that an active anode metal material is repeatedly plated and stripped during the electrochemical cell operation and wherein the host material comprises: a) a substrate; and b) a coating comprising an in-situ formed intermetallic complex comprising at least one first element and at least one second element, wherein at least one second element comprises the active anode metal material.

EXAMPLE 45: The electrochemical cell of any examples herein, particularly example 44, wherein the at least one first element is selected from sulfur (S), tellurium (Te), selenium (Se), antimony (Sb), aluminum, magnesium, or alloys thereof.

EXAMPLE 46: The electrochemical cell of any examples herein, particularly examples 44 or 45, wherein the at least one second element is selected from Li, Na, K, Zn, Mg, Li alloys, Li intermetallics, Li compounds, Na alloys, Na intermetallics, Na compounds, K alloys, K intermetallics, K compounds or any combination thereof.

EXAMPLE 47: The electrochemical cell of any examples herein, particularly examples 44-46, wherein the electrochemical cell further comprises an electrolyte.

EXAMPLE 48: The electrochemical cell of any examples herein, particularly examples 44-47, wherein the in-situ formed intermetallic complex is irreversible.

EXAMPLE 49: The electrochemical cell of any examples herein, particularly example 48, wherein the electrolyte is a solid electrolyte comprising at least one of sulfide compounds, garnet structure oxides, LISICON-type solids, NASICON-or KSICON-type phosphate glass ceramics, perovskite-type and anti-perovskite type compounds, nitrides, oxynitrides, argyrodite-type, or polymer-based electrolytes, or any combination thereof.

EXAMPLE 50: The electrochemical cell of any examples herein, particularly examples 44-49, wherein the active anode metal material comprises Li, Na, K, Zn, Mg, Li alloys, Li intermetallics, Li compounds, Na alloys, Na intermetallics, Na compounds, K alloys, K intermetallics, K compounds or any combination thereof.

EXAMPLE 51: The electrochemical cell of any examples herein, particularly examples 44-50, wherein the at least first element is coated on the substrate prior to in-situ formation of the intermetallic complex between the at least first element and the at least the second element.

EXAMPLE 52: The electrochemical cell of any examples herein, particularly examples 44-51, wherein the coating is disposed on at least one surface of the substrate.

EXAMPLE 53: The electrochemical cell of any examples herein, particularly examples 44-52, wherein the coating forms a uniform or irregular covering of the substrate.

EXAMPLE 54: The electrochemical cell of any examples herein, particularly examples 44-53, wherein the coating is a continuous or discontinuous film over the substrate.

EXAMPLE 55: The electrochemical cell of any examples herein, particularly examples 44-54, wherein the coating has a thickness from 0.001 to 1,000,000 microns.

EXAMPLE 56: The electrochemical cell of any examples herein, particularly examples 44-55, wherein the at least one first element is present in the coating in an amount from about 0.0001 mg/cm² to about 100 mg/cm².

EXAMPLE 57: The electrochemical cell of any examples herein, particularly examples 44-56, wherein during operation of the electrochemical cell, the plated anode metal material exhibits a discharge capacity from about 0.001 mAh cm² to about 1,000,000 mAh cm².

EXAMPLE 58: The electrochemical cell of any examples herein, particularly example 57, wherein during operation of the electrochemical cell, the anode metal material uniformly plates the host material.

EXAMPLE 59: The electrochemical cell of any examples herein, particularly examples 44-58, wherein during operation of the electrochemical cell, the plated active anode metal material exhibits substantially no dendrites in the plating or stripping cycle.

EXAMPLE 60: The electrochemical cell of any examples herein, particularly examples 44-59, exhibiting up to at least 800 cycles of cumulative plating/stripping at a current density from greater than 0.001 mA cm⁻² to about 1000 mA cm⁻².

EXAMPLE 61: The electrochemical cell of any examples herein, particularly examples 44-60, wherein the active anode metal material is substantially fully removed from the host material in the stripping cycle.

EXAMPLE 62: The electrochemical cell of any examples herein, particularly examples 44-61, further comprising a cathode material.

EXAMPLE 63: The electrochemical cell of any examples herein, particularly example 62, wherein the cathode is a metal cathode, a ceramic cathode, or a composite cathode.

EXAMPLE 64: The electrochemical cell of any examples herein, particularly example 63, wherein the cathode comprises copper, carbon, graphite, sodium, potassium, lithium, magnesium, calcium, aluminum, layered oxides, vanadium-based cathode, sulfur-based cathode, spinels, olivines, or any combination thereof.

EXAMPLE 65: The electrochemical cell of any examples herein, particularly examples 62-64, wherein the cell exhibits a reversible capacity of at least about 50 mAh g⁻ after 10,000 cycles at a current density of about 0.01 C to about 20 C.

EXAMPLE 66: The electrochemical cell of any examples herein, particularly examples 62-65, wherein the cell exhibits a coulombic efficiency of greater than about 95%.

EXAMPLE 67: The electrochemical cell of any examples herein, particularly example 66, wherein the cell exhibits a coulombic efficiency of greater than about 99%.

EXAMPLE 68: A method of making the electrochemical cell of any one of claims 44-67 comprising: a) providing a host material comprising: i) a substrate; and ii) a coating disposed on the substrate where the coating comprises at least one first element; b) providing an electrolyte; c) in-situ forming an intermetallic complex comprising the at least one first element and at least one second element, wherein at least one second element comprises an active anode metal material; and d) plating the active anode metal material to form an anode.

EXAMPLE 69: The method of any examples herein, particularly example 68, wherein the coating is formed by vapor deposition, solution deposition, co-rolling, thermal processing, chemical deposition, electrochemical deposition, spray drying, spin coating, hydrothermally, or any combination thereof.

EXAMPLE 70: The method of any examples herein, particularly example 69, wherein the coating is formed by the thermal deposition.

EXAMPLE 71: The method of any examples herein, particularly examples 69-70, wherein the intermetallic complex is formed during a first plating cycle of the anode material, and wherein the intermetallic complex is irreversible.

EXAMPLE 72: The method of any examples herein, particularly examples 69-71, wherein the at least one first element is selected from sulfur (S), tellurium (Te), selenium (Se), antimony (Sb), aluminum, magnesium, or alloys thereof.

EXAMPLE 73: The method of any examples herein, particularly examples 69-72, wherein at least one second element is selected from Li, Na, K, Zn, Mg, Li alloys, Li intermetallics, Li compounds, Na alloys, Na intermetallics, Na compounds, K alloys, K intermetallics, K compounds, or any combination thereof.

EXAMPLE 74: The method of any examples herein, particularly examples 69-73, wherein the electrolyte is a solid electrolyte comprising at least one of sulfide compounds, garnet structure oxides, LISICON-type solids, NASICON-or KSICON-type phosphate glass ceramics, perovskite-type and anti-perovskite type compounds, nitrides, oxynitrides, argyrodite-type, or polymer-based electrolytes, or any combination thereof.

EXAMPLE 75: The method of any examples herein, particularly examples 69-74, wherein the active anode metal material comprises Li, Na, K, Zn, Mg, Li alloys, Li intermetallics, Li compounds, Na alloys, Na intermetallics, Na compounds, K alloys, K intermetallics, K compounds or any combination thereof.

EXAMPLE 76: The method of any examples herein, particularly examples 69-75, further comprising providing a cathode, wherein the cathode is a metal cathode, a ceramic cathode, or a composite cathode.

EXAMPLE 77: The method of any examples herein, particularly example 76, wherein the cathode comprises copper, carbon, graphite, sodium, potassium, lithium, magnesium, calcium, aluminum, layered oxides, vanadium-based cathode, sulfur-based cathode, spinels, olivines, or any combination thereof.

EXAMPLE 78: The method of any examples herein, particularly examples 76-77, wherein the cell exhibits a reversible capacity of at least about 50 mAh g⁻ after 10,000 cycles at a current density of about 0.01 C to about 20 C.

EXAMPLE 79: The method of any examples herein, particularly examples 76-77, wherein the cell exhibits a coulombic efficiency of greater than about 95%.

EXAMPLE 80: The method of any examples herein, particularly example 79, wherein the cell exhibits a coulombic efficiency of greater than about 99%.

### REFERENCES

1. R. Schmuch, R. Wagner, G. Hörpel, T. Placke and M. Winter, Nature Energy, 2018, 3, 267-278.
2. N. Yabuuchi, K. Kubota, M. Dahbi and S. Komaba, Chem Rev, 2014, 114, 11636-11682.
3. H. Pan, Y.-S. Hu and L. Chen, Energy & Environmental Science, 2013, 6.
4. W. Luo, F. Shen, C. Bommier, H. Zhu, X. Ji and L. Hu, Acc Chem Res, 2016, 49, 231-240.
5. L. Wang, J. Shang, Q. Huang, H. Hu, Y. Zhang, C. Xie, Y. Luo, Y. Gao, H. Wang and Z. Zheng, Adv Mater, 2021, 33, e2102802.
6. E. Goikolea, V. Palomares, S. Wang, I. R. Larramendi, X. Guo, G. Wang and T. Rojo, Advanced Energy Materials, 2020, 10.
7. F. Wang, H. Yang, J. Zhang, P. Zhang, G. Wang, X. Zhuang, G. Cuniberti and X. Feng, Adv Mater, 2018, 30, e1800028.
8. P. K. Nayak, L. Yang, W. Brehm and P. Adelhelm, Angew Chem Int Ed Engl, 2018, 57, 102-120.
9. C. Delmas, Advanced Energy Materials, 2018, 8.
10. J. Y. Hwang, S. T. Myung and Y. K. Sun, Chem Soc Rev, 2017, 46, 3529-3614.
11. B. Sun, P. Xiong, U. Maitra, D. Langsdorf, K. Yan, C. Wang, J. Janek, D. Schröder and G. Wang, Adv. Mater., 2020, 32, 1903891.
12. S. Guo, J. Yi, Y. Sun and H. Zhou, Energy Environ. Sci., 2016, 9, 2978-3006.
13. W. Luo and L. Hu, ACS Cent. Sci., 2015, 1, 420-422.
14. B. Sun, P. Xiong, U. Maitra, D. Langsdorf, K. Yan, C. Wang, J. Janek, D. Schroder and G. Wang, Adv Mater, 2020, 32, e1903891.
15. H. Yang, F. He, M. Li, F. Huang, Z. Chen, P. Shi, F. Liu, Y. Jiang, L. He, M. Gu and Y. Yu, Adv Mater, 2021, 33, e2106353.
16. B. Lee, E. Paek, D. Mitlin and S. W. Lee, Chem Rev, 2019, 119, 5416-5460.
17. G. G. Eshetu, G. A. Elia, M. Armand, M. Forsyth, S. Komaba, T. Rojo and S. Passerini, Advanced Energy Materials, 2020, 10.
18. C. Bao, B. Wang, P. Liu, H. Wu, Y. Zhou, D. Wang, H. Liu and S. Dou, Advanced Functional Materials, 2020, 30.
19. W. Liu, Z. Chen, Z. Zhang, P. Jiang, Y. Chen, E. Paek, Y. Wang and D. Mitlin, Energy & Environmental Science, 2020, DOI: 10.1039/d0ee02423f.
20. Q. Shi, Y. Zhong, M. Wu, H. Wang and H. Wang, Angew Chem Int Ed Engl, 2018, 57, 9069-9072.
21. X. Zheng, H. Fu, C. Hu, H. Xu, Y. Huang, J. Wen, H. Sun, W. Luo and Y. Huang, J Phys Chem Lett, 2019, 10, 707-714.
22. H. Wang, C. Wang, E. Matios and W. Li, Angew Chem Int Ed Engl, 2018, 57, 7734-7737.
23. W. Luo, C.-F. Lin, O. Zhao, M. Noked, Y. Zhang, G. W. Rubloff and L. Hu, Advanced Energy Materials, 2017, 7.
24. Y. Zhao, L. V. Goncharova, Q. Zhang, P. Kaghazchi, Q. Sun, A. Lushington, B. Wang, R. Li and X. Sun, Nano Lett, 2017, 17, 5653-5659.
25. S. Choudhury, S. Wei, Y. Ozhabes, D. Gunceler, M. J. Zachman, Z. Tu, J. H. Shin, P. Nath, A. Agrawal, L. F. Kourkoutis, T. A. Arias and L. A. Archer, Nat Commun, 2017, 8, 898.
26. M. Ma, Y. Lu, Z. Yan and J. Chen, Batteries & Supercaps, 2019, 2, 663-667.
27. Z. Xu, J. Yang, T. Zhang, L. Sun, Y. Nuli, J. Wang and S. i. Hirano, Advanced Functional Materials, 2019, DOI: 10.1002/adfm.201901924.
28. Y. Zhao, K. R. Adair and X. Sun, Energy & Environmental Science, 2018, 11, 2673-2695.
29. Y. Zhao, X. Yang, L. Y. Kuo, P. Kaghazchi, Q. Sun, J. Liang, B. Wang, A. Lushington, R. Li, H. Zhang and X. Sun, Small, 2018, 14, e1703717.
30. S.-S. Chi, X.-G. Qi, Y.-S. Hu and L.-Z. Fan, Advanced Energy Materials, 2018, 8.
31. Y. Wang, H. Dong, N. Katyal, H. Hao, P. Liu, H. Celio, G. Henkelman, J. Watt and D. Mitlin, Adv Mater, 2021, DOI: 10.1002/adma.202106005, e2106005.
32. S. Tang, Z. Qiu, X.-Y. Wang, Y. Gu, X.-G. Zhang, W.-W. Wang, J.-W. Yan, M.-S. Zheng, Q.-F. Dong and B.-W. Mao, Nano Energy, 2018, 48, 101-106.
33. Y. Xu, C. Wang, E. Matios, J. Luo, X. Hu, Q. Yue, Y. Kang and W. Li, Advanced Energy Materials, 2020, 10.
34. L. Ye, M. Liao, T. Zhao, H. Sun, Y. Zhao, X. Sun, B. Wang and H. Peng, Angew Chem Int Ed Engl, 2019, 58, 17054-17060.
35. L. Wang, J. Shang, Q. Huang, H. Hu, Y. Zhang, C. Xie, Y. Luo, Y. Gao, H. Wang and Z. Zheng, Adv Mater, 2021, DOI: 10.1002/adma.202102802, e2102802.
36. Y. Xu, E. Matios, J. Luo, T. Li, X. Lu, S. Jiang, Q. Yue, W. Li and Y. Kang, Nano Lett, 2020, DOI: 10.1021/acs.nanolett.0c04566.
37. Y. Ma, Y. Gu, Y. Yao, H. Jin, X. Zhao, X. Yuan, Y. Lian, P. Qi, R. Shah, Y. Peng and Z. Deng, Journal of Materials Chemistry A, 2019, 7, 20926-20935.
38. Y. Fang, Y. Zhang, K. Zhu, R. Lian, Y. Gao, J. Yin, K. Ye, K. Cheng, J. Yan, G. Wang, Y. Wei and D. Cao, ACS Nano, 2019, 13, 14319-14328.
39. P. Liu, H. Yi, S. Zheng, Z. Li, K. Zhu, Z. Sun, T. Jin and L. Jiao, Advanced Energy Materials, 2021, 11.
40. W. Wu, S. Hou, C. Zhang and L. Zhang, ACS Appl Mater Interfaces, 2020, 12, 27300-27306.
41. S. Tang, Y. Y. Zhang, X. G. Zhang, J. T. Li, X. Y. Wang, J. W. Yan, D. Y. Wu, M. S. Zheng, Q. F. Dong and B. W. Mao, Adv Mater, 2019, 31, e1807495.
42. W. Zeng, X. Zhang, C. Yang, C. Zhang, H. Shi, J. Hu, Y. Zhao, W. Zhang, G. Zhang and H. Duan, Chemical Engineering Journal, 2021, 412.
43. W. Yang, W. Yang, L. Dong, G. Shao, G. Wang and X. Peng, Nano Energy, 2021, 80.
44. L. Mo, A. L. Chen, Y. Ouyang, W. Zong, Y. E. Miao and T. Liu, ACS Appl Mater Interfaces, 2021, DOI: 10.1021/acsami.1c13018.
45. K. Yan, S. Zhao, J. Zhang, J. Safaei, X. Yu, T. Wang, S. Wang, B. Sun and G. Wang, Nano Lett, 2020, 20, 6112-6119.
46. Y. Xie, J. Hu, Z. Han, T. Wang, J. Zheng, L. Gan, Y. Lai and Z. Zhang, Energy Storage Materials, 2020, 30, 1-8.
47. J. Wu, P. Zou, M. Ihsan-Ul-Haq, N. Mubarak, A. Susca, B. Li, F. Ciucci and J. K. Kim, Small, 2020, 16, e2003815.
48. N. Mubarak, M. Ihsan-UI-Haq, H. Huang, J. Cui, S. Yao, A. Susca, J. Wu, M. Wang, X. Zhang, B. Huang and J.-K. Kim, Journal of Materials Chemistry A, 2020, 8, 10269-10282.
49. C. Bao, B. Wang, Y. Xie, R. Song, Y. Jiang, Y. Ning, F. Wang, T. Ruan, D. Wang and Y. Zhou, ACS Sustainable Chemistry & Engineering, 2020, 8, 5452-5463.
50. X. Zheng, P. Li, Z. Cao, W. Luo, F. Sun, Z. Wang, B. Ding, G. Wang and Y. Huang, Small, 2019, 15, e1902688.
51. Y. Yu, Z. Wang, Z. Hou, W. Ta, W. Wang, X. Zhao, Q. Li, Y. Zhao, Q. Zhang and Z. Quan, ACS Applied Energy Materials, 2019, 2, 3869-3877.
52. H. Wang, E. Matios, C. Wang, J. Luo, X. Lu, X. Hu, Y. Zhang and W. Li, Journal of Materials Chemistry A, 2019, 7, 23747-23755.
53. S. Tang, Z. Qiu, X.-Y. Wang, Y. Gu, X.-G. Zhang, W.-W. Wang, J.-W. Yan, M.-S. Zheng, Q.-F. Dong and B.-W. Mao, Nano Energy, 2018, 48, 101-106.
54. L. Wang, J. Shang, Q. Huang, H. Hu, Y. Zhang, C. Xie, Y. Luo, Y. Gao, H. Wang and Z. Zheng, Adv Mater, 2021, DOI: 10.1002/adma.202102802, e2102802.
55. Q. Wang, C. Zhao, X. Lv, Y. Lu, K. Lin, S. Zhang, F. Kang, Y.-S. Hu and B. Li, Journal of Materials Chemistry A, 2019, 7, 24857-24867.
56. X. Zheng, W. Yang, Z. Wang, L. Huang, S. Geng, J. Wen, W. Luo and Y. Huang, Nano Energy, 2020, 69.
57. W. Go, M. H. Kim, J. Park, C. H. Lim, S. H. Joo, Y. Kim and H. W. Lee, Nano Lett, 2019, 19, 1504-1511.
58. A. Wang, X. Hu, H. Tang, C. Zhang, S. Liu, Y. W. Yang, Q. H. Yang and J. Luo, Angew Chem Int Ed Engl, 2017, 56, 11921-11926.
59. W. Wu, S. Hou, C. Zhang and L. Zhang, ACS Appl Mater Interfaces, 2020, 12, 27300-27306.
60. L. Tao, A. Hu, L. Mu, D. J. Kautz, Z. Xu, Y. Feng, H. Huang and F. Lin, Advanced Functional Materials, 2020, DOI: 10.1002/adfm.202007556.
61. Y. Ma, Y. Gu, Y. Yao, H. Jin, X. Zhao, X. Yuan, Y. Lian, P. Qi, R. Shah, Y. Peng and Z. Deng, Journal of Materials Chemistry A, 2019, 7, 20926-20935.
62. J. Liang, W. Wu, L. Xu and X. Wu, Carbon, 2021, 176, 219-227.
63. B. Sun, P. Li, J. Zhang, D. Wang, P. Munroe, C. Wang, P. H. L. Notten and G. Wang, Adv Mater, 2018, DOI: 10.1002/adma.201801334, e1801334.
64. M. Ma, Y. Lu, Z. Yan and J. Chen, Batteries & Supercaps, 2019, 2, 663-667.
65. Y. Fang, R. Lian, H. Li, Y. Zhang, Z. Gong, K. Zhu, K. Ye, J. Yan, G. Wang, Y. Gao, Y. Wei and D. Cao, ACS Nano, 2020, 14, 8744-8753.
66. W. Liu, Z. Chen, Z. Zhang, P. Jiang, Y. Chen, E. Paek, Y. Wang and D. Mitlin, Energy & Environmental Science, 2021, 14, 382-395.
67. J. Sun, M. Zhang, P. Ju, Y. Hu, X. Chen, W. Wang and C. Chen, Energy Technology, 2020, 8.
68. J. Sun, C. Guo, Y. Cai, J. Li, X. Sun, W. Shi, S. Ai, C. Chen and F. Jiang, Electrochimica Acta, 2019, 309, 18-24.
69. J. Yan, G. Zhi, D. Kong, H. Wang, T. Xu, J. Zang, W. Shen, J. Xu, Y. Shi, S.
Dai, X. Li and Y. Wang, Journal of Materials Chemistry A, 2020, 8, 19843-19854.
70. X. Zheng, H. Fu, C. Hu, H. Xu, Y. Huang, J. Wen, H. Sun, W. Luo and Y. Huang, J Phys Chem Lett, 2019, 10, 707-714.
71. J. He, A. Bhargav, W. Shin and A. Manthiram, J Am Chem Soc, 2021, 143, 20241-20248.
72. X. Liu, X. Zheng, Y. Dai, W. Wu, Y. Huang, H. Fu, Y. Huang and W. Luo, Advanced Functional Materials, 2021, 31.
73. J. B. Goodenough and Y. Kim, Chemistry of Materials, 2009, 22, 587-603.
74. Y. Zhu, J. C. Gonzalez-Rosillo, M. Balaish, Z. D. Hood, K. J. Kim and J. L. M. Rupp, Nature Reviews Materials, 2020, 6, 313-331.
75. D. H. S. Tan, A. Banerjee, Z. Chen and Y. S. Meng, Nat Nanotechnol, 2020, 15, 170-180.
76. J. Janek and W. G. Zeier, Nature Energy, 2016, 1.
77. P. Albertus, V. Anandan, C. Ban, N. Balsara, I. Belharouak, J. Buettner-Garrett, Z. Chen, C. Daniel, M. Doeff, N. J. Dudney, B. Dunn, S. J. Harris, S. Herle, E. Herbert, S. Kalnaus, J. A. Libera, D. Lu, S. Martin, B. D. McCloskey, M. T. McDowell, Y. S. Meng, J. Nanda, J. Sakamoto, E. C. Self, S. Tepavcevic, E. Wachsman, C. Wang, A. S. Westover, J. Xiao and T. Yersak, ACS Energy Letters, 2021, DOI: 10.1021/acsenergylett.1c00445, 1399-1404.
78. M. Pasta, D. Armstrong, Z. L. Brown, J. Bu, M. R. Castell, P. Chen, A. Cocks, S. A. Corr, E. J. Cussen, E. Darnbrough, V. Deshpande, C. Doerrer, M. S. Dyer, H. EI-Shinawi, N. Fleck, P. Grant, G. L. Gregory, C. Grovenor, L. J. Hardwick, J. T. S. Irvine, H. J. Lee, G. Li, E. Liberti, I. McClelland, C. Monroe, P. D. Nellist, P. R. Shearing, E. Shoko, W. Song, D. S. Jolly, C. I. Thomas, S. J. Turrell, M. Vestli, C. K. Williams, Y. Zhou and P. G. Bruce, Journal of Physics: Energy, 2020, 2.
79. B. S. Vishnugopi, E. Kazyak, J. A. Lewis, J. Nanda, M. T. McDowell, N. P. Dasgupta and P. P. Mukherjee, ACS Energy Letters, 2021, 6, 3734-3749.
80. S. Lou, F. Zhang, C. Fu, M. Chen, Y. Ma, G. Yin, and J. Wang, Adv Mater, 2021, 33, e2000721.
81. R. Wang, Q. Dong, C. Wang, M. Hong, J. Gao, H. Xie, M. Guo, W. Ping, X. Wang, S. He, J. Luo and L. Hu, Adv Mater, 2021, 33, e2100726.
82. L. Ye and X. Li, Nature, 2021, 593, 218-222.
83. D. H. Tan, Y.-T. Chen, H. Yang, W. Bao, B. Sreenarayanan, J.-M. Doux, W. Li, B. Lu, S.-Y. Ham and B. Sayahpour, Science, 2021, 373, 1494-1499.
84. Y.-G. Lee, S. Fujiki, C. Jung, N. Suzuki, N. Yashiro, R. Omoda, D.-S. Ko, T. Shiratsuchi, T. Sugimoto, S. Ryu, J. H. Ku, T. Watanabe, Y. Park, Y. Aihara, D. Im and I. T. Han, Nature Energy, 2020, 5, 299-308.
85. R. Fan, C. Liu, K. He, S. Ho-Sum Cheng, D. Chen, C. Liao, R. K. Y. Li, J. Tang and Z. Lu, ACS Appl Mater Interfaces, 2020, 12, 7222-7231.
86. Z. Zhang, Y. Shao, B. Lotsch, Y.-S. Hu, H. Li, J. Janek, L. F. Nazar, C.-W. Nan, J. Maier, M. Armand and L. Chen, Energy & Environmental Science, 2018, 11, 1945-1976.
87. J. Liu, H. Yuan, H. Liu, C. Z. Zhao, Y. Lu, X. B. Cheng, J. Q. Huang and Q. Zhang, Advanced Energy Materials, 2021, 12.
88. J. Han, H. Li, D. Kong, C. Zhang, Y. Tao, H. Li, Q.-H. Yang and L. Chen, ACS Energy Letters, 2020, 5, 1986-1995.
89. C. Yu, F. Zhao, J. Luo, L. Zhang and X. Sun, Nano Energy, 2021, 83.
90. D. Cao, X. Sun, Y. Li, A. Anderson, W. Lu and H. Zhu, Adv Mater, 2022, DOI: 10.1002/adma.202200401, e2200401.
91. R. Kanno and M. J. J. o. t. e. s. Murayama, 2001, 148, A742.
92. A. Banerjee, X. Wang, C. Fang, E. A. Wu and Y. S. Meng, Chem Rev, 2020, 120, 6878-6933.
93. Y. Kato, S. Hori, T. Saito, K. Suzuki, M. Hirayama, A. Mitsui, M. Yonemura, H. Iba and R. Kanno, Nature Energy, 2016, 1.
94. N. Kamaya, K. Homma, Y. Yamakawa, M. Hirayama, R. Kanno, M. Yonemura, T. Kamiyama, Y. Kato, S. Hama, K. Kawamoto and A. Mitsui, Nat Mater, 2011, 10, 682-686.
95. P. Adeli, J. D. Bazak, K. H. Park, I. Kochetkov, A. Huq, G. R. Goward and L. F. Nazar, Angew Chem Int Ed Engl, 2019, 58, 8681-8686.
96. M. A. Kraft, S. P. Culver, M. Calderon, F. Bocher, T. Krauskopf, A. Senyshyn, C. Dietrich, A. Zevalkink, J. Janek and W. G. Zeier, J Am Chem Soc, 2017, 139, 10909-10918.
97. Z. Deng, Z. Wang, I.-H. Chu, J. Luo and S. P. Ong, Journal of The Electrochemical Society, 2015, 163, A67-A74.
98. Y. Seino, T. Ota, K. Takada, A. Hayashi and M. Tatsumisago, Energy Environ. Sci., 2014, 7, 627-631.
99. S. Randau, D. A. Weber, O. Kötz, R. Koerver, P. Braun, A. Weber, E. Ivers-Tiffee, T. Adermann, J. Kulisch, W. G. Zeier, F. H. Richter and J. Janek, Nature Energy, 2020, 5, 259-270.
100. K. Yoon, S. Lee, K. Oh and K. Kang, Adv Mater, 2022, 34, e2104666.
101. C. Wang, S. Hwang, M. Jiang, J. Liang, Y. Sun, K. Adair, M. Zheng, S. Mukherjee, X. Li, R. Li, H. Huang, S. Zhao, L. Zhang, S. Lu, J. Wang, C. V. Singh, D. Su and X. Sun, Advanced Energy Materials, 2021, 11.
102. Y. Zhao, K. Zheng and X. Sun, Joule, 2018, 2, 2583-2604.
103. J. Wu, S. Liu, F. Han, X. Yao and C. Wang, Adv Mater, 2021, 33, e2000751.
104. Q. Tu, T. Shi, S. Chakravarthy and G. Ceder, Matter, 2021, 4, 3248-3268.
105. T. T. Zuo, R. Ruess, R. Pan, F. Walther, M. Rohnke, S. Hori, R. Kanno, D. Schroder and J. Janek, Nat Commun, 2021, 12, 6669.
106. T. Brahmbhatt, G. Yang, E. Self and J. Nanda, Frontiers in Energy Research, 2020, DOI: 10.3389/fenrg.2020.570754.
107. X. Y. Yue, Y. X. Yao, J. Zhang, Z. Li, S. Y. Yang, X. L. Li, C. Yan and Q. Zhang, Angew Chem Int Ed Engl, 2022, DOI: 10.1002/anie.202205697, e202205697.
108. P. Hartmann, T. Leichtweiss, M. R. Busche, M. Schneider, M. Reich, J. Sann, P. Adelhelm and J. Janek, The Journal of Physical Chemistry C, 2013, 117, 21064-21074.
109. W. Guo, S. Liu, X. Guan, X. Zhang, X. Liu and J. Luo, Advanced Energy Materials, 2019, 9.
110. P. Bron, B. Roling and S. Dehnen, Journal of Power Sources, 2017, 352, 127-134.
111. T. Krauskopf, F. H. Richter, W. G. Zeier and J. Janek, Chem Rev, 2020, 120, 7745-7794.
112. S. Wenzel, T. Leichtweiss, D. Krüger, J. Sann and J. Janek, Solid State Ionics, 2015, 278, 98-105.
113. F. Han, Y. Zhu, X. He, Y. Mo and C. Wang, Advanced Energy Materials, 2016, 6.
114. R. Koerver, I. Aygün, T. Leichtweiß, C. Dietrich, W. Zhang, J. O. Binder, P. Hartmann, W. G. Zeier and J. Janek, Chemistry of Materials, 2017, 29, 5574-5582.
115. M. Suyama, S. Yubuchi, M. Deguchi, A. Sakuda, M. Tatsumisago and A. Hayashi, Journal of The Electrochemical Society, 2021, 168.
116. T. Hakari, M. Deguchi, K. Mitsuhara, T. Ohta, K. Saito, Y. Orikasa, Y. Uchimoto, Y. Kowada, A. Hayashi and M. Tatsumisago, Chemistry of Materials, 2017, 29, 4768-4774.
117. D. H. S. Tan, E. A. Wu, H. Nguyen, Z. Chen, M. A. T. Marple, J.-M. Doux, X. Wang, H. Yang, A. Banerjee and Y. S. Meng, ACS Energy Letters, 2019, 4, 2418-2427.
118. T. K. Schwietert, V. A. Arszelewska, C. Wang, C. Yu, A. Vasileiadis, N. J. J. de Klerk, J. Hageman, T. Hupfer, I. Kerkamm, Y. Xu, E. van der Maas, E. M. Kelder, S. Ganapathy and M. Wagemaker, Nat Mater, 2020, 19, 428-435.
119. S. Wenzel, S. J. Sedlmaier, C. Dietrich, W. G. Zeier and J. Janek, Solid State Ionics, 2018, 318, 102-112.
120. S. E. Sandoval, F. J. Q. Cortes, E. J. Klein, J. A. Lewis, P. P. Shetty, D. Yeh and M. T. McDowell, Journal of The Electrochemical Society, 2021, 168.
121. S. Y. Han, C. Lee, J. A. Lewis, D. Yeh, Y. Liu, H.-W. Lee and M. T. McDowell, Joule, 2021, 5, 2450-2465.
122. H. Zhong, L. Sang, F. Ding, J. Song and Y. Mai, Electrochimica Acta, 2018, 277, 268-275.
123. R. B. Cervera, N. Suzuki, T. Ohnishi, M. Osada, K. Mitsuishi, T. Kambara and K. Takada, Energy Environ. Sci., 2014, 7, 662-666.
124. J. Wan, Y. X. Song, W. P. Chen, H. J. Guo, Y. Shi, Y. J. Guo, J. L. Shi, Y. G. Guo, F. F. Jia, F. Y. Wang, R. Wen and L. J. Wan, J Am Chem Soc, 2021, 143, 839-848.
125. R. Xu, J. F. Ding, X. X. Ma, C. Yan, Y. X. Yao and J. Q. Huang, Adv Mater, 2021, 33, e2105962.
126. D. Cao, X. Sun, Q. Li, A. Natan, P. Xiang and H. Zhu, Matter, 2020, 3, 57-94.
127. X. Feng, H. Fang, N. Wu, P. Liu, P. Jena, J. Nanda and D. Mitlin, Joule, 2022, 6, 543-587.
128. Y. Liu, C. Li, B. Li, H. Song, Z. Cheng, M. Chen, P. He and H. Zhou, Advanced Energy Materials, 2018, 8.
129. S. Wang, J. Wang, J. Liu, H. Song, Y. Liu, P. Wang, P. He, J. Xu and H. Zhou, Journal of Materials Chemistry A, 2018, 6, 21248-21254.
130. J. Kasemchainan, S. Zekoll, D. Spencer Jolly, Z. Ning, G. O. Hartley, J. Marrow and P. G. Bruce, Nat Mater, 2019, 18, 1105-1111.
131. T. Krauskopf, H. Hartmann, W. G. Zeier and J. Janek, ACS Appl Mater Interfaces, 2019, 11, 14463-14477.
132. R. Weber, M. Genovese, A. J. Louli, S. Hames, C. Martin, I. G. Hill and J. R. Dahn, Nature Energy, 2019, 4, 683-689.
133. A. J. Louli, A. Eldesoky, R. Weber, M. Genovese, M. Coon, J. deGooyer, Z. Deng, R. T. White, J. Lee, T. Rodgers, R. Petibon, S. Hy, S. J. H. Cheng and J. R. Dahn, Nature Energy, 2020, 5, 693-702.
134. M. Genovese, A. J. Louli, R. Weber, S. Hames and J. R. Dahn, Journal of The Electrochemical Society, 2018, 165, A3321-A3325.
135. C. Heubner, S. Maletti, H. Auer, J. Hüttl, K. Voigt, O. Lohrberg, K. Nikolowski, M. Partsch and A. Michaelis, Advanced Functional Materials, 2021, 31.
136. J. Qian, B. D. Adams, J. Zheng, W. Xu, W. A. Henderson, J. Wang, M. E. Bowden, S. Xu, J. Hu and J.-G. Zhang, Advanced Functional Materials, 2016, 26, 7094-7102.
137. B. Neudecker, N. Dudney and J. Bates, Journal of the Electrochemical Society, 2000, 147, 517.
138. A. S. Westover, R. L. Sacci and N. Dudney, ACS Energy Letters, 2020, 5, 3860-3867.
139. D. Cheng, R. Shimizu, J. Weaver and Y. Shirley Meng, Microscopy and Microanalysis, 2021, 27, 3324-3327.
140. M. J. Wang, E. Carmona, A. Gupta, P. Albertus and J. Sakamoto, Nat Commun, 2020, 11, 5201.
141. C. Han, Z. Li, W.-j. Li, S.-l. Chou and S.-x. Dou, Journal of Materials Chemistry A, 2014, 2.
142. B. D. Adams, J. Zheng, X. Ren, W. Xu and J. G. Zhang, Advanced Energy Materials, 2017, 8.
143. F. Qiu, X. Li, H. Deng, D. Wang, X. Mu, P. He and H. Zhou, Advanced Energy Materials, 2018, 9.

1. An electrochemical cell comprising:
a conductive host material configured to sustain a plurality of plating/stripping cycles such that an active anode metal material is repeatedly plated and stripped during the electrochemical cell operation and wherein the host material comprises:
a) a substrate comprising a metal web, a metal foam, a metal wire, metal foil, or a metal strip; and
b) a coating disposed on the substrate, where the coating comprises at least one chalcogen comprising sulfur (S), tellurium (Te), selenium (Se), antimony (Sb), or a combination thereof, wherein the at least one chalcogen is present in the coating in an amount from about 0.0001 mg/cm² to about 100 mg/cm².

2.-4. (canceled)

5. The electrochemical cell of claim 1, wherein the substrate comprises copper, aluminum, alloys of copper, or alloys of aluminum.

6. The electrochemical cell of claim 1, wherein the coating comprises an in-situ formed intermetallic complex between the active anode metal material and at least one chalcogen that is formed during a first plating cycle.

7.-11. (canceled)

12. The electrochemical cell of claim 1, wherein the coating has a thickness from 0.001 to 1,000 microns.

13. (canceled)

14. The electrochemical cell of claim 1, wherein the coating comprises at least one single element of the at least one chalcogen, a reactive oxide of the at least one chalcogen, a solid solution of two or more chalcogens, or an intermetallic compound of two or more chalcogens.

15. (canceled)

16. The electrochemical cell of claim 1, wherein the electrochemical cell further comprises an electrolyte comprising a salt and a non-aqueous solvent, wherein the salt comprises a potassium, sodium, lithium, magnesium, calcium, or aluminum salt of bis(fluorosulfonyl) imide, perchlorate, tetrafluoroborate hexafluorophosphate, hexafluroarsenate, or a potassium, sodium, or lithium salt of aluminum tetrachloride, boron tetrachloride iodide, chlorate, borate, iodate, or a combination thereof and wherein the non-aqueous solvent comprises dioxane, ethylene carbonate, dimethyl carbonate, diethyl carbonate, ethyl methyl carbonate, polyoxylene, fluoroethylene carbonate, propylene carbonate, N-methyl acetamide, acetonitrile, symmetric sulfone, sulfolane, polyethylene glycol, dimethoxyethane, 1,3-dioxolane, glymes, siloxane, ethylene oxide grafted sulfolane, or a combination thereof.

17.-20. (canceled)

21. The electrochemical cell of claim 1, wherein the electrolyte is a solid electrolyte comprising at least one of sulfide compounds, garnet structure oxides, LISICON-type solids, NASICON-or KSICON-type phosphate glass ceramics, perovskite-type and anti-perovskite type compounds, nitrides, oxynitrides, argyrodite-type, or polymer-based electrolytes, or any combination thereof.

22. (canceled)

23. (canceled)

24. The electrochemical cell of claim 1, wherein the active anode metal material comprises Li, Na, K, Zn, Mg, Li alloys, Li intermetallics, Li compounds, Na alloys, Na intermetallics, Na compounds, K alloys, K intermetallics, K compounds or any combination thereof.

25. (canceled)

26. (canceled)

27. (canceled)

28. The electrochemical cell of claim 1, exhibiting up to at least 800 cycles of cumulative plating/stripping at a current density from greater than 0.001 mA cm⁻² to about 1,000 mA cm⁻².

29. (canceled)

30. The electrochemical cell of claim 1, further comprising a cathode material, wherein the cathode material is a metal cathode, a ceramic cathode, or a composite cathode.

31. (canceled)

32. (canceled)

33. The electrochemical cell of claim 30, wherein the cell exhibits a reversible capacity of at least about 50 mAh g⁻¹ after 10,000 cycles at a current density of about 0.01 C to about 20 C and/or a coulombic efficiency of greater than about 95%.

34. (canceled)

35. (canceled)

36. (canceled)

37. A method of making the electrochemical cell of claim 1:
a) providing a host material comprising:
i) a substrate comprising a metal web, a metal foam, a metal wire, metal foil, or a metal strip; and
ii) a coating disposed on the substrate where the coating comprises at least one chalcogen comprising sulfur (S), tellurium (Te), selenium (Se), antimony (Sb), or a combination thereof on at least one surface of the substrate;
b) providing an electrolyte; and
c) plating an active anode metal material to form an anode.

38.-42. (canceled)

43. The method of claim 37, wherein the step of depositing comprises one or more of vapor deposition, solution deposition, co-rolling, thermal processing, chemical deposition, electrochemical deposition, spray drying, spin coating, hydrothermally, or any combination thereof.

44. An electrochemical cell comprising:
a conductive host material configured to sustain a plurality of plating/stripping cycles such that an active anode metal material is repeatedly plated and stripped during the electrochemical cell operation and wherein the host material comprises:
a) a substrate; and
b) a coating comprising an in-situ formed intermetallic complex comprising at least one first element and at least one second element, wherein at least one second element comprises the active anode metal material.

45. The electrochemical cell of claim 44, wherein the at least one first element is selected from sulfur (S), tellurium (Te), selenium (Se), antimony (Sb), aluminum, magnesium, or alloys thereof and wherein the at least one second element is selected from Li, Na, K, Zn, Mg, Li alloys, Li intermetallics, Li compounds, Na alloys, Na intermetallics, Na compounds, K alloys, K intermetallics, K compounds or any combination thereof.

46. (canceled)

47. The electrochemical cell of claim 44, wherein the electrochemical cell further comprises a solid electrolyte comprising at least one of sulfide compounds, garnet structure oxides, LISICON-type solids, NASICON-or KSICON-type phosphate glass ceramics, perovskite-type and anti-perovskite type compounds, nitrides, oxynitrides, argyrodite-type, or polymer-based electrolytes, or any combination thereof.

48.-50. (canceled)

51. The electrochemical cell of claim 44, wherein the at least first element is coated on the substrate prior to in-situ formation of the intermetallic complex between the at least first element and the at least the second element.

52.-61. (canceled)

62. The electrochemical cell of claim 44, further comprising a cathode material comprising copper, carbon, graphite, sodium, potassium, lithium, magnesium, calcium, aluminum, layered oxides, vanadium-based cathode, sulfur-based cathode, spinels, olivines, or any combination thereof.

63. (canceled)

64. (canceled)

65. The electrochemical cell of claim 62, wherein the cell exhibits a reversible capacity of at least about 50 mAh g⁻¹ after 10,000 cycles at a current density of about 0.01 C to about 20 C and/or a coulombic efficiency of greater than about 95%.

66. (canceled)

67. (canceled)

68. A method of making the electrochemical cell of claim 44 comprising:
a) providing a host material comprising:
j) a substrate; and
jj) a coating disposed on the substrate where the coating comprises at least one first element;
b) providing an electrolyte;
c) in-situ forming an intermetallic complex comprising the at least one first element and at least one second element, wherein at least one second element comprises an active anode metal material; and
d) plating the active anode metal material to form an anode.

69. The method of claim 68, wherein the coating is formed by vapor deposition, solution deposition, co-rolling, thermal processing, chemical deposition, electrochemical deposition, spray drying, spin coating, hydrothermally, or any combination thereof.

70.-80. (canceled)
